(19) United States
(12) Patent Application Publication
(10) Pub. No.: US 2026/0075298 A1
(43) Pub. Date: Mar. 12, 2026

(54) CAMERA DEVICE AND OPTICAL INSTRUMENT

(71) Applicant: LG INNOTEK CO., LTD., Seoul (KR)

(72) Inventor: Deok Yong LEE, Seoul (KR)

(21) Appl. No.: 19/108,370

(22) PCT Filed: Aug. 24, 2023
(86) PCT No.: PCT/KR2023/012541

§ 371 Date: Mar. 3, 2025

(30) Foreign Application Priority Data
Sep. 2, 2022 (KR) 10-2022-0111234
Nov. 28, 2022 (KR) 10-2022-0161474
Dec. 8, 2022 (KR) 10-2022-0170436

(51) Int. Cl. H04N 23/54; H04N 23/52; H04N 23/68

(52) U.S. Cl. CPC H04N 23/54; H04N 23/52; H04N 23/687

(57) ABSTRACT

An Embodiment includes a stationary unit including a second circuit board, a moving unit including a first circuit board disposed on the second circuit board and an image sensor conductively connected to the first circuit board, and a support unit connecting the first circuit board and the second circuit board and configured to support the moving unit so as to be movable in a direction perpendicular to an optical axis direction, wherein the support unit includes an extension member that includes a plurality of wirings conductively connected to the second circuit board, and the support unit includes a bent region, and a width of a first wiring firstly closest to the bent region among the plurality of wirings is larger than a width of a second wiring secondly closest to the bent region among the plurality of wirings.

### CROSS-REFERENCE TO RELATED APPLICATIONS

This application is the U.S. national stage application of International Patent Application No. PCT/KR2023/012541, filed Aug. 24, 2023, which claims the benefit under 35 U.S.C. § 119 of Korean Application Nos. 10-2022-0111234, filed Sep. 2, 2022; 10-2022-0161474, filed Nov. 28, 2022; and 10-2022-0170436, filed Dec. 8, 2022; the disclosures of each of which are incorporated herein by reference in their entirety.

### TECHNICAL FIELD

Embodiments relate to a camera device and an optical instrument including the same.

### BACKGROUND ART

It is difficult to apply technology of a voice coil motor (VCM) used in existing general camera devices to a subminiature, low-power camera device, and therefore research related thereto has been actively conducted.

Demand for and production of electronic products, such as smart phones and mobile phones equipped with cameras have increased. Cameras for mobile phones are trending toward increased resolution and miniaturization. As a result, an actuator has also been miniaturized, increased in diameter, and been made multifunctional. In order to realize a high-resolution camera for mobile phones, improvement in performance of the camera for mobile phones and additional functions thereof, such as auto focusing, optical image stabilization, and zooming, are required.

### DISCLOSURE

### Technical Problem

Embodiments provide a camera device and an optical device including the same, which can inhibit occurrence of cracks in wiring of a support substrate due to movement of an OIS moving unit and improve performance of an image sensor by shielding noise.

The embodiment also provides a camera device and an optical device including the same, which can reduce the number of wirings of a first circuit board and improve the degree of freedom in wiring design.

The embodiment also provides a camera device and an optical device including the same, which can improve heat dissipation efficiency.

### Technical Solution

A camera device according to an embodiment includes a stationary unit including a second circuit board; a moving unit including a first circuit board disposed on the second circuit board and an image sensor conductively connected to the first circuit board; and a support unit connecting the first circuit board and the second circuit board and configured to support the moving unit so as to be movable in a direction perpendicular to an optical axis direction, wherein the support unit includes an extension member including a plurality of wirings conductively connected to the second circuit board, and the support unit includes a bent region, and a width of a first wiring firstly closest to the bent region among the plurality of wirings is larger than a width of a second wiring secondly closest to the bent region among the plurality of wirings.

The first wiring may be a ground wiring conductively connected to a ground of the first circuit board. The first wiring may be a ground wiring. The second wiring may be a wiring for using a communication protocol related to the image sensor.

The first wiring may include a bent portion corresponding to the bent region, and at least a portion of the bent portion may have a larger width than another portion of the first wiring excluding the bent portion.

A width of a third wiring which is disposed farthest from the bent region among the plurality of wirings may be greater than a width of the second wiring. The third wiring may be a ground wiring conductively connected to a ground of the first circuit board. A fourth wiring which is closest to the third wiring among the plurality of wirings may be a wiring for using a communication protocol related to the image sensor. A width of the third wiring may be greater than a width of the fourth wiring.

The stationary unit may include a base coupled to the second circuit board, and the support unit may include a body coupled to the first circuit board and the extension member extended from the body and coupled to the base. The extension member may include a first extension member extending from the body toward the second circuit board and a second extension member extending in a direction different from an extension direction of the first extension member.

The bent region may include a first bent region formed between the body and the first extension member and a second bent region formed between the first extension member and the second extension member.

A camera device according to an another embodiment includes a stationary unit including a second circuit board; a moving unit including a first circuit board disposed on the second circuit board and an image sensor conductively connected to the first circuit board; and a support unit connecting the first circuit board and the second circuit board and configured to support the moving unit so as to be movable in a direction perpendicular to an optical axis direction, wherein the support unit includes first and second extension members and third and fourth extension members positioned opposite to first and second extension members with the first circuit board interposed therebetween, and at least one unit lane for transmitting and receiving a data signal related to the image sensor is disposed at each of the first and second extension members and the unit lane includes a plurality of terminals.

Each of the first and second extension members includes two ground terminals conductively connected to a ground of the first circuit board, and the unit lane may be disposed between the two ground terminals.

The unit lane may include three terminals, and one unit lane may be disposed at the first extension member, and two unit lanes may be disposed at the second extension member.

The camera device according to the another embodiment may include first to fourth coil units disposed on the first circuit board; and first to third sensors disposed on the first circuit board.

The third extension member may include a first coil terminal conductively connected to the first and second coil units, and the fourth extension member may include a second coil terminal conductively connected to the third and fourth coil units.

The first sensor may be disposed closest to the first extension member among the first to fourth extension member, the second sensor may be disposed closest to the second extension member among the first to fourth extension members, and the third sensor may be disposed closest to the third extension member among the first to fourth extension members.

A first sensor terminal conductively connected to the first sensor may be disposed at the first extension member, a second sensor terminal conductively connected to the second sensor may be disposed at the second extension member, and a third sensor terminal conductively connected to the third sensor may be disposed at one of the third and fourth extension members.

The embodiment provides a camera device and an optical device including the same which can reduce the number of wirings of the first circuit board and improve the degree of freedom in wiring design.

A camera device according to another embodiment includes a stationary unit including a second circuit board; a moving unit including a first circuit board disposed on the second circuit board and an image sensor conductively connected to the first circuit board; and a support board connecting the first circuit board and the second circuit board and configured to support the moving unit so as to be movable in a direction perpendicular to an optical axis direction, wherein the support board includes a body connected to the first circuit board, a first extension member including a first terminal extending from the body and coupled with the second circuit board, and a second extension member including a second terminal extending from the body and coupled with the second circuit board, wherein the first extension member includes a third terminal conductively connected to the first terminal, and the second extension member includes a fourth terminal conductively connected to the third terminal.

The third terminal and the fourth terminal may be coupled by a solder or a conductive adhesive. The third terminal and the fourth terminal may not be conductively connected to the second terminal. The third terminal may be disposed above the first terminal, and the fourth terminal may be disposed above the second terminal. The third and fourth terminals may be disposed closer to the first circuit board than the second circuit board. The first extension member and the second extension member may be coupled to the stationary unit.

The support board may include a first wiring for connecting the first terminal and the third terminal, a second wiring for connecting the third terminal and the first circuit board, and a third wiring for connecting the fourth terminal and the first circuit board.

The moving unit may include a first circuit element disposed on the first circuit board and conductively connected to the third terminal, and a second circuit element disposed on the first circuit board and conductively connected to the fourth terminal. The first terminal may be a common power terminal for the first and second circuit elements.

The first terminal may be disposed so as to overlap the third terminal in a direction parallel to the optical axis direction. The third terminal may be disposed so as to overlap the fourth terminal in a direction which is perpendicular to the optical axis direction and in which the first extension member and the second extension member face each other.

The support board may include a first wiring disposed at the first extension member and connecting the first terminal and the third terminal; a second wiring disposed at the body and the first extension member and connecting the first circuit element and the third terminal; and a third wiring disposed at the body and the second extension member and connecting the second circuit element and the fourth terminal. The first circuit element may be disposed closer to the first extension member than to the second extension member, and the second circuit element may be disposed closer to the second extension member than to the first extension member.

The support board may include a third extension member extending from the body and positioned opposite to the first extension member, and a fourth extension member extending from the body and positioned opposite to the second extension member, and the third extension member includes a fifth terminal, and the fourth extension member includes a sixth terminal connected to the fifth terminal by a solder or a conductive adhesive. The third and fourth extension portions may be coupled to the stationary unit.

Each of the first circuit element and the second circuit element may be a sensor for detecting movement of the moving unit, and the first terminal may be a common power terminal for the first and second circuit elements.

The first circuit element may include a first terminal conductively connected to the third terminal, the second circuit element may include a second terminal conductively connected to the fourth terminal, and the first circuit board may include a first wiring conductively connected to the third terminal and a second wiring conductively connected to the fourth terminal. The first circuit board may not include any wiring that conductively connects the first wiring and the second wiring.

The first circuit element may be disposed closer to the third terminal than to the fourth terminal, and the second circuit element may be disposed closer to the fourth terminal than to the third terminal.

A camera device according to another embodiment includes a stationary unit; a moving unit including a first circuit board, first and second circuit elements disposed on the first circuit board, and an image sensor conductively connected to the first circuit board; and a support board connecting the first circuit board and the stationary unit and configured to support the moving unit so as to be movable in a direction perpendicular to an optical axis direction, wherein the support board includes first and second extension members coupled to the stationary unit and spaced apart from each other, wherein the first extension member includes a first terminal conductively connected to the first circuit element, and the second extension member includes a second terminal conductively connected to the second circuit element and the first terminal, and wherein the first circuit board does not include a wiring conductively connecting the first circuit element and the second circuit element.

A camera device according to another embodiment includes a stationary unit including a cover member; a moving unit disposed inside the stationary unit and including a first circuit board and an image sensor conductively connected to the first circuit board; a support board connected to the stationary unit and the moving unit and configured to support the moving unit so as to be movable in a direction perpendicular to the optical axis direction; and a heat dissipation member disposed on the stationary unit and including a first region connected to the support board and a second region connected to the cover member.

The support board may include a pad contacting the first region of the heat dissipation member. The pad may be connected to a ground terminal of the support board.

The pad may be disposed on one region of the support board which is connected to the stationary unit.

The cover member includes an upper plate and a side plate extending from the upper plate, the stationary unit includes an extension portion disposed between the side plate and the support board, and the heat dissipation member may be disposed on the extension portion of the stationary unit.

The heat dissipation member may be disposed on the extension portion of the stationary unit, and the first region may be in contact with the side plate of the cover member. The heat dissipation member may be disposed on the extension portion of the stationary unit, and the first region may be in contact with the upper plate of the cover member.

The heat dissipation member may be disposed on an outer surface of the extension portion of the stationary unit, and the first region may be in contact with the side plate of the cover member. The heat dissipation member may include a first portion disposed on a first surface of the extension portion facing the support board and including the first region, and a second portion disposed on a second surface of the extension portion facing the side plate of the cover member and including the second region. The heat dissipation member may be a metal member.

The stationary unit includes a second circuit board arranged under the first circuit board, the support board includes a terminal coupled with the second circuit board, and the pad may be disposed at an upper side of the terminal of the support board.

The stationary unit includes a housing disposed on the moving unit; and a base disposed under the moving unit and including a protruding portion coupled with the support board, and the extension portion of the stationary unit may extend from a side portion of the housing.

The support board may include a pad disposed on the protruding portion of the base and in contact with the first region of the heat dissipation member.

The protruding portion of the base may be disposed between the side portion of the housing and the side plate of the cover member.

The support board includes a conductive pattern conductively connecting the terminal and the first circuit board, and the pad may be formed on the conductive pattern.

A camera device according to another embodiment includes a stationary unit including a base and a second circuit board coupled with the base; a moving unit including a first circuit board and an image sensor conductively connected to the first circuit board; a support board connected to the stationary unit and the moving unit and configured to support the moving unit so as to be movable in a direction perpendicular to the optical axis direction; and a heat dissipation member including a first portion disposed on the base and connected to the support board, and a second portion connected to the second circuit board.

The support board may include a pad that contacts the first region of the heat dissipation member, and the second circuit board may include a pad that contacts the second region of the heat dissipation member.

The base may include a protruding portion coupled to the support board, and the heat dissipation member may be disposed on the protruding portion of the base.

### Advantageous Effects

The embodiment sufficiently withstand impact or stress caused by movement of a moving portion of the support board during OIS operation and can inhibit cracks from occurring in the wiring of the terminal portion of the support board by making a width of the wiring closest to the bent region of the support board larger than a width of another wiring of the support board.

In addition, in the embodiment, noise introduced from the outside can be blocked from being transmitted to signal wiring by the ground wiring disposed on an edge region of the terminal portion of the support board, and thereby the performance of the camera module ca be improved.

In addition, in the embodiment, the lane is disposed in the order immediately following the ground wiring disposed adjacent to the outermost side of the terminal portion, and thereby the number of ground terminals required to shield the lane can be reduced and the number of terminals of the terminal portion of the support board.

In addition, in the embodiment, the lanes are disposed at two terminal portions, the two terminal portions are disposed at the same side so as to correspond to, face, or overlap each other. Therefore, a length of the wiring of each lane may be matched or a difference in the lengths of the wirings of the lane can be reduced, and the performance of the image sensor can be improved.

In addition, in the embodiment, the number of wirings of the first circuit board for electrical connection between the circuit elements of the first circuit board and the terminals of the support board can be reduced through electrical connection between the extension members of the support board.

In the embodiment, the degree of freedom in the design of the wiring of the support board can be improved through the electrical connection between the extension members.

In the embodiment, the degree of freedom in the design of the first circuit board can be improved as the number of wirings is reduced.

In addition, in the embodiment, the wiring (inner layer) connected between the circuit elements of the first circuit board can be omitted.

In addition, since the wiring which is the inner layer, is omitted in the embodiment, noise transfer due to overlapping between the inner layer and another wiring layer can be inhibited.

In the embodiment, the heat generated in the OIS moving unit can be directly released to the cover member through the heat dissipation member disposed between the support board connecting the OIS moving unit and the stationary unit and the cover member, and thereby the heat dissipation efficiency can be improved.

In the embodiment, since the heat dissipation member is structured to be inserted into the housing, the durability or rigidity of the housing can be increased, the stationary unit can be inhibited from damage due to impact, and the impact stress received by the stationary unit can be alleviated.

In addition, in the embodiment, the pad can be formed by removing the insulating layer of the support board, for example, a part of the cover layer and exposing a part of the conductive pattern of the support board which is connected to the ground terminal. As a result, in the embodiment, the heat dissipation efficiency can be easily improved without significantly changing the structure of the camera device and without changing the size of the camera device.

In the embodiment, the ground of the substrate member can be connected to the heat dissipation member disposed at the housing, and thereby the heat dissipation efficiency can be improved.

In the embodiment, the heat generated during the operation of the image sensor can be easily transferred and released to the cover member through the heat dissipation member and, thereby the performance of the image sensor can be inhibited from being deteriorated due to heat.

In addition, the embodiment can improve heat dissipation efficiency and can reduce negative impacts on the optical device caused by heat generated in the camera device when the camera device is mounted on the optical device.

### DESCRIPTION OF DRAWINGS

FIG. 1 is a perspective view of a camera device according to an embodiment;

FIG. 2 is a perspective view of the camera device from which a cover member is removed;

FIG. 3 is an exploded perspective view of the camera device shown in FIG. 1;

FIG. 4A is a cross-sectional view of the camera device taken along line A-B in FIG. 1;

FIG. 4B is a cross-sectional view of the camera device taken along line C-D in FIG. 1;

FIG. 4C is a cross-sectional view of the camera device taken along line E-F in FIG. 1;

FIG. 5 is an exploded perspective view of the AF operation unit shown in FIG. 3;

FIG. 6 is a perspective view of a bobbin, a sensing magnet, a balancing magnet, a first coil, a circuit board, a first position sensor, and a capacitor;

FIG. 7A is a perspective view of the bobbin, a housing, the circuit board, an upper elastic member, the sensing magnet, and the balancing magnet;

FIG. 7B is a perspective view of the embodiment shown in FIG. 7A to which a wire is added;

FIG. 8 is a bottom perspective view of the housing, the bobbin, a lower elastic member, a magnet, and the circuit board;

FIG. 9 is a perspective view of an image sensor unit;

FIG. 10A is a first exploded perspective view of the image sensor unit shown in FIG. 9;

FIG. 10B is a second exploded perspective view of the image sensor unit shown in FIG. 9;

FIG. 10C is an enlarged view of a groove of the holder shown in FIG. 10A;

FIG. 10D is an enlarged view of the terminal member shown in FIG. 10A;

FIG. 10E is an enlarged view of a groove in the base shown in FIG. 10A;

FIG. 10F is an enlarged view of a groove in the holder in which the terminal member shown in FIG. 10B is disposed;

FIG. 11 is a bottom perspective view of the holder, the terminal member, the first substrate unit, the support board, the base, and the second substrate unit shown in FIG. 10A;

FIG. 12 is a plan view of the holder, the first substrate unit, the image sensor, the second coil, and the OIS position sensor;

FIG. 13 is a rear perspective view of the holder and the first substrate unit;

FIG. 14 is a perspective view of the base, the terminal member and the wire;

FIG. 15 is a bottom view of the first substrate unit, the support board, and the heat dissipation member;

FIG. 16 is a perspective view of the first substrate unit, the support board, and the heat dissipation member;

FIG. 17A is a first perspective view of the support board coupled to the holder and the base;

FIG. 17B is a second perspective view of the support board coupled to the holder and the base;

FIG. 18A illustrates movement of the OIS moving unit in the x-axis direction;

FIG. 18B illustrates movement of the OIS moving unit in the y-axis direction;

FIG. 18C is for explaining a clockwise rotation of the OIS moving unit in the case of driving through four channels.

FIG. 18D is for explaining a counterclockwise rotation of the OIS moving unit in the case of driving through four channels;

FIG. 19A illustrates an embodiment of the magnet shown in FIG. 5;

FIG. 19B illustrates another embodiment of the magnet shown in FIG. 5;

FIG. 20A illustrates disposition of the first to third regions of the second substrate unit, the extension region, the AF moving unit, the OIS moving unit, and the controller according to an embodiment;

FIG. 20B is a schematic cross-sectional view of the lens module, the first substrate unit, the image sensor, the second substrate unit, and the heat dissipation member;

FIG. 21 is a block diagram of the configuration of the controller and the first to third sensors;

FIG. 22A shows a conductive pattern of two adjacent extension members of FIG. 17A.

FIG. 22B shows a conductive pattern of two adjacent extension members of FIG. 17B.

FIGS. 23A to 23D are enlarged views of the extension members of FIGS. 22A and 22B.

FIG. 24 shows a comparative example in which the ground wiring is omitted in the extension member of FIG. 23A.

FIG. 25 shows the arrangement of terminals of the extension members of the support board.

FIG. 26 is a perspective view of the image sensor unit according to another embodiment.

FIG. 27 is a bottom perspective view of the holder, the terminal member, the first substrate unit, the support board, the heat dissipation member, the base, and the second substrate unit of FIG. 26.

FIG. 28 is a perspective view of the first substrate unit, the support board, and the heat dissipation member of FIG. 27.

FIG. 29A is a first perspective view of the support board coupled to the holder and the base of FIG. 27.

FIG. 29B is a second perspective view of the support board coupled to the holder and the base of FIG. 27.

FIG. 30A is an enlarged view of the terminal of the first support board and the terminal of the second support board of FIG. 27.

FIG. 30B shows the terminal of the first support board and the terminal of the second support board of FIG. 30A, and the solder or the conductive adhesive.

FIG. 30C shows the terminal of the first support board and the terminal of the second support board, and the solder or the conductive adhesive.

FIG. 31 shows an electrical connection relationship of the first circuit board, the terminal of the first support board, the terminal of the second support board, and the terminal of the support board of FIG. 27.

FIG. 32 shows a connection relationship between terminals of the support board of FIG. 27 and the circuit element of the first circuit board.

FIG. 33 shows a connection relationship between terminals of the support board and the circuit element of the first circuit board in a comparative example in which the terminals of FIG. 32 are not provided.

FIG. 34 is a perspective view of a camera device according to another embodiment with the cover member removed.

FIG. 35 is a cross-sectional view of the camera device of FIG. 34 in the CD direction of FIG. 1.

FIG. 36 is an exploded perspective view of the AF driving unit of the camera device of FIG. 34.

FIG. 37A is a perspective view of the bobbin, the housing, the circuit board, the upper elastic member, the sensing magnet, and the balancing magnet of an embodiment according to FIG. 34.

FIG. 37B is a perspective view of FIG. 37A with a wire added.

FIG. 38 is a bottom perspective view of the housing, the bobbin, the lower elastic member, the magnet, and the circuit board of FIG. 36.

FIG. 39 is a perspective view of the image sensor unit of the camera device of FIG. 34.

FIG. 40A is a first exploded perspective view of the image sensor unit of FIG. 39.

FIG. 40B is a second exploded perspective view of the image sensor unit of FIG. 39.

FIG. 41 is a bottom perspective view of the holder, the terminal member, the first substrate unit, the support board, the heat dissipation member, the base, and the second substrate unit of FIG. 40A.

FIG. 42 is a perspective view of the first substrate unit, the support board, and the heat dissipation member of FIG. 34.

FIG. 43A is a first perspective view of the support board coupled to the holder and the base of FIG. 39.

FIG. 43B is a second perspective view of the support board coupled to the holder and the base of FIG. 39.

FIG. 44A shows the conductive patterns of two adjacent extension members of FIG. 43A.

FIG. 44B shows the conductor patterns of two adjacent extension members of FIG. 43B.

FIG. 45 shows the arrangement of terminals of the extension members of the support board of FIG. 44A.

FIG. 46 is an enlarged view of the heat dissipation member of FIG. 35.

FIG. 47 shows another embodiment of the heat dissipation member of FIG. 46.

FIG. 48 shows another embodiment of the heat dissipation member of FIG. 46.

FIG. 49 shows another embodiment of the heat dissipation member of FIG. 46.

FIG. 50A shows a perspective view of an optical device according to an embodiment.

FIG. 50B shows a perspective view of an optical device according to another embodiment.

FIG. 51 shows a configuration diagram of the optical device illustrated in FIGS. 50A and 50B.

### BEST MODE

Hereinafter, embodiments of the present invention will be described in detail with reference to the accompanying drawings.

The technical idea of the present invention may be embodied in many different forms, and should not be construed as being limited to the following embodiments set forth herein. One or more of components of the embodiments may be selectively combined with each other or replaced without departing from the technical spirit and scope of the present invention.

Unless otherwise particularly defined, terms (including technical and scientific terms) used in the embodiments of the present invention have the same meanings as those commonly understood by one of ordinary skill in the art to which this invention belongs. It will be further understood that commonly used terms, such as those defined in dictionaries, should be interpreted as having meanings consistent with their meanings in the context of the relevant art.

The terminology used in the embodiments of the present invention is for the purpose of describing particular embodiments only, and is not intended to limit the present invention. As used in the disclosure and the appended claims, the singular forms are intended to include the plural forms as well, unless the context clearly indicates otherwise. The phrase “at least one (or one or more) of A, B and C” may be interpreted as including one or more of all combinations of A, B and C.

Furthermore, when describing the components of the present invention, terms such as “first”, “second”, “A”, “B”, “(a)” or “(b)” may be used. Since these terms are provided merely for the purpose of distinguishing the components from each other, they do not limit the nature, sequence or order of the components.

It should be understood that, when an element is referred to as being “linked”, “coupled” or “connected” to another element, the element may be directly “linked”, “coupled” or “connected” to the another element, or may be “linked”, “coupled” or “connected” to the another element via a further element interposed therebetween. Furthermore, it will be understood that, when an element is referred to as being formed “on” or “under” another element, it can be directly “on” or “under” the other element, or can be indirectly disposed with regard thereto, with one or more intervening elements therebetween. In addition, it will also be understood that “on” or “under” the element may mean an upward direction or a downward direction based on the element.

Hereinafter, an AF operation unit may be alternatively referred to as a “lens driving apparatus”, a “VCM (Voice Coil Motor)”, an “actuator” or a “lens moving device”. Hereinafter, the term “coil” may be interchangeably used with “coil unit”, or “coil portion”, and the term “elastic member” may be interchangeably used with “elastic unit” or “spring”.

In the follow description, the “terminal” may be alternatively referred to as a “pad”, “electrode”, “conductive layer” or “bonding portion”.

In the following description, the terms “board unit”, “printed circuit board”, “circuit board”, and “substrate” may be used interchangeably with one another.

For the convenience of description, although the camera module according to an embodiment is described using a rectangular coordinate system (x, y, z), the lens moving apparatus may be described using some other coordinate systems, and the embodiments are not limited thereto. In the respective drawings, the X-axis direction and the Y-axis direction mean directions perpendicular to the Z-axis which is an optical axis direction. The Z-axis direction, which is the direction of the optical axis OA, may be referred to as a “first direction”, the X-axis direction may be referred to as a “second direction”, and the Y-axis direction may be referred to as a “third direction”. Furthermore, for example, the x-axis direction may be represented as “one of a first horizontal direction and a second horizontal direction”, and the y-axis direction may be represented as “the other of the first horizontal direction and the second horizontal direction”.

For example, the optical axis may be the optical axis of a lens mounted on a lens barrel. Alternatively, for example, the optical axis may be an axis that is perpendicular to an imaging area of the image sensor and passes through a center of the imaging area.

The first direction may be a direction perpendicular to an imaging area of an image sensor. Furthermore, the optical-axis direction may be a direction parallel to the optical axis.

The camera device according to an embodiment of the present invention is capable of performing an “autofocus function”. Here, the “autofocus function” serves to automatically focus an image of a subject on an image sensor surface.

Hereinafter, the camera device may alternatively be referred to as a “camera module”, a “camera assembly”, a “camera unit”, a “camera”, an “imaging device”, or a “lens moving apparatus”.

In addition, the camera device according to the embodiment may perform a function of “Optical Image Stabilization”. Here, the function of “Optical Image Stabilization” may serve to inhibit the contour line of a captured image from being blurred due to vibration caused by shaking of the user's hand when capturing a still image.

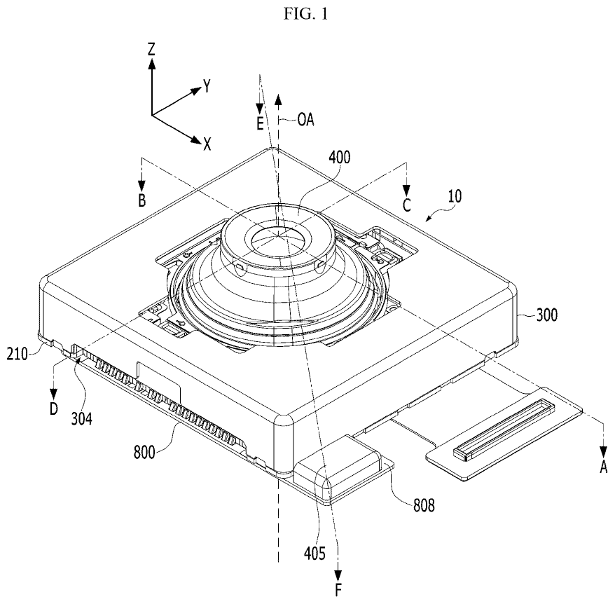

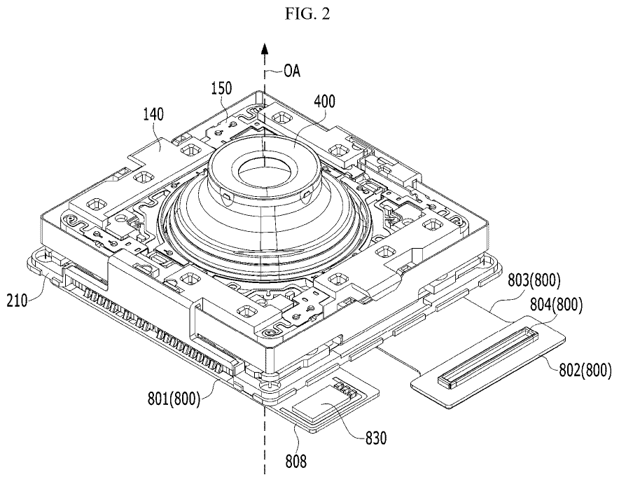

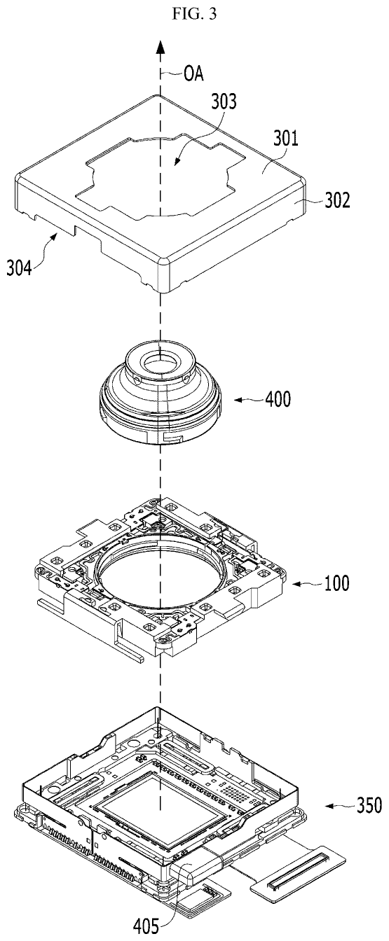

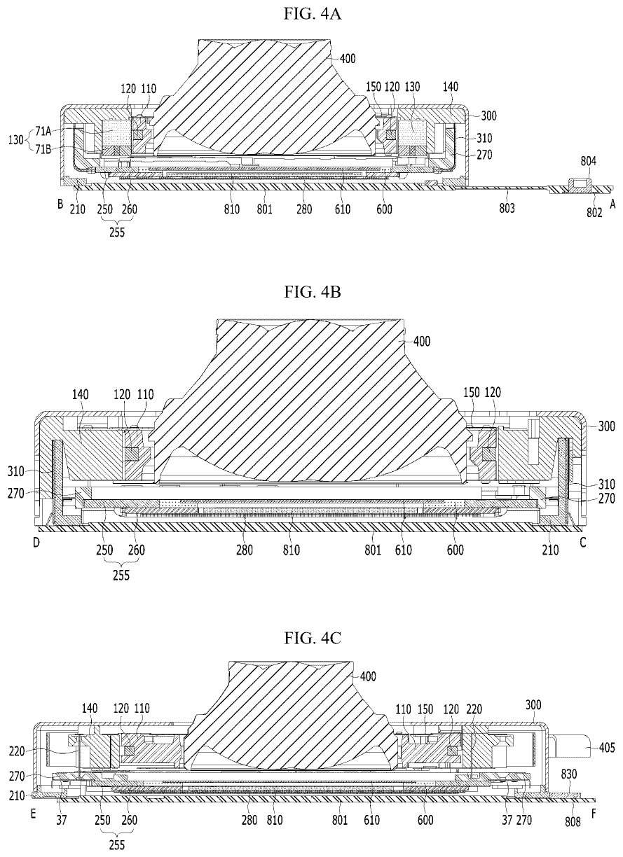

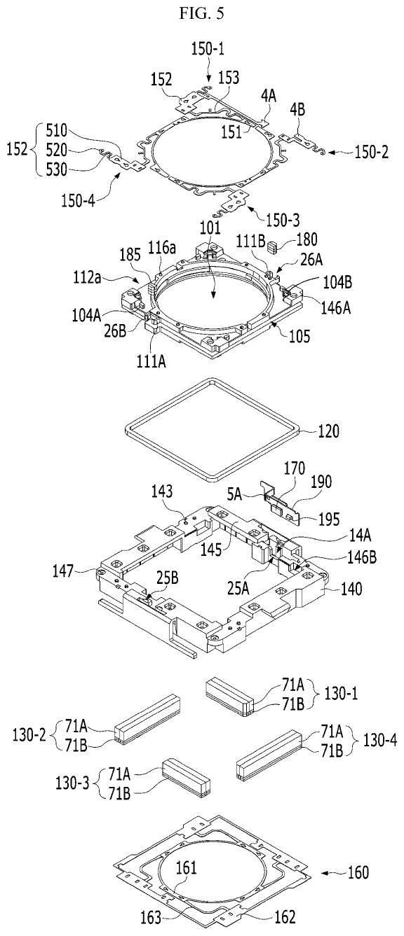

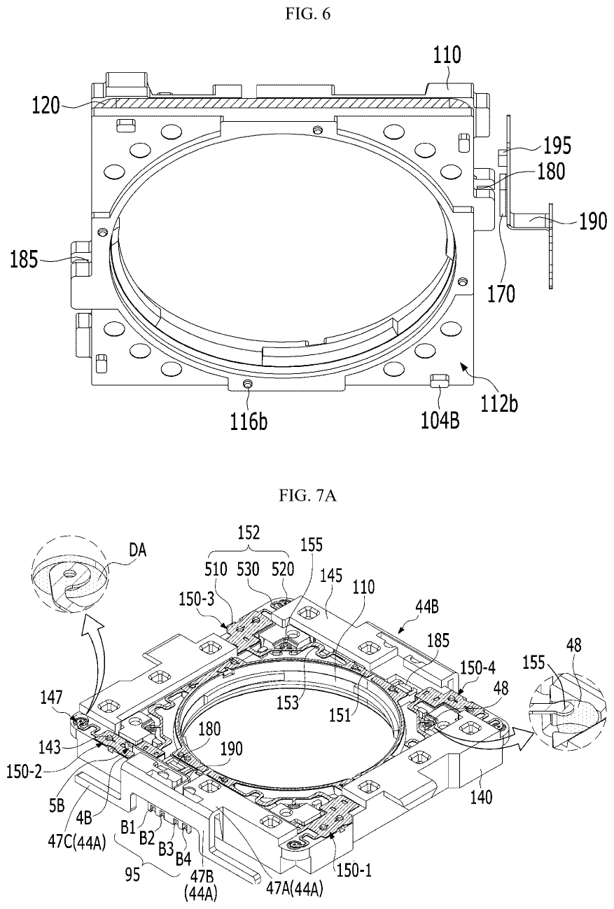

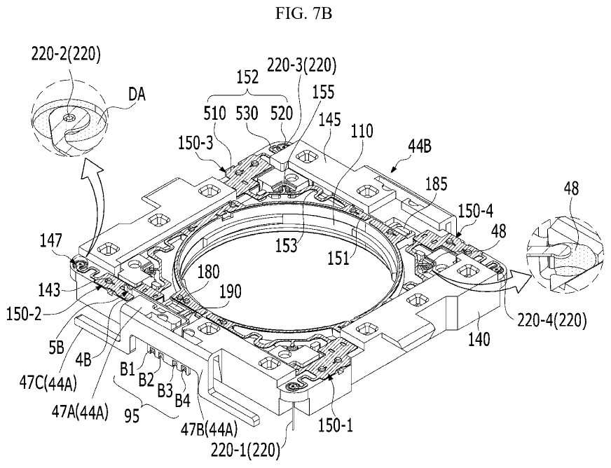

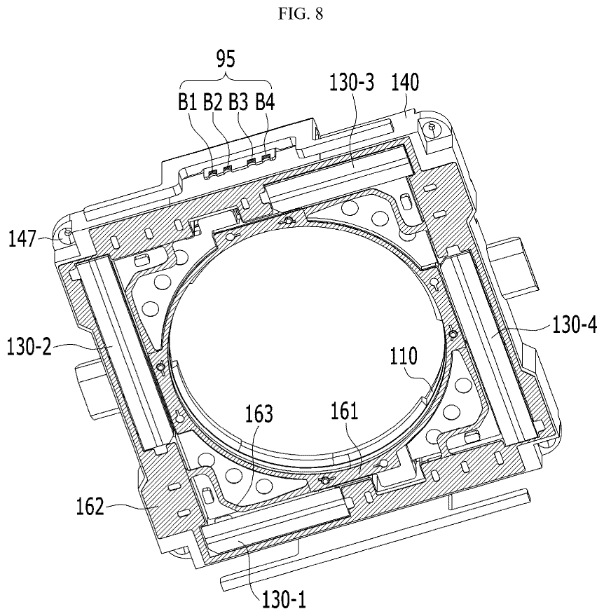

FIG. 1 is a perspective view of a camera device 10 according to an embodiment, FIG. 2 is a perspective view of the camera device 10 from which a cover member 300 is removed, FIG. 3 is an exploded perspective view of the camera device 10 shown in FIG. 1, FIG. 4A is a cross-sectional view of the camera device 10 taken along line A-B in FIG. 1, FIG. 4B is a cross-sectional view of the camera device 10 taken along line C-D in FIG. 1, FIG. 4C is a cross-sectional view of the camera device 10 taken along line E-F in FIG. 1, FIG. 5 is an exploded perspective view of the AF driving unit 100 shown in FIG. 3, FIG. 6 is a perspective view of a bobbin 110, a sensing magnet 180, a balancing magnet 185, a first coil 120, a circuit board 190, a first position sensor 170, and a capacitor 195, FIGS. 7A and 7B are perspective views of the bobbin 110, a housing 140, the circuit board 190, an upper elastic member 150, the sensing magnet 180, and the balancing magnet 185, FIG. 8 is a bottom perspective view of the housing 140, the bobbin 110, a lower elastic member 160, a magnet 130, and the circuit board 190.

Referring to FIGS. 1 to 8, the camera device 10 may include an AF driving unit 100 and an image sensor unit 350. The AF driving unit 100 may include an AF moving unit. The image sensor unit 350 may include an OIS driving unit. The OIS driving unit may include an OIS moving unit. One of the AF moving unit and the OIS moving unit may be a first moving unit, and the other one of the AF moving unit and the OIS moving unit may be a second moving unit.

The camera device 10 may further include at least one of the cover member 300 and the lens module 400. The cover member 300 and the base 210 described below may form a case.

The AF driving unit 100 is coupled with the lens module 400 and moves the lens module in the optical axis direction or in a direction parallel to the optical axis OA, and the auto-focusing function of the camera device 10 can be performed by the AF driving unit 100.

The image sensor unit 350 can include the image sensor 810. For example, the image sensor unit 350 (or OIS driving unit) can include an OIS moving unit including the image sensor 810. For example, the image sensor unit 350 can move the OIS moving unit (e.g., the image sensor 810) in a direction perpendicular to the optical axis. In addition, the image sensor unit 350 can tilt or rotate (or roll) the OIS moving unit (e.g., the image sensor 810) with respect to the optical axis or with the optical axis as a rotation axis. The image sensor unit 350 may perform the optical image stabilization of the camera device 10.

For example, the image sensor 810 may include an imaging area for detecting light passing through the lens module 400. Here, the imaging area may be expressed as an effective area, a light-receiving area, an active area, or a pixel area. For example, the imaging area of the image sensor 810 is a region where light passing through the filter 610 is incident and an image containing the light is formed, and may include at least one unit pixel. For example, the imaging area may include a plurality of unit pixels.

The AF driving unit 100 may be expressed as a “lens moving unit” or a “lens driving device.” Alternatively, the AF driving unit 100 may be expressed as a “first moving unit (or second moving unit)”, a “first actuator (or second actuator)”, or an “AF driving unit”.

Also, the image sensor unit 350 may be expressed as an “image sensor moving unit”, an “image sensor shift unit”, a “sensor moving unit”, or a “sensor shift unit”. Alternatively, the image sensor unit 350 may be expressed as a second moving unit (or first moving unit) or a “second actuator (or first actuator)”.

Referring to FIGS. 5 and 6, the AF driving unit 100 may move the lens module 400 in the optical axis direction. For example, the AF driving unit 100 may move the bobbin 110 in the optical axis direction. For example, the AF driving unit 100 may include a bobbin 110, a first coil 120, a magnet 130, and a housing 140. The AF driving unit 100 may further include an upper elastic member 150 and a lower elastic member 160.

In addition, the AF driving unit 100 may further include a first position sensor 170, a circuit board 190, and a sensing magnet 180 for AF feedback driving. In addition, the AF driving unit 100 may further include at least one of a balancing magnet 185 and a capacitor 195.

The bobbin 110 may be disposed inside the housing 140 and may be moved in the direction of the optical axis OA or the first direction (e.g., the Z-axis direction) by electromagnetic interaction between the first coil 120 and the magnet 130.

The bobbin 110 may have an opening for coupling with the lens module 400 or mounting the lens module 400. For example, the opening of the bobbin 110 may be a through hole penetrating the bobbin 110 in the optical axis direction, and a shape of the opening of the bobbin 110 may be circular, oval, or polygonal, but is not limited thereto.

The lens module 400 may include at least one lens and/or a lens barrel. For example, the lens module 400 may include one or more lenses and a lens barrel that accommodates the one or more lenses. However, one configuration of the lens module is not limited to the lens barrel, and any holder structure capable of supporting one or more lenses may be used.

For example, the lens module 400 may be screw-coupled with the bobbin 110 as an example. Or, for example, the lens module 400 may be coupled to the bobbin 110 by an adhesive (not shown) as an example. Meanwhile, light passing through the lens module 400 may pass through the filter 610 and be irradiated to the image sensor 810.

The bobbin 110 may include at least one protruding portion 111A and 111B provided on the outer surface thereof. For example, at least one protruding portion 111A and 111B may protrude in a direction parallel to a straight line perpendicular to the optical axis OA, but is not limited thereto. For example, the bobbin 110 may include two protruding portions 111A and 111B positioned opposite to each other.

The protruding portions 111A and 111B of the bobbin 110 correspond to the grooves 25A and 25B of the housing 140, and may be inserted or placed within the grooves 25A and 25B of the housing 140, and may suppress or inhibit the bobbin 110 from rotating more than a certain range around the optical axis.

The bobbin 110 may include a protruding portion 146A that protrudes in a direction perpendicular to the optical axis. For example, the protruding portion 146A of the bobbin 110 may be disposed at a corner of the bobbin 110.

The housing 140 may include a recess 146B corresponding to, opposite to, or overlapping the protruding portion 146A of the bobbin 110. At least a portion of the protruding portion 146A of the bobbin 110 may be disposed in the recess 146B of the housing 140.

The protruding portion 146A of the bobbin 110 may act as a stopper to allow the bobbin 110 to move within a defined range in the optical axis direction (e.g., in a direction from the upper elastic member 150 to the lower elastic member 160).

A first escape groove 112a may be provided on the upper surface of the bobbin 110 to avoid spatial interference with the first frame connection portion 153 of the upper elastic member 150. In addition, a second escape groove 112b may be provided on the lower surface of the bobbin 110 to avoid spatial interference with the second frame connection portion 163 of the lower elastic member 160.

The bobbin 110 may include a first coupling portion 116a for being coupled and fixed to the upper elastic member 150. For example, the first coupling portion 116a of the bobbin 110 may be in the form of a protrusion, but is not limited thereto, and in other embodiments, may be in the form of a plane or a groove. In addition, the bobbin 110 may include a second coupling portion 116b for being coupled and fixed to the lower elastic member 160. For example, the second coupling portion 116b may be in the form of a protrusion, but is not limited thereto, and in other embodiments, may be in the form of a flat surface or a groove.

Referring to FIG. 5, a groove 105 may be provided on the outer surface of the bobbin 110 on which the first coil 120 is seated, inserted, or disposed. For example, the groove 105 of the bobbin 110 may have a shape that matches the shape of the first coil 120 or a closed curve shape (e.g., a ring shape).

In addition, the bobbin 110 may include a first seating groove 26a in which the sensing magnet 180 is seated, inserted, fixed, or disposed. In addition, the bobbin 110 may include a second seating groove 26b in which the balancing magnet 185 is seated, inserted, fixed, or disposed.

For example, the first and second seating grooves 26a and 26b of the bobbin 110 may be formed on the outer surfaces of the bobbin 110 facing each other. For example, the first seating groove 26a may be formed at the first protruding portion 111A of the bobbin 110, and the second seating groove 26b may be formed at the second protruding portion 111B of the bobbin 110.

The bobbin 110 may include a guide protrusion 104A for guiding a portion of the first frame connection portion 153 of the upper elastic member 150. For example, the guide protrusion 104A may be protruded from the bottom surface of the escape portion 112a of the bobbin 110.

Referring to FIGS. 5, 7A, and 7B, a damper 48 may be disposed between the bobbin 110 and the upper elastic member 150. For example, the damper 48 may be disposed between the bobbin 110 and the first frame connection portion 153 of the upper elastic member 150, and may be in contact with, coupled with, or attached to both of the bobbin 110 and the first frame connection portion 153.

For example, the upper elastic member 150 may include an extension portion (or protruding portion) 155 extending from the first frame connection portion 153. The extension portion 155 may be spaced apart from each of the outer frame 152 and the inner frame 151. In addition, the extension portion 155 may be spaced apart from one end of the first frame connection portion 153 connected to the inner frame 151 and the other end of the first frame connection portion 153 connected to the outer frame 152. The extension portion 155 may extend onto the upper surface of the bobbin 110.

For example, a portion (or an end) of the extension portion 155 may be disposed on the damper 48 disposed on the upper surface of the bobbin 110 and may overlap the damper 48. For example, the bobbin 110 may include a receiving portion 104B for receiving or disposing the damper 48. For example, the receiving portion 104B may be a groove. The receiving portion 104B may be recessed from the bottom surface of the escape portion 112a of the bobbin 110.

For example, the damper 48 may be disposed between the receiving portion 104B of the bobbin 110 and the extension portion 155 of the upper elastic member 150, and may be in contact with, coupled to, or attached to both of the receiving portion 104B and the extension portion 155. The damper 48 may be attached to or brought into contact with the extension portion 155 and the receiving portion 104B of the bobbin 110 to buffer or absorb vibration of the bobbin 110. For example, the damper 48 may be formed of a damping material (e.g., silicon).

The first coil 120 is disposed on the bobbin 110 or coupled with the bobbin 110. For example, the first coil 120 may be disposed on or coupled to the outer side surface of the bobbin 110. For example, the first coil 120 may surround the outer side surface of the bobbin 110 in a direction that rotates around the optical axis OA, but is not limited thereto.

The first coil 120 may be wound directly on the outer side surface of the bobbin 110, but is not limited thereto, and according to another embodiment, the first coil 120 may be wound on the bobbin 110 using a coil ring, or may be provided as a coil block in the shape of an angled ring.

A power or a driving signal may be supplied to the first coil 120. The power or the driving signal supplied to the first coil 120 may be a direct current signal or an alternating current signal, or may include a direct current signal and an alternating current signal, and may be in the form of a voltage or a current.

When a driving signal (e.g., a driving current) is supplied to the first coil 120, the first coil 120 may form an electromagnetic force by an electromagnetic interaction with the magnet 130, and the bobbin 110 may be moved in the optical axis direction by the formed electromagnetic force.

At an initial position of the AF moving unit, the bobbin 110 can be movable in an upward or downward direction, which is called a bidirectional driving of the AF moving unit. Or, at the initial position of the AF moving unit, the bobbin 110 can be movable in an upward direction, which is called a unidirectional driving of the AF moving unit.

At the initial position of the AF moving unit, the first coil 120 can be disposed to correspond to or overlap with the magnet 130 disposed at the housing 140 in a direction perpendicular to the optical axis OA and parallel to a straight line passing through the optical axis.

For example, the AF moving unit may include the bobbin 110 and components coupled to the bobbin 110 (e.g., the first coil 120, the sensing magnet 180, and the balancing magnet 185. In addition, the AF moving unit may further include the lens module 400.

And the initial position of the AF moving unit may be an original position of the AF moving unit in the state in which no power is supplied to the first coil 120 or the position where the AF moving unit is placed when the upper and lower elastic members 150 and 160 are elastically deformed only by the weight of the AF moving unit. In addition, the initial position of the bobbin 110 may be the position where the AF moving unit is placed when the gravity acts from the bobbin 110 toward the base 210, or conversely, when the gravity acts from the base 210 toward the bobbin 110.

The sensing magnet 180 can provide a magnetic field that can be detected by the first position sensor 170, and the balancing magnet 185 can serve to cancel out the influence of the magnetic field of the sensing magnet 180 and play a role in balancing the weight with respect to the sensing magnet 180.

The sensing magnet 180 can be expressed as a “sensor magnet” or a “second magnet”. In addition, the balancing magnet 185 can be expressed as a “weight member”, a “balancing member”, or a “weight balancing member”.

The sensing magnet 180 can be disposed on the bobbin 110 or coupled to the bobbin 110. The sensing magnet 180 can be disposed to face the first position sensor 170. The balancing magnet 185 can be disposed on the bobbin 110 or coupled to the bobbin 110. For example, the balancing magnet 185 may be disposed to be opposite to the sensing magnet 180.

For example, each of the sensing magnet 180 and the balancing magnet 185 may be a unipolar magnet having single N pole and single S pole, but is not limited thereto. In another embodiment, each of the sensing magnet 180 and the balancing magnet 185 may be a bipolar magnet or a quadrupolar magnet having two N poles and two S poles.

The sensing magnet 180 may move in the optical axis direction together with the bobbin 110, and the first position sensor 170 may detect the strength of the magnetic field or the magnetic force of the sensing magnet 180 moving in the optical axis direction, and output an output signal according to the detected result.

For example, the intensity or magnetic force of the magnetic field detected by the first position sensor 170 may change according to the displacement of the bobbin 110 in the optical axis direction, and the first position sensor 170 may output an output signal proportional to the intensity of the detected magnetic field, and the displacement of the bobbin 110 in the optical axis direction may be detected using the output signal of the first position sensor 170.

The housing 140 is disposed in the cover member 300. For example, the housing 140 may be disposed on the image sensor unit 350.

The housing 140 may accommodate the bobbin 110 therein, and may support the magnet 130, the first position sensor 170, and the circuit board 190.

Referring to FIGS. 5, and 7A-8, the housing 140 may be configured to have an overall hollow column shape. For example, the housing 140 may have a polygonal (e.g., quadrangle or octagonal) or circular opening, and the opening of the housing 140 may be a through hole shape penetrating the housing 140 in the optical axis direction.

The housing 140 may include side portions corresponding to or facing the side plate 302 of the cover member 300 and corners corresponding to or facing the corners of the cover member 300.

In order to inhibit direct collision with the inner surface of the top plate 301 of the cover member 300, the housing 140 may include a stopper 145 provided on the upper portion, the upper surface, or upper end thereof.

Referring to FIG. 5, the housing 140 may include a mounting groove 14A (or groove) for accommodating a circuit board 190. The mounting groove 14A may have a shape matching the shape of the circuit board 190.

Referring to FIGS. 7A and 7B, the housing 140 may include a protruding portion 44A and 44B that surrounds at least one of the circuit board 190 and the support board 310. For example, the protruding portion 44A and 44B may be disposed or formed on an outer side surface of the housing 140. For example, the protruding portion 44A and 44B may be disposed or formed on an outer side surface of the side portion of the housing 140. The protruding portion 44A and 44B may be expressed as a “protection portion,” a “support portion,” an “extension portion,” or a guide portion.

The protruding portion 44A and 44B of the housing 140 may surround at least a portion of the circuit board 190 and at least a portion of the support board 310. For example, the housing 140 may include a first protruding portion 44A disposed on a first side portion of the housing and a second protruding portion 44B disposed on a second side portion of the housing 140. The first protruding portion 44A and the second protruding portion 44B may be disposed to be opposite to each other with respect to the optical axis OA or the bobbin 110. In other embodiments, the second protruding portion 44B may be omitted.

For example, the circuit board 190 may be disposed within the first protruding portion 44A. For example, the mounting groove 14A may be formed at the first protruding portion 44A.

For example, each of the first protruding portion 44A and the second protruding portion 44B may include a first portion 47A connected to the upper surface of the housing 140, and a second portion 47B connected to the first portion 47A and spaced apart from the side portion of the housing 140. For example, the first portion 47A of the first protruding portion 44A may be connected to the upper surface of the first side portion of the housing 140, and the first portion 47A of the second protruding portion 44B may be connected to the upper surface of the second side portion of the housing 140. For example, the first portion 47A may protrude from the upper surface of the housing 140 in the optical axis direction or in a direction toward the inner surface of the upper plate 301 of the cover member 300.

For example, at least a portion of the circuit board 190 may be disposed between the first portion 47A and the second portion 47B of the first protruding portion 44A. Also, for example, at least a portion of the support board 310 may be disposed between the first portion 47A and the second portion 47B of the first protruding portion 44A.

The housing 140 may include an opening for exposing the terminals B1 to B4 of the terminal portion 95 of the circuit board 190, and the opening may be formed on the side portion of the housing 140.

Each of the first protruding portion 44A and the second protruding portion 44B of the housing 140 may include a third portion 47C extending from the second portion 47B. For example, the third portion 47C may extend or protrude from a lower portion or lower end of the second portion 47B (e.g., the second horizontal direction) in a direction parallel to the outer side surface of the first side portion (or second side portion) of the housing 140.

For example, the third portion 47C may include a third-first portion extending from one end of the second portion 47B and a third-second portion extending from the another end of the second portion, and the third-first portion and the third-second portion may extend or protrude in opposite directions.

An adhesive or a sealing member may be disposed between the protruding portions 44A and 44B of the housing 140 and the cover member 300. For example, the adhesive (or sealing member) may be disposed between the protruding portions 44A and 44B of the housing 140 and the side plate 302 of the cover member 300, and may bond the protruding portions 44A and 44B and the side plate 302. The protruding portions 44A and 44B are configured to increase the bonding area with the side plate of the cover member 300 and stably bond the housing 140 and the cover member 300 without interference of the support board 310.

At least one first coupling portion 143 that is bonded to the first outer frame 152 of the upper elastic member 150 may be provided on the upper portion, upper end, or upper surface of the housing 140. A second coupling portion that is bonded and fixed to the second outer frame 162 of the lower elastic member 160 may be provided on the lower portion, lower end, or lower surface of the housing 140. For example, each of the first and second coupling portions of the housing 140 may be a flat surface, a protrusion shape, or a groove shape.

A hole 147 that is a path through which a wire 220 passes may be formed at a corner of the housing 140. The hole 147 may be a through hole passing through the housing 140 in the optical axis direction. In another embodiment, the hole may have a structure that is sunken from the outer side surface of the corner portion of the housing 140, and at least a portion of the hole may be opened to the outer side surface of the corner portion. The number of holes 147 of the housing 140 may be equal to the number of support members.

The magnet 130 may be disposed on, coupled to, or fixed to the housing 140, which is a stationary unit. For example, the magnet 130 may be disposed on, coupled to, or fixed to the side portion of the housing 140. The magnet 130 may include an AF driving magnet 71A for AF driving. In addition, the magnet 130 may include an OIS driving magnet 71B for OIS driving. The driving magnet 71A for AF below may be alternatively expressed as one of the first magnet and the second magnet, and the driving magnet 71B for OIS may be alternatively expressed as the other of the first magnet and the second magnet.

In another embodiment, the magnet 130 may be disposed on, coupled to, or fixed to a corner portion of the housing.

For example, the magnet 130 may include a plurality of magnet units. For example, the magnet 130 may include first to fourth magnet units 130-1 to 130-4 disposed at the housing 140. In another embodiment, the magnet 130 may include two or more magnet units.

The magnet 130 may be disposed on at least one of the side portion or the corner portion of the housing 140. For example, at least a portion of the magnet 130 may be disposed on the side portion or the corner portion of the housing 140. Or, for example, at least a portion of the magnet 130 may be disposed on the side portion of the housing 140, and the remaining portion of the magnet 130 may be disposed on the corner portion of the housing 140.

For example, each of the magnet units 130-1 to 130-4 may include a first portion disposed on a corresponding one of the four corners of the housing 140. Additionally, each of the magnet units 130-1 to 130-4 may include a second portion disposed on the side portion of the housing 140 adjacent to the corresponding one of the four corners of the housing 140.

For example, the first magnet unit 130-1 and the third magnet unit 130-3 may be positioned on opposite sides of the housing 140 in the first horizontal direction (e.g., Y-axis direction). For example, the second magnet unit 130-2 and the fourth magnet unit 130-4 may be positioned on opposite sides of the housing 140 in the second horizontal direction (e.g., X-axis direction).

For example, the first magnet unit 130-1 and the third magnet unit 130-3 may be positioned parallel to each other in the second horizontal direction (e.g., X-axis direction), and the second magnet unit 130-2 and the fourth magnet unit 130-4 may be positioned parallel to each other in the first horizontal direction (e.g., Y-axis direction).

In the initial position of the AF moving unit, the magnet 130 may be disposed at the housing 140 so as to overlap at least a portion of the first coil 120 in a direction parallel to a straight line which is perpendicular to the optical axis OA and passes through the optical axis OA.

The magnet 130 may include a unipolar magnetized magnet or a bipolar magnet including one N pole region and one S pole region. In another embodiment, the magnet 130 may include a bipolar magnetized magnet or a quadrupolar magnet including two N pole regions and two S pole regions. In another embodiment, the magnet 130 may include a unipolar magnetized magnet and a bipolar magnetized magnet.

For example, the magnet 130 may include an AF magnet (or an AF driving magnet) for performing an AF operation and an OIS magnet (or an OIS driving magnet) for performing an OIS operation. In another embodiment, for example, in another embodiment, the magnet 130 may be a common magnet for performing AF operation and OIS operation.

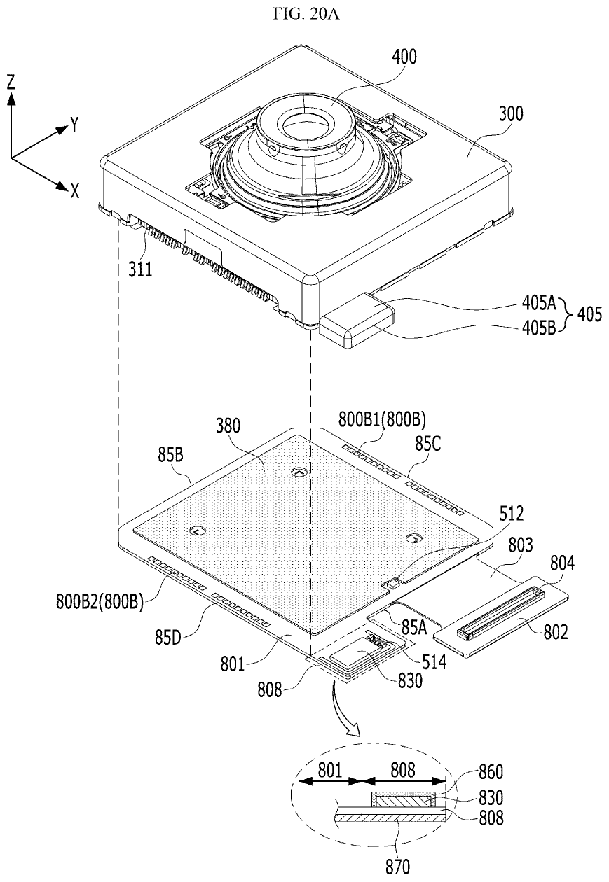

FIG. 19A illustrates an embodiment of the magnet 130 of FIG. 5.

Referring to FIG. 19A, the magnet 130 may include a first magnet 71A which is an AF magnet and a second magnet 71B which is disposed below the first magnet 71A as an OIS magnet.

The first magnet 71A may be a two-pole magnet including one N-pole region and one S-pole region. For example, the N-pole region and the S-pole region of the first magnet 71A may be disposed to face or oppose each other in a direction perpendicular to the optical axis. In another embodiment, the first magnet 71A may be a four-pole magnet including two N-pole regions and two S-pole regions.

The first magnet 71A may include a plurality of magnet units 71A1 to 71A4. As described above, each of the plurality of magnet units 71A1 to 71A4 may be a two-pole magnet or a four-pole magnet. For example, the magnet units 71A1 to 71A4 may have the same size and shape. For example, the two magnet units 71A1 and 71A3 that are opposite in a first diagonal direction may have the same size and shape, and the remaining two magnet units 71A2 and 71A4 that are opposite in a second diagonal direction may have the same size and shape.

In another embodiment, the size and shape of the two magnet units 71A1 and 71A3 may be different from the size and shape of the remaining two magnet units 71A2 and 71A4. For example, a length of the long side of each of the two magnet units 71A1, 71A3 may be greater than a length of the long side of each of the remaining two magnet units 71A2, 71A4. For example, a length of the short side of each of the two magnet units 71A1 and 71A3 may be the same as a length of the short side of each of the remaining two magnet units 71A2 and 71A4.

The second magnet 71B may be a four-pole magnet including two N-pole regions and two S-pole regions. For example, the second magnet 71B may include a first magnet portion 30A, a second magnet portion 30B, and a partition wall 30C disposed between the first magnet portion 30A and the second magnet portion 30B. At this time, the partition wall 30C may be a non-magnetic material or air, etc., and the partition wall may be alternatively expressed as a “neutral zone” or a “neutral region.” In another embodiment, the second magnet 71B may be a two-pole magnet including one N pole region and one S pole region.

For example, the first magnet portion 30A and the second magnet portion 30B may be spaced apart from each other in a direction perpendicular to the first direction (or the optical axis direction). For example, the first magnet portion 30A may include a first N pole region and a first S pole region that face or oppose each other in the optical axis direction. The second magnet portion 30B may include a second N pole region and a second S pole region that are opposite or facing each other in the direction of the optical axis. In addition, the first N pole region (or the first S pole region) of the first magnet portion 30A and the second S pole region (or the second N pole region) of the second magnet portion 30B may be opposite or facing each other in the direction perpendicular to the optical axis.

The second magnet 71B may include a plurality of magnet units 71B1 to 71B4. Each of the plurality of magnet units 71B1 to 71B4 may be a four-pole magnet as described above. In another embodiment, each of the magnet units 71B1 to 71B4 may be a two-pole magnet. Each of the magnet units 71B1 to 71B4 may be opposite or overlapped with a corresponding one of the second coil units 230-1 to 230-4 in the optical axis direction.

For example, the magnet units 71B1 to 71B4 may have the same size and shape. For example, the two magnet units 71B1 and 71B3 that are opposite in the first diagonal direction may have the same size and shape, and the remaining two magnet units 71B2 and 71B4 that are opposite in the second diagonal direction may have the same size and shape.

In another embodiment, the size and shape of the two magnet units 71B1 and 71B3 may be different from the size and shape of the remaining two magnet units 71B2 and 71B4. For example, the length of the long side of each of the two magnet units 71B1 and 71B3 may be greater than the length of the long side of each of the remaining two magnet units 71B2 and 71B4. For example, the length of the short side of each of the two magnet units 71B1 and 71B3 may be the same as the length of the short side of each of the remaining two magnet units 71B2 and 71B4.

The second magnet 71B may be disposed below the first magnet 71A. The second magnet 71B may be disposed on the lower surface of the first magnet 71A. For example, the upper surface of the second magnet 71B may be in contact with the lower surface of the first magnet 71A or may be fixed or coupled to the lower surface of the first magnet 71A by an adhesive. For example, at least a portion of the first magnet 71A may overlap at least a portion of the second magnet 71B in the first direction (or optical axis direction).

In another embodiment, the second magnet may be spaced apart from the first magnet. In this case, a portion of the housing 140 may be disposed between the first magnet and the second magnet. Or, in another embodiment, a partition wall or a yoke may be disposed between the spaced apart first magnet and the second magnet. In this case, the description of the partition wall 30C may be applied or analogically applied to the partition wall.

For example, the length T2 of the second magnet 71B in the optical axis direction may be smaller than the length T1 of the first magnet 71A in the optical axis direction T2<T1. In another embodiment, T2 may be greater than or equal to T1.

In addition, the length L2 of the long side of the second magnet 71B may be less than or equal to the length L1 of the long side of the first magnet 71A (L2≤L1). In another embodiment, L2 may be greater than L1.

In addition, the width W2 (or the length of the short side) of the second magnet 71B may be smaller than or equal to the width W1 (or the length of the short side) of the first magnet 71A (W2≤W1). In another embodiment, W2 may be greater than W1.

In the initial position of the AF moving unit, the first coil 120 may face or overlap the first magnet 71A in a direction perpendicular to the first direction (or the optical axis direction). In FIG. 19A, the N-pole region of the first magnet 71A may be disposed to face the first coil 120 or the N-pole region among the N-pole and S-pole regions may be positioned closer to the first coil 120, but in other embodiments, the arrangement may be the opposite.

For example, at the initial position of the OIS moving unit, at least a portion of the first magnet 130 may overlap with at least a portion of the second coil 230 in the first direction (or in the optical axis direction). For example, at the initial position of the OIS moving unit, at least a portion of the second magnet 71B may overlap with at least a portion of the second coil 230 in the first direction (or in the optical axis direction).

The length L2 of the long side of the second magnet 71B may be greater than the length L3 of the long side of the second coil 230 (L2>L3). In another embodiment, the length of the long side of the second magnet 71B may be less than or equal to the length of the long side of the second coil 230.

The width W2 (or the length of the short side) of the second magnet 71B may be greater than the length L4 of the short side of the second coil 230 (W2>L4). In another embodiment, the length of the long side of the second magnet 71B may be less than or equal to the length of the long side of the second coil 230.

For example, the length of the long side of each of the two magnet units 71B1 and 71B3 of the second magnet 71B may be smaller than the length of the long side of each of the coil units 230-1 and 230-3 of the second coil 230. In another embodiment, the length of the long side of each of the two magnet units 71B1 and 71B3 may be equal to or greater than the length of the long side of each of the coil units 230-1 and 230-3.

In addition, the length of the long side of each of the remaining two magnet units 71B2 and 71B4 of the second magnet 71B may be greater than the length of the long side of each of the coil units 230-2 and 230-4 of the second coil 230. In another embodiment, the length of the long side of each of the magnet units 71B2 and 71B4 may be equal to or smaller than the length of the long side of each of the coil units 230-2 and 230-4 of the second coil 230.

For example, the length of the short side of each of the first to fourth magnet units 71B1 to 71B4 of the second magnet 71B may be smaller than the length of the short side of each of the first to fourth coil units 230-1 to 230-4 of the second coil 230. In another embodiment, the length of the short side of each of the first to fourth magnet units 71B1 to 71B4 may be greater than the length of the short side of each of the first to fourth coil units 230-1 to 230-4.

FIG. 19B illustrates another embodiment of the magnet 130 of FIG. 5.

Referring to FIG. 19B, the second magnet 71BB of FIG. 19B may be a two-pole magnet including one N-pole region and one S-pole region. The description of the lengths T2, L2, and W2 of the second magnet 71B in FIG. 19A may be applied or analogically applied to the second magnet 71BB of FIG. 19B.

The circuit board 190 may be disposed at the housing 140, and the first position sensor 170 may be disposed or mounted on the circuit board 190 and may be conductively connected to the circuit board 190. For example, the circuit board 190 may be disposed in the mounting groove 14A of the housing 140, and the terminals 95 of the circuit board 190 may be exposed to the outside of the housing 140.

The circuit board 190 may have a terminal portion 95 (or terminal unit) including a plurality of terminals B1 to B4 for conductively connecting with an external terminal or external device. The plurality of terminals B1 to B4 of the circuit board 190 may be conductively connected to the first position sensor 170.

The first position sensor 170 may be disposed on the housing 140 or/and the circuit board 190. For example, the first position sensor 170 may be disposed on a first surface of the circuit board 190, and the plurality of terminals B1 to B4 may be disposed on a second surface of the circuit board 190. Here, the second surface of the circuit board 190 may be the opposite surface of the first surface of the circuit board 190. For example, the first surface of the circuit board 190 may be any surface of the circuit board 190 that faces the bobbin 110 or the sensing magnet 180. For example, the circuit board 190 may be a printed circuit board, or an FPCB.

The first position sensor 170 may be conductively connected to the circuit board 190. For example, the first position sensor 170 may be conductively connected to the first to fourth terminals B1 to B4 of the circuit board 190. For example, the circuit board 190 may include a circuit pattern or wiring (not shown) for conductively connecting the first to fourth terminals B1 to B4 and the first position sensor 170.

For example, at the initial position of the AF moving unit, at least a portion of the first position sensor 170 may face or overlap the sensing magnet 180 in a direction parallel to a straight line which is perpendicular to the optical axis OA and passes through the optical axis OA. In another embodiment, at the initial position of the AF moving unit, the first position sensor may not face or overlap the sensing magnet.

The first position sensor 170 serves to detect movement, displacement, or position of the bobbin 110 in the optical axis direction. That is, the first position sensor 170 is configured to detect the magnetic field or the intensity of the magnetic field of the sensing magnet 180 mounted on the bobbin 110 according to the movement of the bobbin 110, and output an output signal according to the detected result, and the movement, displacement, or position of the bobbin 110 in the optical axis direction can be detected using the output of the first position sensor 170.

The first position sensor 170 can be a driver IC including a Hall sensor and a driver. The first position sensor 170 may include first to fourth terminals for transmitting and receiving data with the outside using data communication using a protocol, for example, I2C communication, and fifth and sixth terminals for directly supplying a driving signal to the first coil 120.

For example, each of the first to fourth terminals of the first position sensor 170 may be conductively connected to a corresponding one of the first to fourth terminals B1 to B4 of the circuit board 190 by solder or a conductive adhesive.

Also, for example, the fifth and sixth terminals of the first position sensor 170 may be conductively connected to the first coil 120. For example, the first position sensor 170 may be conductively connected to the first coil 120 through at least one of the upper elastic member 150 and the lower elastic member 160, and may supply a driving signal to the first coil 120.

For example, a part of the first upper elastic unit 150-1 may be connected to one end of the first coil 120, and another part of the first upper elastic unit 150-1 may be conductively connected to the circuit board 190. A part of the second upper elastic unit 150-2 may be connected to the other end of the first coil 120, and another part of the second upper elastic unit 150-2 may be conductively connected to the circuit board 190. The circuit board 190 may include a first pad 5A conductively connected to another part of the first upper elastic unit 150-1 and a second pad 5B conductively connected to another part of the second upper elastic unit 150-2. Each of the fifth and sixth terminals of the first position sensor 170 may be conductively connected to a corresponding one of the first and second pads 5A and 5B of the circuit board 190.

In another embodiment, the first coil 120 may be conductively connected to the circuit board 190 and the fifth and sixth terminals of the first position sensor 170 by two lower elastic members.

For example, in an embodiment where the first position sensor 170 is a driver IC, the first and second terminals B1 and B2 of the circuit board 190 may be power terminals for supplying power, the third terminal B3 may be a terminal for transmitting and receiving a clock signal, and the fourth terminal B4 may be a terminal for transmitting and receiving a data signal.

In another embodiment, the first position sensor 170 may be a Hall sensor. In this case, the first position sensor 170 may include two input terminals to which a driving signal or power is supplied and two output terminals for outputting a sensing voltage (or output voltage). For example, the driving signal may be supplied to the first position sensor 170 through the first and second terminals B1 and B2 of the circuit board 190, and the output of the first position sensor 170 may be output to the outside through the third and fourth terminals B3 and B4. Also, the first coil 120 is conductively connected to the circuit board 190. And the circuit board 190 may further include two terminals other than the first to fourth terminals B1 to B4, and the driving signal may be supplied to the first coil 120 from the outside through the two separate terminals.

For example, the ground terminal among the power terminals of the first position sensor 170 can be conductively connected to the cover member 300.

The capacitor 195 may be disposed or mounted on the first surface of the circuit board 190. The capacitor 195 may be in the form of a chip, and in this case, the chip may include a first terminal corresponding to one end of the capacitor 195 and a second terminal corresponding to the other end of the capacitor 195. The capacitor 195 may also be expressed as a “capacitive element” or a condenser.

The capacitor 195 may be conductively connected in parallel to the first and second terminals B1 and B2 of the circuit board 190 for supplying power (or a driving signal) to the first position sensor 170 from the outside. Alternatively, the capacitor 195 may be conductively connected in parallel to the terminals of the first position sensor 170 that are conductively connected to the first and second terminals B1 and B2 of the circuit board 190.

The capacitor 195 may act as a smoothing circuit that removes a ripple component included in the power signal (GND, VDD) supplied to the first position sensor 170 from the outside by being conductively connected in parallel to the first and second terminals B1 and B2 of the circuit board 190, and thereby a stable and uniform power signal can be supplied to the first position sensor 170.

In another embodiment, the sensing magnet 180 may be disposed at the housing 140, and the first position sensor 170 may be disposed at the bobbin 110. In another embodiment, the balancing magnet 185 may be omitted.

The upper elastic member 150 and the lower elastic member 160 may be coupled with the bobbin 110 and the housing 140. For example, the upper elastic member 150 may be coupled to an upper portion, upper end, or upper surface of the bobbin 110 and an upper portion, upper end, or upper surface of the housing 140, and the lower elastic member 160 may be coupled to a lower portion, lower end, or lower surface of the bobbin 110 and a lower portion, lower end, or lower surface of the housing 140. The upper elastic member 150 and the lower elastic member 160 may elastically support the bobbin 110 with respect to the housing 140.

The upper elastic member 150 may include a plurality of upper elastic units (e.g., 150-1 to 150-4) that are conductively separated from each other or spaced apart from each other. The lower elastic member 160 is implemented as a single elastic unit, but in other embodiments may include a plurality of lower elastic units that are conductively separated from each other or spaced apart from each other. In other embodiments, at least one of the upper elastic member and the lower elastic member may be implemented as a single unit or a single configuration.

The upper elastic member 150 may include a first inner frame 151 that is coupled or fixed to the upper portion, upper surface, or upper end of the bobbin 110, a second inner frame (152) that is coupled or fixed to the upper portion, upper surface, or upper end of the housing 140, and a first frame connection portion 153 that connects the first inner frame 151 and the first outer frame 152. In addition, the upper elastic member 150 may include the above-described extension portion 155.

The lower elastic member 160 may include a second inner frame 161 coupled or fixed to the lower portion, lower surface, or lower end of the bobbin 110, a second outer frame 162 coupled or fixed to the lower portion, lower surface, or lower end of the housing 140, and a second frame connecting portion 163 connecting the second inner frame 161 and the second outer frame 162 to each other. The inner frame may be expressed as an inner portion, the outer frame may be expressed as an outer portion, and the frame connection portion may be expressed as a connection portion.

Each of the first and second frame connection portions 153 and 163 may be formed to be bent or curved at least once to form a pattern of a certain shape.

Each of the upper elastic member 150 and the lower elastic member 160 may be made of a conductive material, for example, a metal material. In addition, each of the upper elastic member 150 and the lower elastic member 160 may be formed of an elastic member, for example, a plate spring.

Referring to FIG. 5, FIG. 7A, and FIG. 7B, for example, the second outer frame 152 of the first upper elastic unit 150-1 may include a first bonding portion 4A that is coupled or conductively connected to the first pad 5A of the circuit board 190, and the second outer frame 152 of the second upper elastic unit 150-2 may include a second bonding portion 4B that is conductively connected to the second pad 5B of the circuit board 190.

In another embodiment, at least one of the upper elastic member 150 or the lower elastic member 160 may include two elastic members. For example, each of the two elastic members may be coupled or conductively connected to a corresponding one of the first and second pads of the circuit board 190, and the first coil 120 may be conductively connected to the two elastic members.

The first outer frame 152 of the upper elastic member 150 may include a first coupling portion 510 coupled with the housing 140, a second coupling portion 520 coupled with the wire 220, and a connector 530 connecting the first coupling portion 510 and the second coupling portion 520. The first coupling portion 510 may include a through hole or hole for coupling with the first coupling portion 143 of the housing 140. The second coupling portion 520 may include a through hole or hole for coupling with the wire 220. For example, the second coupling portion 520 may be connected to the wire 220 by a conductive adhesive or solder. For example, the connector 530 may include a bent portion that is bent at least once or a curved portion that is bent at least once, but it is not limited to this, and in other embodiments, the connector 530 may be in a straight shape.

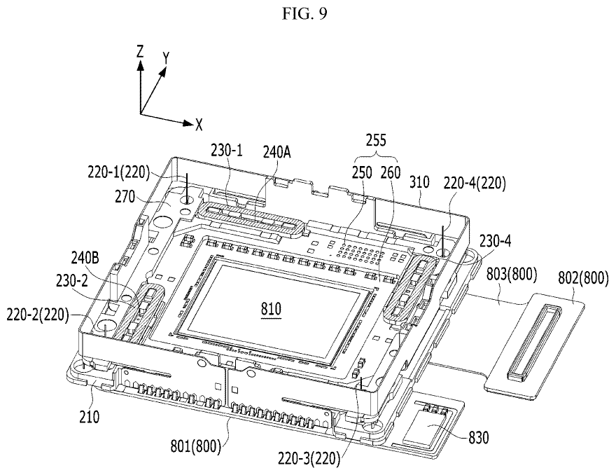

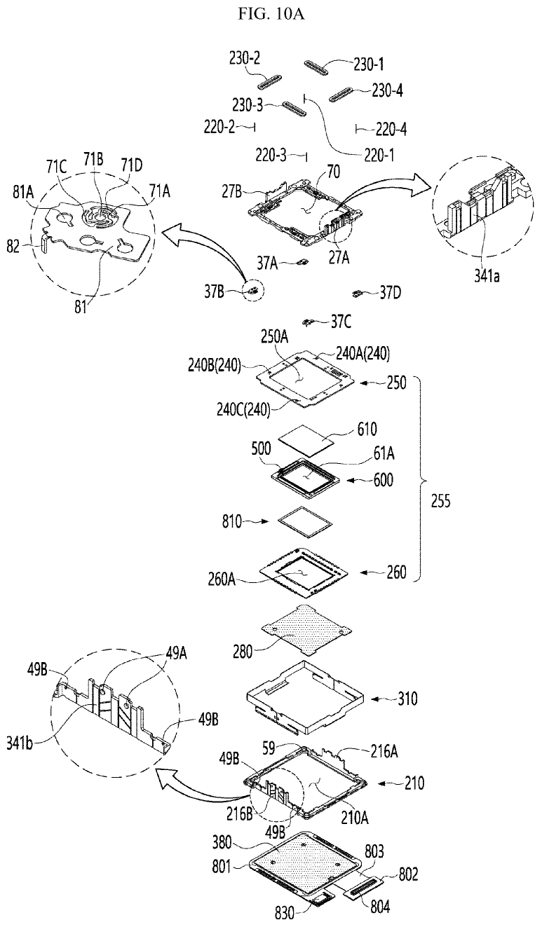

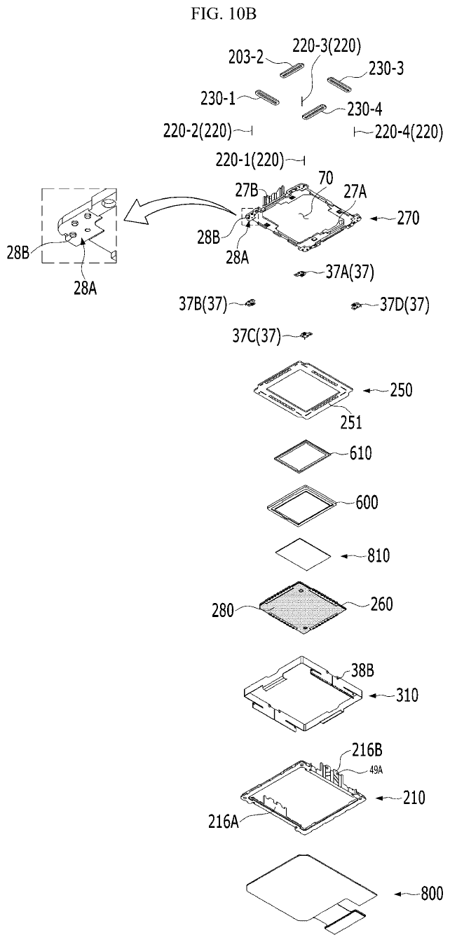

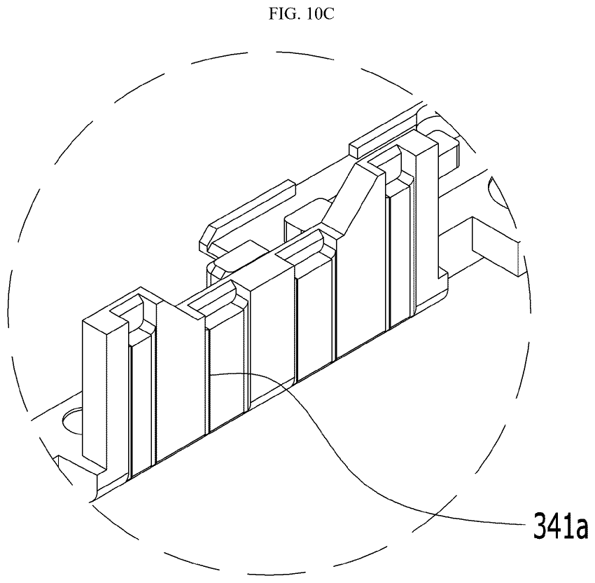

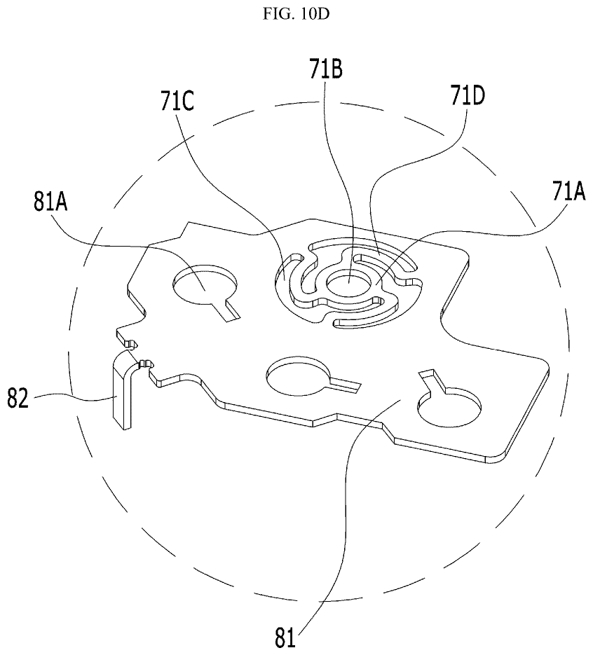

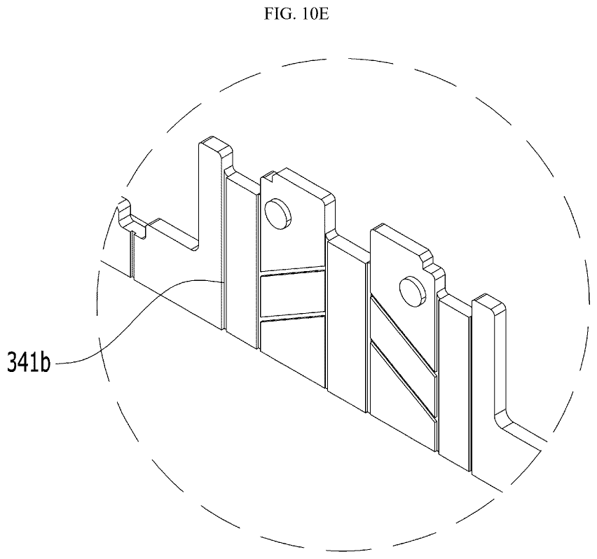

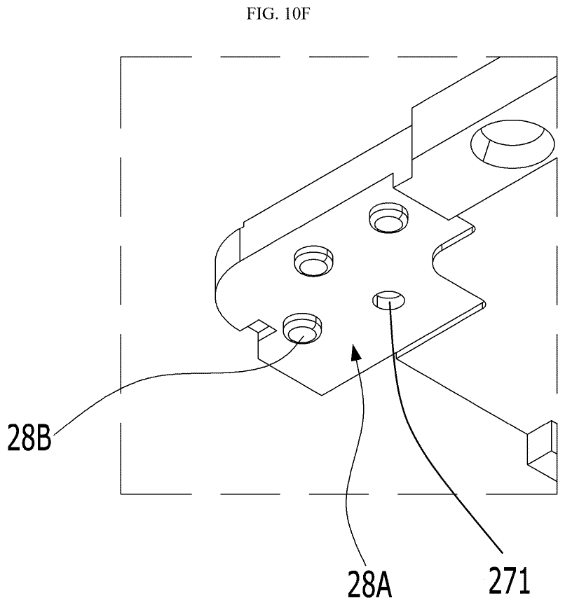

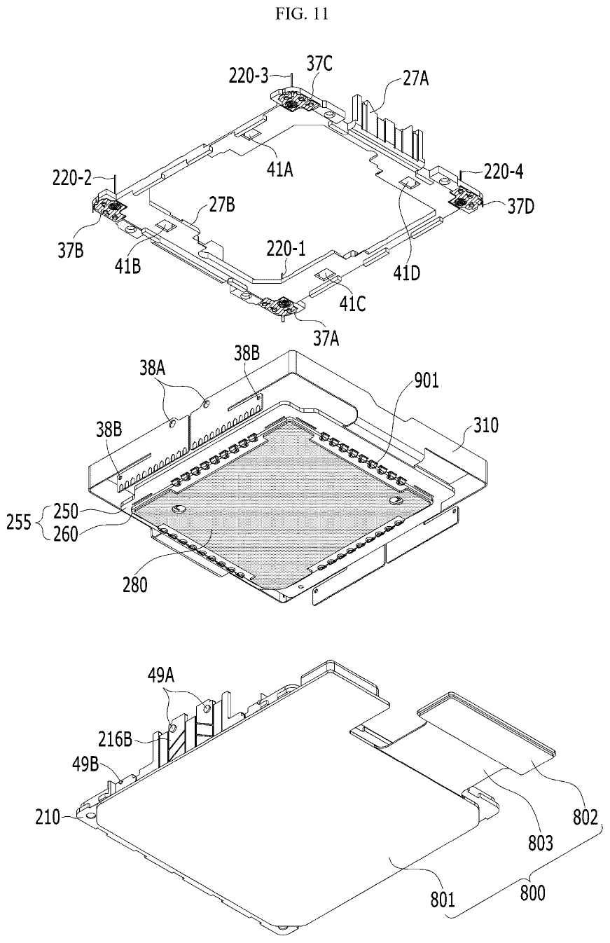

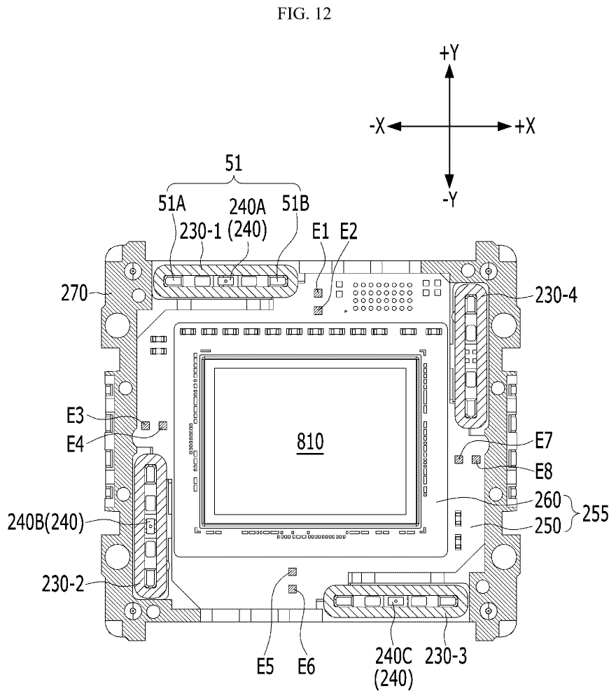

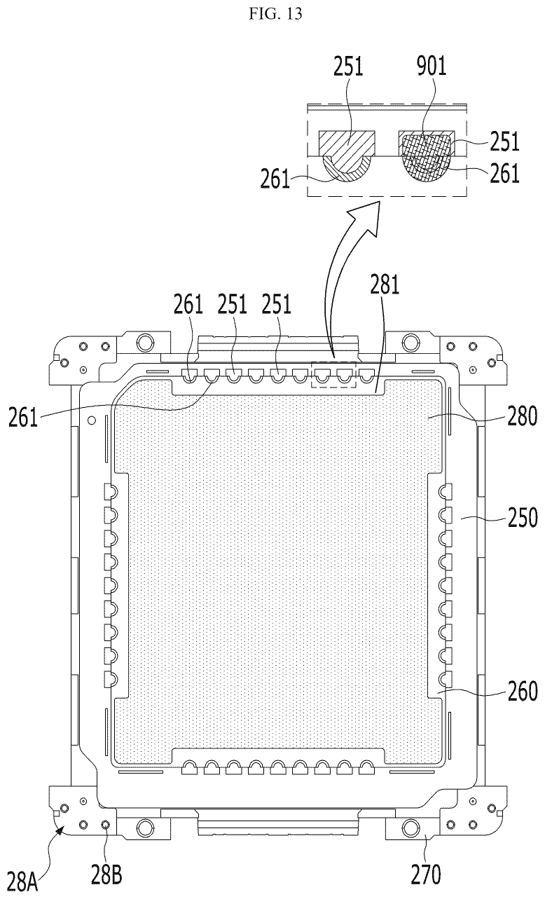

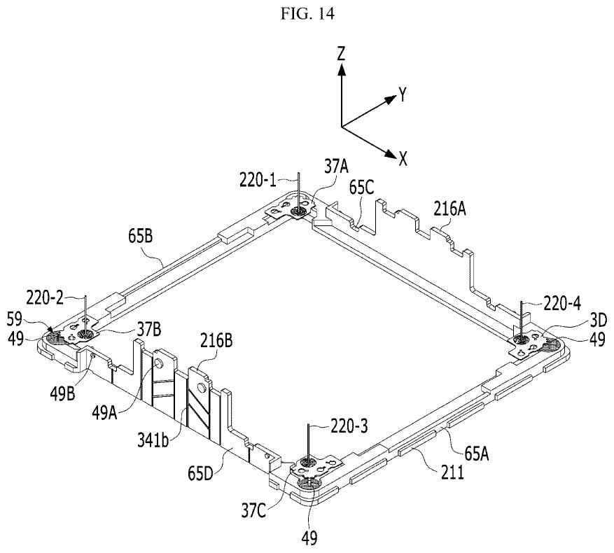

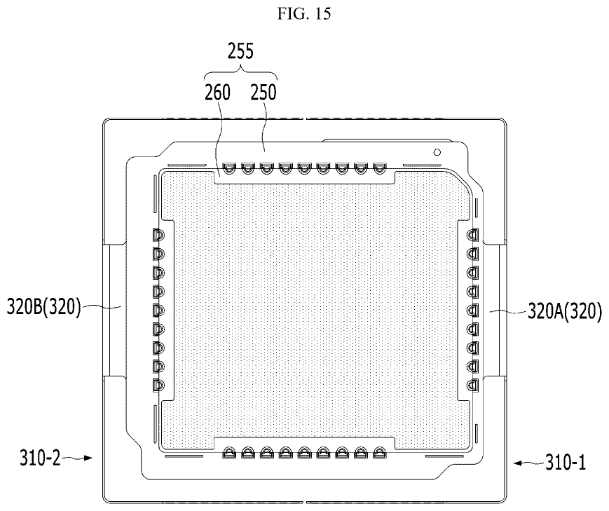

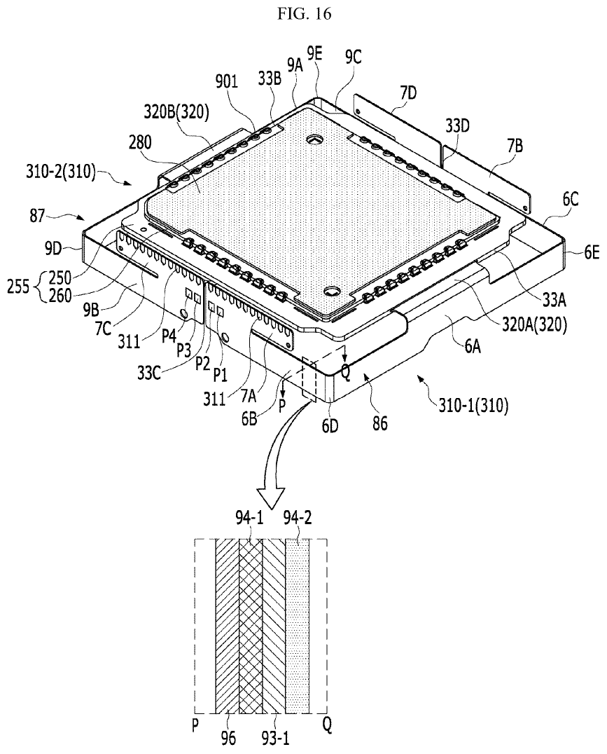

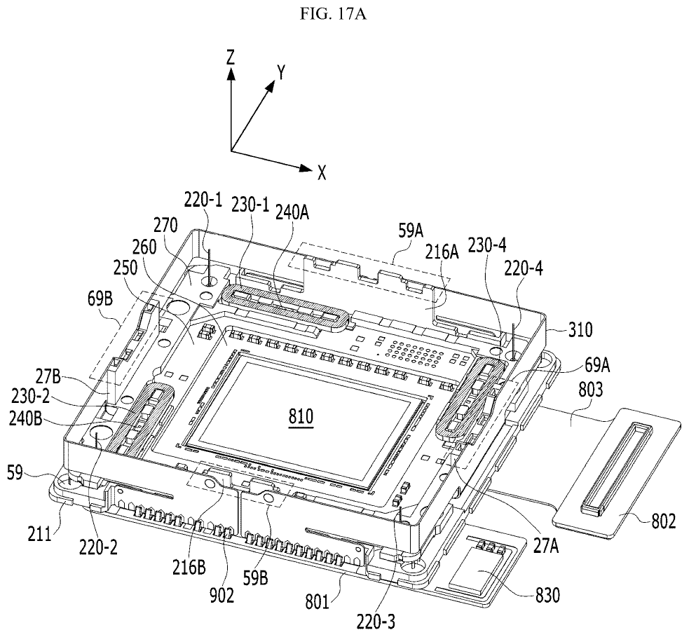

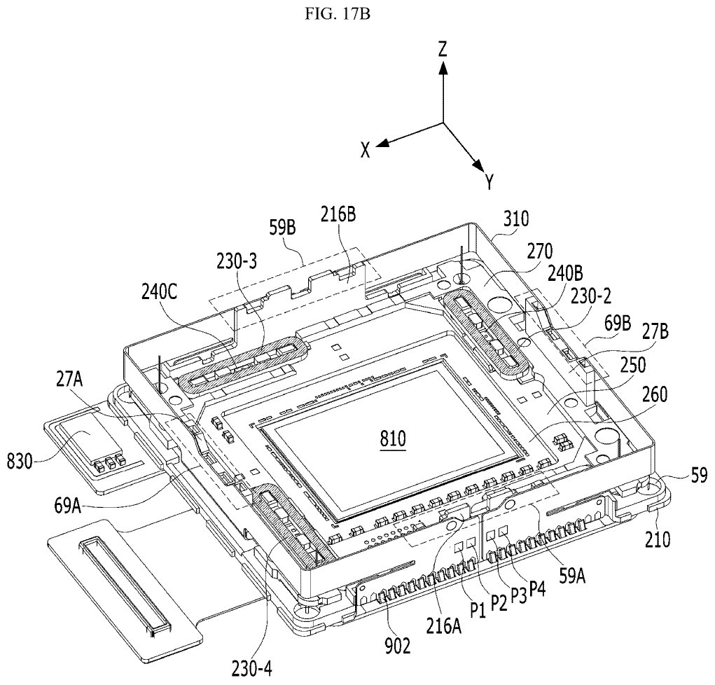

FIG. 9 is a perspective view of an image sensor unit 350, FIG. 10A is a first separated perspective view of the image sensor unit 350 of FIG. 9, FIG. 10B is a second separated perspective view of the image sensor unit 350 of FIG. 9, FIG. 10C is an enlarged view of a groove 341a of the holder 270 of FIG. 10A, FIG. 10D is an enlarged view of a terminal member 37 of FIG. 10A, FIG. 10E is an enlarged view of the groove 341b of the base 210 of FIG. 10A, FIG. 10F is an enlarged view of a groove 28A of the holder 270 for arranging the terminal member 37 of FIG. 10B, and FIG. 11 is a bottom perspective view of the holder 270, the terminal member 37, the first substrate unit 255, the support board 310, the heat dissipation unit 280, the base 210, and the second substrate unit 800 in FIG. 10A, FIG. 12 is a plan view of the holder 270, the first substrate unit 255, the image sensor 810, the second coil 230, and an OIS position sensor 240, FIG. 13 is a rear perspective view of the holder 270 and the first substrate unit 255, FIG. 14 is a perspective view of the base 210, the terminal member 37, and a wire 220, FIG. 15 is a bottom view of the first substrate unit 255, the support board 310, and the heat dissipation member 280, FIG. 16 is a perspective view of the first substrate unit 255, the support board 310, and the heat dissipation member 280, FIG. 17A is a first perspective view of the support board 310 coupled to the holder 270 and the base 210, and FIG. 17B is a second perspective view of the support board 310 coupled to the holder 270 and the base 210.

Referring to FIGS. 9 to 17B, the image sensor unit 350 may include a stationary unit and an OIS moving unit that is spaced apart from the stationary unit. The image sensor unit 350 may include a support unit that connects the stationary unit and the OIS moving unit.

For example, the support unit may include a support board 310. Or, for example, the support unit may be the support board 310. In another embodiment, the support unit may be an elastic member, for example, a plate spring or a suspension wire, instead of the support board 310.

The stationary unit may be a fixed part of the camera device 10 that does not move when the OIS operates. For example, the stationary unit may include the second substrate unit 800. For example, the stationary unit may include a configuration that is coupled with the second substrate unit 800. The term substrate unit (255 or 800) may be expressed as a “substrate” or a “circuit board.”

For example, the stationary unit may include the base 210 coupled with the second substrate unit 800. For example, the stationary unit may include the housing 140 of the AF driving unit and components disposed at the housing 140, such as the magnet 130, the first position sensor 170, and the circuit board 190. In addition, the stationary unit may include the cover member 300 coupled with the base 210. The OIS moving unit may be disposed inside the cover member 300. For example, the cover member 300 may accommodate the moving unit and the support board 310.

The OIS moving unit may include the image sensor 810. The OIS moving unit may further include the first substrate unit 255 spaced apart from the second substrate unit 800 and conductively connected to the second substrate unit 800. Also, for example, the OIS moving unit may include at least one of the components disposed on the first substrate unit 255, for example, the heat dissipation member 280, the holder 270, the second coil 230, and the second position sensor 240. The holder 270 may be replaced with a “spacing member.” In another embodiment, the holder 270 may be omitted and the second coil 230 may be disposed on the first substrate unit 255, for example, the first circuit board 250.

For example, the camera device 10 may include the stationary unit, the moving unit including the first heat dissipation body 280 disposed on the stationary unit, and the image sensor 810 disposed on the first heat dissipation body 280, and the support unit (e.g., 310) that supports the moving unit so that the moving unit can move in a direction perpendicular to the optical axis direction. The support unit (e.g., 310) may connecting the moving unit and the stationary unit.

The moving unit may include the first substrate unit 255 on which the image sensor 810 is disposed, the stationary unit may include the second substrate unit 800 disposed spaced apart from the first substrate unit 255, and the support unit may connect the first substrate unit 255 and the second substrate unit 800.

The support unit may include a conductive layer 93-1, a first insulating layer 94-1 disposed under the conductive layer 93-1, and a second insulating layer 94-2 disposed on the conductive layer 93-1. A part of the first insulating layer 94-1 may be not disposed so that a portion of the conductive layer 93-1 may be exposed from the first insulating layer 94-1.

The first substrate unit 255 may include the first circuit board 250 connected to the support unit, the second circuit board 260 conductively connected to the image sensor 810, and a solder 901 conductively connecting the first circuit board 250 and the second circuit board 260.

The camera device 10 may include an elastic member 220 (hereinafter referred to as “wire”) for elastically supporting the OIS moving unit with respect to the stationary unit. The elastic member 220 may be in the form of a wire or a spring.

For example, one end of the wire 220 may be coupled to the upper elastic member 150 (or the housing 140), and the other end of the wire 220 may be coupled to the holder 270. For example, one end of the wire 220 may be coupled to the first outer frame 152 of the upper elastic member 150 (e.g., the second coupling portion 520) by solder or a conductive adhesive. For example, the other end of the wire 220 may be coupled to the terminal member 37 by solder or a conductive adhesive, and the terminal member 37 may be disposed at the holder 270 or coupled to the holder 270.

Referring to FIGS. 7A and 7B, a damper DA may be disposed between one end of the wire 220 passing through the hole 147 of the housing 140 and the hole 147 of the housing 140. For example, at least a portion of the damper DA may be disposed within the hole 147 of the housing 140, and may be coupled or attached to at least a portion of the wire 220 and the housing 140.

For example, the wire 220 may be disposed parallel to the optical axis direction. For example, the wire 220 may be disposed at a corner of the housing 140 or/and a corner of the holder 270. For example, the wire 220 may include four wires 220-1 to 220-4. Each of the four wires 220-1 to 220-4 may be disposed at a corresponding one of the four corners of the housing 140 or/and the four corners of the holder 270.

Referring to FIGS. 10A to 10F, a hole 271 may be formed at the holder 270 for at least a portion of the wire 220 to pass through. For example, the hole 271 may be formed at the corner of the holder 270 for the other end of the wire 220 to pass through. For example, the hole 271 may be formed at each of the four corners of the holder 270. For example, the hole 271 may be a through hole penetrating the holder 270 in the optical axis direction, but in another embodiment, it may be in the form of an escape groove.

For example, the terminal member 37 may be disposed on or coupled to the upper or lower surface of the holder 270. For example, the terminal member 37 may be disposed on or coupled to the lower surface of the corner of the holder 270. A groove 28A may be formed at the holder 270 for disposing the terminal member 37. For example, the groove 28A may be formed at the lower surface of the corner of the holder 270.

The holder 270 may include at least one protrusion 28B, and the terminal member 37 may include at least one hole 81A for being coupled with at least one protrusion 28B of the holder 270. The terminal member 37 and the holder 270 may be coupled to each other by adhesive or thermal fusion. In addition, the terminal member 37 may include a hole 71B for inserting or coupling the other end of the wire 220. For example, each of the holes 81A and 71B may be a through hole.

For example, the terminal member 37 may include a body 81 coupled to the holder 270. The body 81 may include a coupling portion 71 coupled to the wire 220. The coupling portion 71 may include a coupling region 71A coupled to the wire 220 and the hole 71B formed at the coupling region 71A. The coupling region 71A may be a region of the body 81 coupled to the wire 220 by solder or a conductive adhesive. For example, the other end of the wire 220 passing through the hole 71B may be coupled to the lower portion or lower surface of the coupling region 71A by solder or a conductive adhesive.

For example, the body 81 may include at least one hole 71C formed around the coupling region 71A. For example, the body 81 may include a plurality of holes 71C surrounding the coupling region 71A. For example, the plurality of holes 71C may be spaced apart from the hole 71B.

In addition, the body 81 may include a supporter 71D positioned between the plurality of holes 71C and supporting the coupling region 71A. The supporter 71D may be expressed as a “connector” or a “bridge.” The supporter 71D may include a plurality of supporters spaced apart from each other. The supporter 71D may be connected to the coupling region 71A.

At least one hole 71C may serve to ensure that the solder is formed primarily only in the coupling region 71A by an interfacial tension (e.g., surface tension) at the edge of the coupling region 71A during soldering.

In addition, the coupling region 71A must be heated for soldering, and the heat of the coupling region 71A can be suppressed or blocked from being transferred to other regions of the body 81 by the at least one hole 71C, and thereby inhibiting the solder during soldering from being formed in other regions of the body 81. Ultimately, at least one hole 71C can improve the solderability of the solder.

The terminal member 37 may include an extension portion 82 extending from the body 81. The extension portion 82 may be extended by bending downward from the body 81. For example, the extension portion 82 may be extended toward the hole 59 of the base 210. The extension portion 82 may alternatively be expressed as a “bent portion”.

For example, the terminal member 37 may include four terminals 37A to 37D corresponding to four wires 220-1 to 220-4. Each of the terminals 37A to 37D may be disposed at the corresponding one of the corners of the holder 270 and may be coupled with the corresponding one of the wires 220-1 to 220-4. The description of FIG. 10A may be applied the structure of each of the terminals 37A to 37D. The terminal member 37 may be formed of a conductive material, for example, metal. In another embodiment, the terminal member 37 may be omitted, and the wire 220 may be directly coupled to the holder 270.

Referring to FIG. 14, a damper 49 or an adhesive may be disposed between the terminal member 37 and the base 210, and the damper 49 may be in contact with, coupled with, or attached to the terminal member 37 and the base 210. For example, the base 210 may include a hole 59 (or groove) formed at a position corresponding to or facing the terminal member 37. For example, the hole 59 (or groove) may be formed at the corner of the base 210.

For example, the damper 49 may be disposed in the hole 59 of the base 210. Alternatively, at least a portion of the extension portion 82 of the terminal member 37 may be disposed in the hole 59 of the base 210, and the damper 49 may be in contact with, coupled with, or attached to the extension portion 82. The damper 49 may play a role in absorbing or alleviating the vibration of the OIS moving unit, and thereby the oscillation of the OIS moving unit can be inhibited or suppressed when the OIS operation is performed.

In another embodiment, the extension portion 82 may be omitted from the terminal member 37, and the camera device 10 may not include the damper 49 of FIG. 14.

The support board 310 may support the OIS moving unit with respect to the stationary unit so that the OIS moving unit may move in a direction perpendicular to the optical axis, or the OIS moving unit may tilt or rotate around the optical axis within a predetermined range.

For example, one end of the support board 310 may be connected or coupled with the first substrate unit 255, and the other end of the support board 310 may be connected or coupled with the second substrate unit 800.

The holder 270 may be disposed under the AF driving unit. For example, the holder 270 may be made of a non-conductive material. For example, the holder 270 may be made of an injection molded material that is easy to shape by an injection molding process. In addition, the holder 270 may be formed of an insulating material. In addition, for example, the holder 270 may be made of a resin or plastic material.

Referring to FIGS. 10A to 10F and FIG. 12, the holder 270 may include an upper surface, a lower surface opposite to the upper surface thereof, and a side surface (e.g., an outer side surface) connecting the upper surface and the lower surface thereof. For example, the lower surface of the holder 270 may face or be opposite the second substrate unit 800.

The holder 270 may support the first substrate unit 255 and may be combined with the first substrate unit 255. For example, the first substrate unit 255 may be disposed under the holder 270. For example, the lower portion, lower surface, or lower end of the holder 270 may be coupled with the upper portion, upper surface, or upper end of the first substrate unit 255. For example, the holder 270 may be coupled with the first substrate unit 255 by an adhesive. For example, in another embodiment, the first substrate unit 255 may be disposed on the upper side of the holder 270.

The holder 270 may accommodate or support the second coil 230. The holder 270 may support the second coil 230 so that the second coil 230 is disposed spaced apart from the first substrate unit 255. For example, at least a portion of the holder 270 may be disposed between the second coil 230 and the first substrate unit 255.

The holder 270 may include an opening 70 corresponding to a region of the first substrate unit 255. For example, the opening 70 of the holder 270 may be a through hole penetrating the holder 270 in the optical axis direction. For example, the opening 70 of the holder 270 may correspond to, face, or overlap the image sensor 810 in the optical axis direction.

The shape of the opening 70 of the holder 270 as viewed from the top may be a polygon, for example, a quadrangle, a circle, or an oval shape, but is not limited thereto and may be implemented in various shapes.

For example, the opening 70 of the holder 270 may have a shape or size that exposes the image sensor 810, a part of the upper surface of the first circuit board 250, a part of the upper surface of the second circuit board 260, and the elements. For example, an area of the opening 70 of the holder 270 may be larger than an area of the image sensor 810 and may be larger than the area of the opening 250A of the first circuit board 250.

Referring to FIG. 11, the holder 270 may include holes 41A, 41B, and 41C corresponding to the second position sensor 240. For example, the holder 270 may include holes 41A, 41B, and 41C formed at positions corresponding to the first to third sensors 240A, 240B, and 240C of the second position sensor 240.

For example, the holes 41A, 41B, and 41C may be disposed adjacent to the corners of the holder 270. The holder 270 may include a dummy hole 41D formed adjacent to a corner of the holder 270 that does not correspond to the second position sensor 240. The dummy hole 41D may be formed to balance the weight of the OIS moving unit when the OIS operation is performed. The dummy hole 41D may be a through hole. In another embodiment, the dummy hole 41D may not be formed. The holes 41A, 41B, and 41C may be through holes that penetrate the holder 270 in the optical axis direction. In another embodiment, the holes 41A, 41B, and 41C of the holder 270 may be omitted.

At least one coupling protrusion 51 may be formed on the upper surface of the holder 270 to be coupled with the second coil 230. The coupling protrusion 51 may protrude upward from the upper surface of the holder 270 or in a direction toward the AF driving unit. For example, the coupling protrusion 51 may be formed adjacent to each of the holes 41A to 41D of the holder 270.

For example, two coupling protrusions 51A and 51B may be disposed or arranged to correspond to one hole 41A, 41B, 41C, and 41D) of the holder 270. For example, the hole 41A, 41B, 41C, and 41D of the holder 270 may be located between two coupling protrusions 51A and 51B.

The holder 270 may include at least one protruding portion 27A and 27B. The protruding portion 27A and 27B may protrude from the upper surface of the holder 270. For example, the protruding portion 27A and 27B may protrude in the optical axis direction or upward from the outer side surface of the holder 270.

For example, the holder 270 may include two protruding portions 27A and 27B that are opposed or overlapped in a second horizontal direction (e.g., X-axis direction).

For example, the holder 270 may include four side portions (or side plates), and the protruding portions 27A and 27B may be formed at two of the four side portions. For example, the protruding portions 27A and 27B may be disposed or positioned in the center of the side portion (or side plate) of the holder 270.

The holder 270 may include a groove 341a. The groove 341a may be an adhesive receiving groove. The groove 341a may be formed on the outer side surface of the protruding portions 27A and 27B of the holder 270. The groove 341a may be formed on the upper surface of the protruding portions 27A and 27B of the holder 270. The groove 341a may be formed from the upper surface to the lower surface of the protruding portions 27A and 27B of the holder 270. An adhesive for bonding the support board 310 to the holder 270 may be disposed in the groove 341a. The groove 341a may include a plurality of grooves. For example, the groove 341a may extend in the optical axis direction. In another embodiment, the groove of the holder 270 may extend in a direction perpendicular to the optical axis.

The first substrate unit 255 may include a first circuit board 250 and a second circuit board 260 that are conductively connected to each other. The second circuit board 260 may be expressed as a “sensor board” instead. In another embodiment, the heat dissipation member 280 may be included in the first substrate unit 255.

The first substrate unit 255 may be disposed on the lower surface of the holder 270. For example, the first substrate unit 255 may be coupled to the lower surface of the holder 270. For example, the first circuit board 250 may be disposed on or/and coupled to the lower surface of the holder 270. For example, a first surface of the first circuit board 250 may be coupled or attached to the lower surface of the holder 270 by an adhesive member.

At this time, the first surface of the first circuit board 250 may face or opposite the AF driving unit, and may be the surface on which the second position sensor 240 is disposed. In addition, a second surface of the first circuit board 250 may be the opposite surface of the first surface of the first circuit board 250.

The first circuit board 250 may be expressed as a sensor board, a main board, a main circuit board, a sensor circuit board, or a moving circuit board. In all embodiments, the first circuit board 250 may be alternatively expressed as a “second board” or a “second circuit board”, and the second circuit board 260 may be alternatively expressed as a “first board” or a “first circuit board”.

The second position sensor 240 (240A, 240B, and 240C) for detecting movement of the OIS moving unit in a direction perpendicular to the optical axis direction and/or rotation, tilting, or rolling of the OIS moving unit with respect to the optical axis may be disposed on the first circuit board 250. In addition, a controller 830 or/and a circuit element (e.g., a capacitor) may be disposed on the first circuit board 250.

The first circuit board 250 may include first terminals E1 to E8 for conductively connecting to the second coil 230. Here, the first terminals E1 to E8 may be alternatively expressed as “first pads” or “first bonding portions.” The first terminals E1 to E8 of the first circuit board 250 may be disposed or arranged on the first surface 60A of the first circuit board 250. For example, the first circuit board 250 may be a printed circuit board or a flexible printed circuit board (FPCB).

The first circuit board 250 may include an opening 250A corresponding to or opposite to the opening of the lens module 400 and the bobbin 110. For example, the opening 250A of the first circuit board 250 may be a through hole or hollow that penetrates the first circuit board 250 in the optical axis direction, and may be formed at the center of the first circuit board 250.

When viewed from the top, the shape of the first circuit board 250, for example, the outer peripheral shape, may be a shape that matches or corresponds to the holder 270, for example, a quadrangle shape. In addition, when viewed from the top, the shape of the opening 250A of the first circuit board 250 may be a polygon, for example, a quadrangle, or a circular or oval shape. For example, the opening 250A of the first circuit board 250 may open or expose the image sensor 810 and/or the opening 260A of the second circuit board 260.

In addition, the first circuit board 250 may include at least one terminal 251 for conductively connecting with the second circuit board 260. Here, the terminal 251 of the first circuit board 250 may be alternatively expressed as a “pad” or a “bonding portion.” The terminal 251 of the first circuit board 250 may be disposed or positioned on the lower surface of the first circuit board 250.

For example, the terminal 251 may be plural, and the plurality of terminals 251 may be disposed or positioned in a region between the opening 250A of the first circuit board 250 and one side of first circuit board 250 and may be disposed or positioned in a direction parallel to the one side of first circuit board 250. For example, the plurality of terminals 251 may be disposed to surround the opening 250A.

The second circuit board 260 may be disposed under the first circuit board 250. The second circuit board 260 may be conductively connected to the image sensor 810.

When viewed from the top, the second circuit board 260 may have a shape of polygonal (e.g., quadrangle, square, or rectangular), but is not limited thereto, and may have a shape of circular or oval in other embodiments.

For example, an area of the outer peripheral surface of the second circuit board 260 having a quadrangle shape may be larger than an area of the opening 250A of the first circuit board 250. For example, a lower side of the opening 250A of the first circuit board 250 may be shielded or blocked by the second circuit board 260.

For example, when viewed from the top or bottom, the outer side surface (or side) of the second circuit board 260 may be located between the outer side surface (or side) of the first circuit board 250 and the opening 250A of the first circuit board 250.

For example, the second circuit board 260 may include an opening 260A corresponding to the opening 250A of the first circuit board 250 or/and the image sensor 810. The opening 260A of the second circuit board 260 may be a hole or hollow penetrating the second circuit board 260 in the optical axis direction, and may be formed at the center of the second circuit board 260.

For example, the opening 260A of the second circuit board 260 may open or expose the image sensor 810. For example, the image sensor 810 may be disposed within the opening 260A of the second circuit board 260 and may be conductively connected to the second circuit board 260. For example, the image sensor 810 may be conductively connected to the second circuit board 260 by a wire.

In another embodiment, the opening 260A may not be formed in the second circuit board 260, and the image sensor 810 may be placed on the upper surface of the second circuit board 260.

In another embodiment, the heat dissipation member 280 may be omitted, and in the another embodiment in which the heat dissipation member 280 is omitted, the opening 260A may not be formed in the second circuit board 260 and the image sensor 810 may be disposed on the upper surface of the second circuit board 260.

For example, in the another embodiment where the heat dissipation member 280 is omitted, the image sensor 810 may be disposed on the upper surface of a single substrate in which the first circuit board and the second circuit board are integrally formed.

The second circuit board 260 may include at least one terminal 261 conductively connected to at least one terminal 251 of the first circuit board 250. For example, the number of terminal 261 of the second circuit board 260 may be plural.

For example, at least one terminal 261 of the second circuit board 260 may be formed at a side surface or an outer side surface of the second circuit board 260 connecting the upper and lower surfaces of the second circuit board 260. The upper surface of the second circuit board 260 may be a surface facing the first circuit board 250, and the lower surface of the second circuit board 260 may be an opposite surface to the upper surface of the second circuit board. For example, the terminal 261 may be a groove shape that is recessed from the side surface of the second circuit board 260. Or, for example, the terminal 261 may a kind of via having a semicircular or semi-elliptical shape which is formed on the side surface of the second circuit board 260. In another embodiment, at least one terminal of the second circuit board 260 that is conductively connected to the second terminal 251 of the first circuit board 250 may be formed on the upper surface of the second circuit board 260.

For example, the terminal 261 of the second circuit board 260 may be coupled to the terminal 251 of the first circuit board 250 by solder (901, see FIG. 11) or a conductive adhesive material. In the enlarged dotted line portion in FIG. 13, only one solder 901 is shown for connecting one terminal of the second circuit board 260 and one terminal 251 of the first circuit board, but a solder for connecting another terminal of the second circuit board 260 and a corresponding terminal of the first circuit board 250 may be provided.

For example, the first and second circuit boards 250 and 260 may be printed circuit boards or FPCBs. In addition, at least one of the first and second circuit boards 250 and 260 may be an organic substrate or a ceramic substrate.

The heat dissipation member 280 may be disposed or coupled to the first substrate unit 255. For example, the heat dissipation member 280 may be disposed or coupled to the second circuit board 260. For example, the heat dissipation member 280 may be disposed under the second circuit board 260. For example, the heat dissipation member 280 may be bonded or fixed to the lower surface of the second circuit board 260. For example, at least a portion of the upper surface of the heat dissipation member 280 may be bonded or fixed to the lower surface of the second circuit board 260 by an adhesive.

The term “heat dissipation member” may also be alternatively expressed as “heat dissipation sheet”, “heat dissipation tape”, “heat dissipation layer”, “heat dissipation film”, “heat dissipation board”, “heat dissipation plate”, or “heat dissipation body”.

In another embodiment, the heat dissipation member 280 may be included in the first substrate unit 255, and the image sensor 810 may be disposed in the first substrate unit 255.

The opening 260A of the second circuit board 260 may open or expose at least a portion of the heat dissipation member 280. The image sensor 810 may be disposed on, attached to, or coupled to the at least a portion of the heat dissipation member 280 exposed by the opening 260A. For example, the image sensor 810 may be fixed, attached, or coupled to the heat dissipation member 280 by an adhesive. For example, the image sensor 810 may be disposed on the first substrate unit 255.

For example, at least a portion of the upper surface of the heat dissipation member 280 may be exposed by the opening 260A, and the image sensor 810 may be disposed on, attached to, or coupled to at least a portion of the upper surface of the heat dissipation member 280 exposed by the opening 260A.

In another embodiment, the second circuit board 260 may include a groove formed at the lower surface of the second circuit board 260 to receive or dispose the heat dissipation member 280.

In another embodiment, the second circuit board 260 may not have an opening 260A, and the heat dissipation member 280 may be fixed, attached, or coupled to the lower surface of the second circuit board 260. In another embodiment, the heat dissipation member 280 may be omitted.

For example, the heat dissipation member 280 may be a plate-shaped member having a predetermined thickness and hardness. In addition, the heat dissipation member 280 may enhance the heat dissipation effect of dissipating heat generated from the heat source of the first substrate unit 255 to the outside. At this time, the heat source of the first substrate unit 255 may be an electronic element (or circuit element) disposed on the first substrate unit 255, such as the image sensor 810, the controller 830, the second position sensor 240, or/and the capacitor.

For example, the heat dissipation member 280 may include at least one of a metal material having high thermal conductivity and high heat dissipation efficiency, such as SUS, aluminum, nickel, phosphorus, bronze, or copper.

In addition, the heat dissipation member 280 may act as a reinforcing member to stably support the image sensor 810 and inhibit the image sensor 810 from being damaged by external impact or contact.

In another embodiment, the heat dissipation member 280 may be formed of a heat dissipation member having high thermal conductivity, such as a heat dissipation epoxy, a heat dissipation plastic (e.g., polyimide), or a heat dissipation synthetic resin.

For example, in an embodiment of the present invention, the term “heat dissipation member” may be alternatively expressed as a “heat dissipation body”, a “heatsink”, a “heat dissipation plate”, a “heat dissipation sheet”, a plate, a metal plate, a reinforcing member, or a stiffener.

In order to improve the heat dissipation effect, the heat dissipation member 280 may include a preset pattern including at least one groove or at least one unevenness. For example, a groove or an unevenness having a preset pattern may be formed at the lower surface of the heat dissipation member 280.

For example, the preset pattern may include a plurality of grooves formed at preset intervals. For example, the preset pattern may have a stripe shape. In another embodiment, the preset pattern may have a net shape or a mesh shape. In another embodiment, the preset pattern may have a shape including dots spaced apart from each other. For example, the shape of the dots may be circular, oval, or polygonal (e.g., quadrangle).

In another embodiment, the preset pattern may be formed at at least one of the upper surface, lower surface, or outer side surface of the heat dissipation member 280. In another embodiment, the heat dissipation member may include holes or through holes instead of grooves or protrusions. The heat dissipation member 280 may be separated from the stationary unit, for example, the second substrate unit 800 since the heat dissipation member 280 moves together with the OIS moving unit. The heat dissipation member 280 may include at least one escape groove 281 (see FIG. 13) to avoid spatial interference with the solder 901.

In FIG. 13, the first circuit board 250 and the second circuit board 260 are conductively connected by the solder 901, but in other embodiments, the first circuit board and the second circuit board may be implemented as a single integrated circuit board.

The second coil 230 may be disposed on or connected to the OIS moving unit. For example, the second coil 230 may be disposed on the holder 270. The second coil 230 may be disposed on the upper surface of the holder 270. The second coil 230 may be disposed under the magnet 130.

The second coil 230 can be coupled with the holder 270. For example, the second coil 230 can be coupled or attached to the upper surface of the holder 270. For example, the second coil 230 can be coupled with the coupling protrusion 51 of the holder 270. The second coil 230 can move the OIS moving unit by interaction with the magnet 130.

For example, the second coil 230 can correspond to, face, or overlap the magnet 130 disposed at the stationary unit in the direction of the optical axis OA. In another embodiment, the stationary unit can include a magnet dedicated to OIS that is separate from the magnet of the AF driving unit, and the second coil can correspond to, face, or overlap the OIS dedicated magnet. In this case, the number of magnets for OIS can be the same as the number of coil units included in the second coil 230.

In another embodiment, the second coil 230 may be disposed on the stationary unit, and the magnet 71B for OIS of the magnet 130 may be disposed on the OIS moving unit. At this time, the second coil 230 may be conductively connected to the supporting board 310 or/and the second substrate unit 800 through a conductive member.

For example, the second coil 230 may include a plurality of coil units 230-1 to 230-4. For example, the second coil 230 may include four coil units 230-1 to 230-4 disposed at four corners of the holder 270. For example, at least a portion of each of the coil units 230-1 to 230-4 may be disposed at a corresponding one of the corners of the holder 270. A portion of each of the coil units 230-1 to 230-4 may be disposed on a side portion of the holder 270 adjacent to a corresponding one of the corners of the holder 270.

Each of the coil units 230-1 to 230-4 may be in the form of a coil block having a closed curve or a ring shape. For example, each coil unit may have a hollow or hole. For example, the coil units may be formed as FP (Fine Pattern) coils, or winding coils, or coil blocks. For example, the hollow or hole of the coil units 230-1 to 230-4 may be inserted into or coupled to the protrusion 51 of the holder 270.

In another embodiment, the second coil 230 may be disposed on the first circuit board 250 and may be coupled with the first circuit board 250.

The second coil 230 may be conductively connected to the first circuit board 250. For example, the first coil unit 230-1 may be conductively connected to two terminals E1 and E2 of the first circuit board 250, the second coil unit 230-2 may be conductively connected to two other terminals E3 and E4 of the first circuit board 250, the third coil unit 230-3 may be conductively connected to two other terminals E5 and E6 of the first circuit board 250, and the fourth coil unit 230-4 may be conductively connected to two other terminals E7 and E8 of the first circuit board 250.

Power or a driving signal may be supplied to the first to fourth coil units 230-1 to 230-4 through the first circuit board 250. The power or driving signal supplied to the second coil 230 may be a DC signal or an AC signal, or may include a DC signal and an AC signal, and may be in the form of a current or a voltage.

The OIS moving unit may move in the first horizontal direction or the second horizontal direction or may roll around the optical axis by the interaction of the first to fourth magnet units 130-1 to 130-4 and the first to fourth coil units 230-1 to 230-4.

For example, current may be independently applied to at least three of the four coil units 230-1 to 230-4. In another embodiment, current may be independently applied to at least two of the four coil units 230-1 to 230-4.

For example, a separate independent driving signal, for example, a driving current, may be supplied to each of the four coil units 230-1 to 230-4.

The controller 830 and 780 may supply at least one driving signal to at least one of the first to fourth coil units 230-1 to 230-4, and may move the OIS moving unit in the X-axis direction and/or the Y-axis direction or rotate the OIS moving unit within a preset angular range around the optical axis by controlling the at least one driving signal. Hereinafter, the “controller” may be at least one of the controller 830 of the camera device 10 or the controller 780 of the optical device 200A.

When the second coil 230 is driven through three channels, three independent driving signals may be supplied to the second coil 230. For example, two coil units (e.g., 230-2 and 230-4, or 230-1 and 230-3) that are diagonally opposite each other among the four coil units can be connected in series, and one driving signal can be supplied to the two coil units that are connected in series, and an independent driving signal can be supplied to each of the remaining two coil units among the four coil units.

Or, when the second coil 230 is driven through four channels, an independent driving signal can be supplied to each of the four coil units 230-1 to 230-4 that are separated from each other.

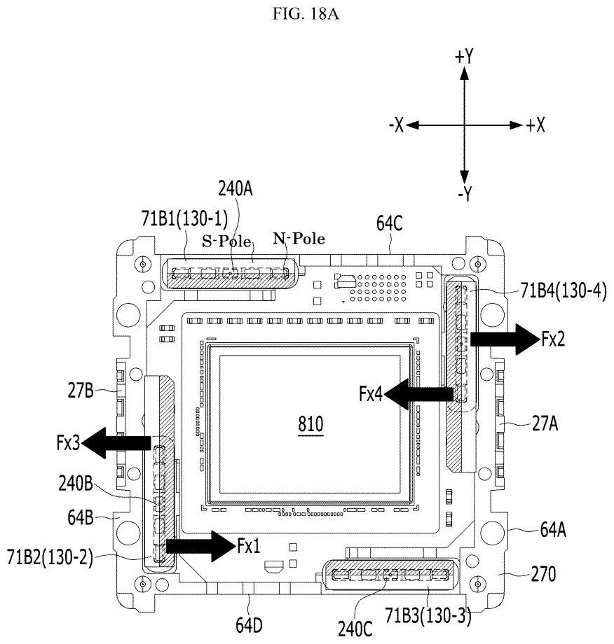

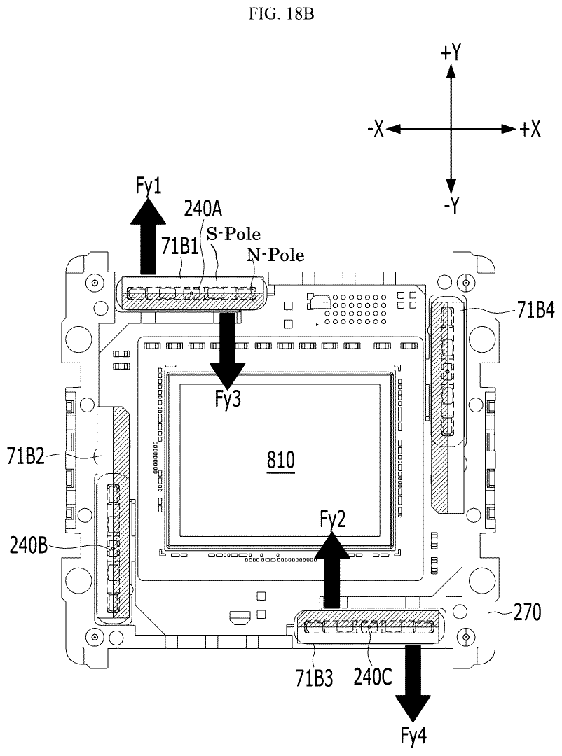

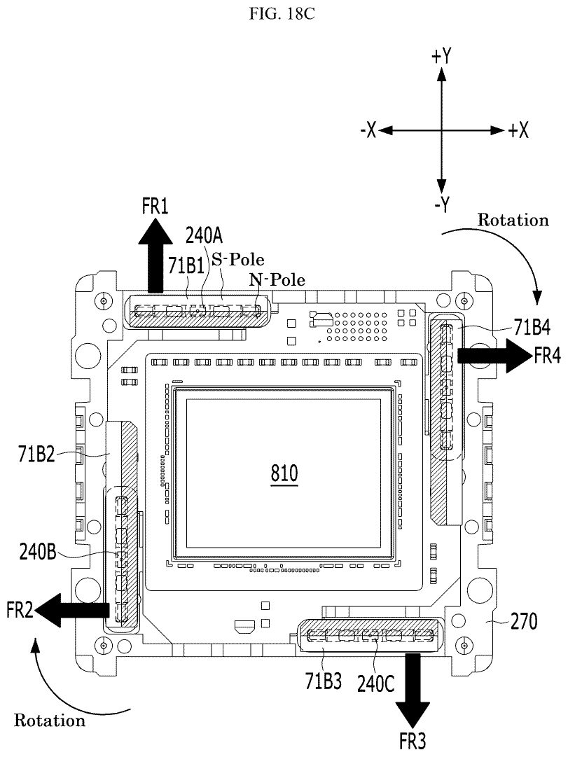

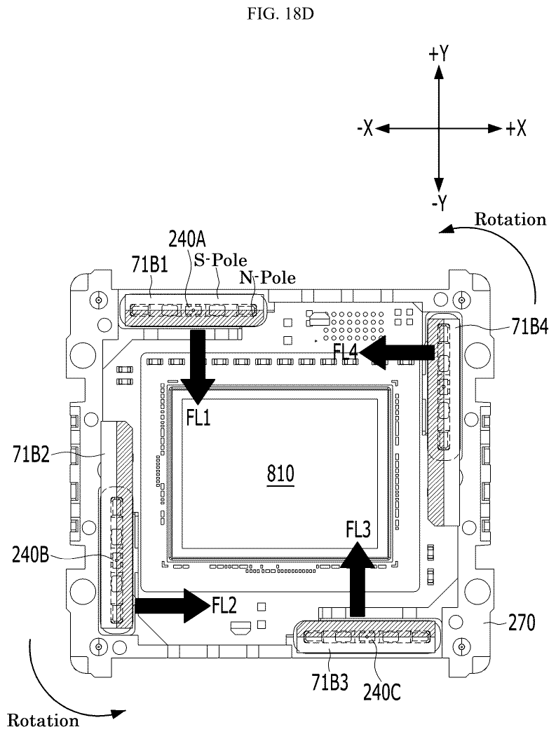

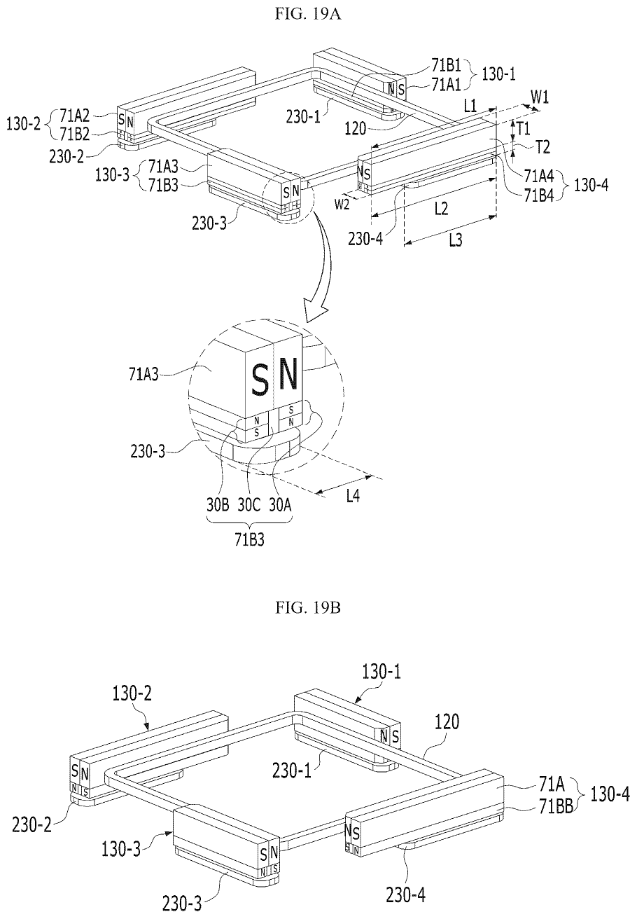

FIG. 18A is for explaining the X-axis direction movement of the OIS moving unit, and FIG. 18B is for explaining the Y-axis direction movement of the OIS moving unit.

The N and S poles of each of the first and third magnet units 71B1 and 71B3 facing each other in the first diagonal direction may be disposed to face each other in the first horizontal direction (e.g., Y-axis direction). In addition, the N and S poles of each of the second and fourth magnet units 71B2 and 71B4 facing each other in the second diagonal direction perpendicular to the first diagonal direction may be disposed to face each other in the second horizontal direction (e.g., X-axis direction).

That is, the direction in which the N pole and S pole of the first magnet unit 71B1 face each other may be the same as or parallel to the direction in which the N pole and S pole of the third magnet unit 71B3 face each other. In addition, the direction in which the N pole and the S pole of the second magnet unit 71B2 face each other may be the same as or parallel to the direction in which the N pole and the S pole of the fourth magnet unit 71B4 face each other.

In another embodiment in which the second magnet 71B is a two-pole magnet, the N pole of each of the first to fourth magnet units 71B1 to 71B4 may be located at an inside and the S pole may be located at an outside with respect to the boundary line (or boundary surface) of the N pole and the S pole. In another embodiment, the S pole of each of the first to fourth magnet units 71B1 to 71B4 may be located at the inside and the N pole may be located at the outside with respect to the boundary line of the N pole and the S pole. The boundary line (or boundary surface) may be a substantially non-magnetic portion that separates the N pole and the S pole, and may be a portion with almost no polarity.

Referring to FIG. 18A, the OIS moving unit may move or shift in the X-axis direction by the first electromagnetic force Fx1 (or Fx3) due to the interaction between the second coil unit 230-2 and the second magnet unit 71B2 and the second electromagnetic force Fx2 (or Fx4) due to the interaction between the fourth coil unit 230-4 and the fourth magnet unit 71B4. For example, the directions of the first electromagnetic force Fx1 (or Fx3) and the second electromagnetic force Fx2 (or Fx4) may be the same direction.

Referring to FIG. 18B, the OIS moving unit can move or shift in the y-axis direction by the third electromagnetic force Fy1 (or Fy3) due to the interaction between the first coil unit 230-1 and the first magnet unit 71B1 and the fourth electromagnetic force Fy2 (or Fy4) due to the interaction between the third coil unit 230-3 and the third magnet unit 71B3. For example, the directions of the third electromagnetic force Fy1 (or Fy3) and the fourth electromagnetic force Fy2 (or Fy4) may be the same direction.

FIG. 18C is for explaining the clockwise rotation of the OIS moving unit when the 4-channel operation is performed, and FIG. 18D is for explaining the counterclockwise rotation of the OIS moving unit when the 4-channel operation is performed.

Referring to FIG. 18C, the OIS moving unit can rotate, tilt, or roll clockwise about the optical axis or with the optical axis as an axis by the first electromagnetic force FR1 due to the interaction between the first coil unit 230-1 and the first magnet unit 71B1, the second electromagnetic force FR2 due to the interaction between the second coil unit 230-2 and the second magnet unit 71B2, the third electromagnetic force FR3 due to the interaction between the third coil unit 230-3 and the third magnet unit 71B3, and the fourth electromagnetic force FR4 due to the interaction between the fourth coil unit 230-4 and the fourth magnet unit 71B4.

Also, referring to FIG. 18D, the OIS moving unit can rotate, tilt, or roll counterclockwise about the optical axis or as an axis by the first electromagnetic force FL1 due to the interaction between the first coil unit 230-1 and the first magnet unit 71B1, the second electromagnetic force FL2 due to the interaction between the second coil unit 230-2 and the second magnet unit 71B2, the third electromagnetic force FL3 due to the interaction between the third coil unit 230-3 and the third magnet unit 71B3, and the fourth electromagnetic force FL4 due to the interaction between the fourth coil unit 230-4 and the fourth magnet unit 71B4.

For example, the direction of the first electromagnetic force FR1 (or FL1) and the direction of the third electromagnetic force FR3 (or FL3) can be opposite to each other. Also, for example, the direction of the second electromagnetic force FR2 (or FL2) and the direction of the fourth electromagnetic force FR4 (or FL4) may be opposite to each other. Also, for example, the direction of the first electromagnetic force RF1 (or FL1) and the direction of the second electromagnetic force FR2 (or FL2) may be perpendicular to each other.

In the case of 3-channel driving, a driving signal may not be provided to two coil units (e.g., 130-1 and 130-3, or 130-2 and 130-4) that are connected in series, and thus, the electromagnetic force by the two coil units that are connected in series may not be generated. For example, in the case of 3-channel driving, FR2 and FR4 may be omitted in FIG. 18C, and FR1 and FR3 may be present. Or, in the case of 3-channel driving, FR2 and FR4 may be present, and FR1 and FR3 may be omitted in FIG. 18C. Also, in the case of 3-channel driving, FL2 and FL4 may be omitted and FL1 and FL3 may be present in FIG. 18D. Or, in the case of 3-channel driving, FL2 and FL4 may be present and FL1 and FL3 may be omitted in FIG. 18D.

Compared to 3-channel driving, the 4-channel driving of FIGS. 18C and 18D can improve the electromagnetic force for rotation of the OIS moving unit, and thus, the driving current for driving the first to fourth coil units 230-1 to 230-4 can be reduced, thereby reducing power consumption.

In the embodiment of FIG. 2, OIS driving for hand shake correction is performed using the second magnet 71B and the second coil 230, but in other embodiments, OIS driving for hand shake correction may be performed using a shape memory alloy member. For example, the shape memory alloy member can be coupled to the stationary unit and the OIS moving unit, and can be conductively connected to the first substrate unit 255. The controller 830, 780 can supply a driving signal to the shape memory alloy member, and can move the OIS moving unit in a direction perpendicular to the optical axis by the shape memory alloy member, or can rotate, tilt, or roll the OIS moving unit around the optical axis.

In another embodiment, the OIS driving is performed using the second magnet 71B and the second coil 230, and the camera device 10 can include a ball member (not shown) disposed between the base 210 and the holder 270 to support the OIS moving unit. At this time, the ball member can support the OIS moving unit so that the OIS moving unit can move in a direction perpendicular to the optical axis or rotate, tilt, or roll around the optical axis by using a frictional force or/and a rolling force between the base 210 and the holder 270. For example, in an embodiment, a ball member may be disposed in the hole 59 of the base 210, and the ball member may be in contact with the base 210 and the holder 270, respectively. In another embodiment, the ball member may be provided, and the terminal member 37 and the wire 220 may be omitted.

The second position sensor 240 may be disposed at, coupled to, or mounted on the first surface (e.g., the upper surface) of the first circuit board 250. The second position sensor 240 may detect movement or displacement of the OIS moving unit in a direction perpendicular to the optical axis direction, for example, shift or movement of the OIS moving unit in a direction perpendicular to the optical axis direction. In addition, the second position sensor 240 may detect rotation, rolling, or tilting of the OIS moving unit within a preset range with respect to the optical axis or with the optical axis as an axis. The first position sensor 170 may be expressed as an “AF position sensor”, and the second position sensor 240 may be expressed as an “OIS position sensor”.

The second position sensor 240 may be opposed to or overlapped with the magnet 130 in the optical axis direction. For example, the second position sensor 240 may be opposed to or overlapped with the second magnet 71B in the optical axis direction. For example, the second position sensor 240 may include three or more sensors corresponding to or overlapping with three or more of the four magnet units 71B1 to 71B4 of the second magnet 71B in the optical axis direction to detect the movement of the OIS moving unit.

For example, the second position sensor 240 may be disposed below the second coil 230.

For example, the second position sensor 240 may not overlap the second coil 230 in a direction perpendicular to the optical axis. For example, a sensing element of the second position sensor 240 in a direction perpendicular to the optical axis may not overlap the second coil 230. The sensing element may be a portion that detects a magnetic field.

For example, a center of the second position sensor 240 may not overlap the second coil 230 in a direction perpendicular to the optical axis. For example, the center of the second position sensor 240 may be the spatial center in the x-axis and y-axis directions in an xy-coordinate plane perpendicular to the optical axis. Alternatively, the center of the second position sensor 240 may be the spatial center in the x-axis, y-axis, and z-axis directions.

In another embodiment, at least a portion of the second position sensor 240 may overlap the second coil 230 in a direction perpendicular to the optical axis.

For example, the second position sensor 240 may overlap the hole 41A to 41C of the holder 270 in the optical axis direction. Also, for example, the second position sensor 240 may overlap the hollow of the second coil 230 in the optical axis direction. Also, for example, the hole 41A to 41C of the holder 270 may overlap at least a part of the hollow of the second coil 230 in the optical axis direction.

For example, at least a part of the second position sensor 240, for example, the center of the second position sensor 240, may not overlap the second coil 230 in the optical axis direction.

For example, the second position sensor 240 may include a first sensor 240A, a second sensor 240B, and a third sensor 240C that are disposed to be spaced apart from each other.

For example, each of the first to third sensors 240A, 240B, and 240C may be a Hall sensor. In another embodiment, each of the first to third sensors 240A, 240B, and 240C may be a driver IC including a Hall sensor and a driver. The description of the first position sensor 170 may be applied or analogically applied to the first to third sensors 240A, 240B, and 240C. For example, each of the first to third sensors 240A2, 240B, and 240C may be a displacement detection sensor whose output voltage changes according to the position or relationship with the corresponding magnet unit.

Each of the first sensor 240, the second sensor 240B, and the third sensor 240C may be conductively connected to the first circuit board 250.

The second position sensor 240 may be disposed below the hollow of the second coil 230. In another embodiment, the second position sensor 240 may be disposed outside the second coil 230 when viewed in the optical axis or from the top.

The second position sensor 240 may not overlap the second coil 230 in a direction perpendicular to the optical axis direction. For example, the second position sensor 240 may overlap the holder 270 in the direction perpendicular to the optical axis direction.

For example, the first sensor 240A may be disposed under the hollow of the first coil unit 230-1. The first sensor 240A may be disposed in a corresponding one hole 41A among the holes 41A to 41C of the holder 270. The second sensor 240B may be disposed under the hollow of the second coil unit 230-2. The second sensor 240B may be disposed in a corresponding another hole 41B among the other holes 41A to 41C of the holder 270. The third sensor 240C may be disposed under the hollow of the third coil unit 230-3. The third sensor 240C may be placed in a corresponding another hole 41C among the holes 41A to 41C of the holder 270.

For example, each of the first to third sensors 240A, 240B, and 240C may not overlap a corresponding one of the coil unit 230-1 to 230-3 in a direction perpendicular to the optical axis. The first to third sensors 240A, 240B, and 240C may overlap the holder 270 in a direction perpendicular to the optical axis.

By disposing the first to third sensors 240A, 240B, and 240C so as not to overlap the OIS coil 230 in a direction perpendicular to the optical axis, the influence of the output of the OIS position sensor 240 on the magnetic field of the OIS coil 230 can be reduced, thereby accurate OIS feedback driving can be enabled and reliability of the OIS operation can be ensured.

The second position sensor 240 may be opposed to, correspond to, or overlap the magnet 130 in the direction of the optical axis. For example, at least a part of the first sensor 240A may overlap the first magnet unit 71B1 of the second magnet 71B in the direction of the optical axis at the initial position of the OIS moving unit. The first sensor 240A may output a first output signal (e.g., a first output voltage) according to the result of detecting the magnetic field of the first magnet unit 71B1.

For example, at the initial position of the OIS moving unit, at least a part of the second sensor 240B may overlap the second magnet unit 71B2 of the second magnet 71B in the optical axis direction, and may output a second output signal (e.g., a second output voltage) according to the result of detecting the magnetic field of the second magnet unit 71B2.

In addition, for example, at the initial position of the OIS moving unit, at least a part of the third sensor 240C may overlap the third magnet unit 71B3 of the second magnet 71B in the optical axis direction, and may output a third output signal (e.g., a third output voltage) according to the result of detecting the magnetic field of the third magnet unit 71B3.

The initial position of the OIS moving unit may be an original position of the OIS moving unit when no power or driving signal is applied to the second coil 230 from the controller 820, 780, or may be a position at which the OIS moving unit is disposed when elastically deformed only by a weight of the OIS moving unit by the support board. In addition, the initial position of the OIS moving unit may be the position at which the OIS moving unit is disposed when gravity acts from the first substrate unit 255 toward the second substrate unit 800, or when gravity acts in the opposite direction.

In order to improve the linearity of the relationship between the displacement of the OIS moving unit and the output of the second position sensor 240, each sensor unit 240A, 240B, and 240C may overlap the corresponding magnet unit 71B1, 71B2, and 71B3 in the optical axis direction within the stroke range of the OIS moving unit.

For example, the controller 830 or 780 can control the rolling of the OIS moving unit using at least one of the first output voltage of the first sensor 240A, the second output voltage of the second sensor 240B, and the third output voltage of the third sensor 240C. For example, the controller 830 or 780 can control the rolling of the OIS moving unit using the first output voltage and the third output voltage.

For example, the controller 830 or 780 can control or adjust the movement or displacement of the OIS moving unit in the first horizontal direction (e.g., the y-axis direction) or the second horizontal direction (e.g., the x-axis direction) using at least one of the first to third output voltages. For example, the controller 830 or 780 can control or adjust the movement or displacement of the OIS moving unit in the first horizontal direction (e.g., the y-axis direction) using the first output voltage of the first sensor 240A, and can control or adjust the movement or displacement of the OIS moving unit in the second horizontal direction using the second output voltage of the second sensor 240B.

For example, each of the first to third sensors 240A, 240B, and 240C can be a Hall sensor. In another embodiment, each of the first to third sensors can be a driver IC including a Hall sensor. In another embodiment, each of the first and second sensors 240A and 240B can be a Hall sensor, and the third sensor 240C can be a TMR (Tunnel MagnetoResistance) sensor. At this time, the TMR (Tunnel MagnetoResistance) sensor may be a TMR magnetic angle sensor.

In another embodiment, each of the first to third sensors 240A, 240B, and 240C may be a TMR (Tunnel MagnetoResistance) sensor. At this time, the TMR sensor may be a TMR linear magnetic field sensor whose output is linear according to the displacement (or stroke) of the OIS moving unit.

The base 210 may be disposed under the first substrate unit 255. The base 210 may be spaced apart from the first substrate unit 255. The base 210 may have a polygonal shape, for example, a quadrangle shape, that coincides with or corresponds to the cover member 300 or the first substrate unit 255.

For example, the base 210 may include an opening 210A corresponding to or facing the first substrate unit 255. The opening 210A of the base 210 may be a through hole penetrating the base 210 in the optical axis direction. In other embodiments, the base may not have an opening.

For example, the base 210 may be coupled with the side plate 302 of the cover member 300. The side potion or outer side surface of the base 210 may include a step 211 (see FIG. 14) to which an adhesive may be applied when bonded to the side plate 302 of the cover member 300. At this time, the step 211 may guide the side plate 302 of the cover member 300 coupled to the upper side. The step 211 of the base 210 and the lower end of the side plate 302 of the cover member 300 may be bonded and fixed by an adhesive or the like.

The base 210 may include at least one protrusion 216A and 216B protruding from the upper surface thereof. For example, the protrusion 216A and 216B may protrude upward from the outer side surface of the base 210. For example, the base 210 may include two protrusions 216A and 216B that face each other or overlap each other in a first horizontal direction (e.g., in the Y-axis direction).

For example, the base 210 may include four side portions (or side plates), and the protrusions 216A and 216B may be formed on two of the four side portions of the base 210. For example, the protrusions 216A and 216B may be disposed at or positioned in the center of the side portion (or side plate) of the base 210.

The base 210 may include a groove 341b. The groove 341b may be an adhesive receiving groove. The groove 341b may be formed on an outer side surface of the protrusion 216A and 216B of the base 210. The groove 341b may be formed on an upper surface of the protrusion 216A and 216B of the base 210. The groove 341b may be formed from an upper surface to a lower surface of the protrusion 216A and 216B of the base 210. An adhesive for adhering the support board 310 to the base 210 may be disposed in the groove 341b. The groove 341b may include a plurality of grooves. For example, the groove 341b may extend in the optical axis direction. In another embodiment, the groove formed at the protrusion 216A and 216B of the base 210 may extend in a direction perpendicular to the optical axis.

The second substrate unit 800 may be disposed under the base 210. For example, the second substrate unit 800 may be disposed to be apart from the OIS moving unit, for example, the first substrate unit 255 and the heat dissipation member 280 in the optical axis direction.

For example, the second substrate unit 800 may be disposed under the lower surface of the base 210. The second substrate unit 800 may be coupled to the base 210. For example, the second substrate unit 800 may be coupled to the lower surface of the base 210.

The second substrate unit 800 may serve to provide a signal to the image sensor unit 350 from the outside or output a signal transmitted from the image sensor unit 350 to the outside.

The second substrate unit 800 may include a first region 801 (or first substrate) corresponding to, opposite to, or overlapping the AF driving unit 100 or the image sensor 810 in the optical axis direction, a second region 802 (or second substrate) at which a connector 804 is disposed, and a third region 803 (or third substrate) connecting the first region 801 and the second region 802. The connector 804 is conductively connected to the second region 802 of the second substrate unit 800 and may have a port for conductively connecting an external device (e.g., an optical device 200A). The opening 210A of the base 210 may be closed or encapsulated by the first region 801 of the second substrate unit 800.

The first region 801 of the second substrate unit 800 may correspond to, face, or overlap at least one of the cover member 300 and the base 210 in the optical axis direction. For example, the first region 801 may overlap the upper plate 301 and the side plate 302 of the cover member 300 in the optical axis direction.

Each of the first region 801 and the second region 802 of the second substrate unit 800 may include a rigid substrate. The third region 803 may include a flexible substrate. In addition, each of the first region 801 and the third region 803 may further include a flexible substrate.

In another embodiment, at least one of the first to third regions 801 to 803 of the circuit board 800 may include at least one of a rigid substrate and a flexible substrate.

The second substrate unit 800 may be disposed at the rear of the first substrate unit 255. For example, the first substrate unit 255 may be disposed between the AF driving unit 100 and the second substrate unit 800. In another embodiment, the second substrate portion may be arranged between the AF driving portion and the first substrate portion.

When viewed from the top, the first region 801 of the second substrate unit 800 may have a polygonal shape (e.g., a quadrangle, a square, or a rectangle), but is not limited thereto, and in another embodiment, may have a shape such as a circle.

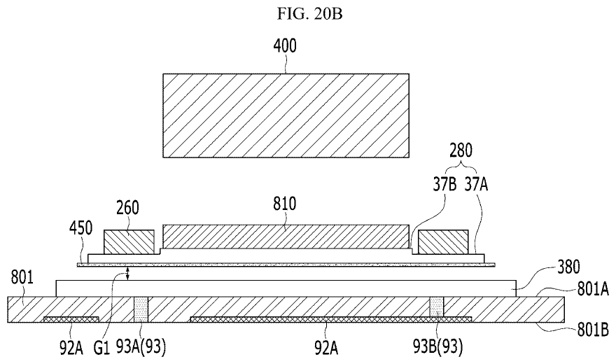

FIG. 20A illustrates one embodiment of the arrangement of the first to third regions 801 to 803 of the second substrate unit 800, the extension region 808, the AF moving unit and the OIS moving unit, and the controller 830.

Referring to FIG. 20A, the first region 801 may include four side portions 85A to 85D (or side surfaces). For example, the first region 801 may include first and second side portions 85A and 85B that are positioned facing or opposite to each other in a second horizontal direction (e.g., in the X-axis direction), and third and fourth side portions 85C and 85D that are positioned facing or opposite to each other in the first horizontal direction (e.g., in the Y-axis direction).

The second region 802 may be positioned adjacent to the first side portion 85A of the first region 801, and the third region 803 may be connected to the first side portion 85A of the first region 801. For example, the third region 803 may be extended from the first region 801 and connected to one side of the second region 802 facing the first side portion 85A.

The second substrate unit 800 may include a plurality of terminals 800B corresponding to the terminals 311 of the support board 310. The plurality of terminals 800B may be formed in the first region 801 of the second substrate unit 800. For example, the second substrate unit 800 may include first terminals 800B1 spaced apart or disposed at a second horizontal direction (e.g., in the X-axis direction) of the first region 801 along a side of the third side portion 85C and second terminals 800B2 spaced apart or disposed at a second horizontal direction along a side of the fourth side portion 85D of the first region 801.

For example, a plurality of terminals 800B may be formed on a first surface (e.g., an upper surface) of the second substrate unit 800 (e.g., a first region 801) facing the first substrate unit 255.

For example, the controller 830 may be disposed on an extension region extending from one of the third and fourth side portions 85C and 85D of the first region 801 of the second substrate unit 800. In another embodiment, the controller may be disposed on an extension region extending from a side portion of the first region 801 of the second substrate unit 800 where a plurality of terminals are formed.

A coupling hole (not shown) may be formed in the first region 801, and a coupling protrusion (not shown) for coupling with the coupling hole of the first region 801 may be formed at the base 210.

The camera device 10 may further include a heat dissipation member 380 that is arranged, coupled, or fixed to the second substrate unit 800. For example, the heat dissipation member 380 may be disposed on, coupled to, or fixed to the upper surface of the first region 801 of the second substrate unit 800. In other embodiments, the heat dissipation member 380 may be omitted.

The camera device 10 may further include a third heat dissipation member (not shown) that is disposed on, coupled to, or fixed to the second surface (e.g., the lower surface) of the second substrate unit 800.

For example, the heat dissipation member 380 may be a plate-shaped member having a preset thickness and hardness. In addition, the heat dissipation member 380 may face or overlap the heat dissipation member 280 in the optical axis direction.

In FIG. 20A, the controller 830 is disposed on or coupled to the upper surface of the extension region 808, but in other embodiments, the controller may be positioned or coupled on the lower surface of the extension region 808.

In FIG. 20A, the controller 830 is positioned on the extension region 808 of the second substrate unit 800 located outside the cover member 300, but in other embodiments, the controller may be disposed on the first region of the second substrate unit 800 located outside the base 210.

In another embodiment, the controller may be disposed or mounted on the second circuit board 260 which is a sensor board. For example, in other embodiments, the controller may be disposed or mounted on the upper surface of the second circuit board 260. Since the heat dissipation member 280 is disposed or coupled on the lower surface of the second circuit board 260, when the controller is disposed on the second circuit board 260, heat generated by the controller can be easily dissipated by the heat dissipation member 280, thereby heat dissipation efficiency and heat dissipation performance can be improved.

FIG. 20B shows a simplified cross-sectional view of the lens module 400, the first substrate unit 255, the image sensor 810, and the second substrate unit 800.

Referring to FIG. 20B, the image sensor 810 can be disposed in the opening 260A (or hole) of the second circuit board 260 and can be coupled with the heat dissipation member 280.

For example, the heat dissipation member 280 may include a body 37A disposed below the second circuit board 260 and a protruding portion 37B (or protrusion region) protruding from the body 37A and disposed within the opening 260A of the second circuit board 260.

The camera device 10 may include a heat dissipation body 450 connecting the heat dissipation member 280 and the support member (e.g., the support board 310).

The heat dissipation body 450 may include a body (or first region) that is coupled with the lower surface of the heat dissipation member 280 and a connection member (or second region) that connects the body and the support member (e.g., the support board 310). The heat dissipation body 450 may include a graphite sheet.

The image sensor 810 may be disposed on, coupled to, or fixed at the protruding portion 37B. For example, the image sensor 810 may be disposed on, coupled to, or attached to the upper surface of the protruding portion 37B. For example, the upper surface of the protruding portion 37B may be positioned lower than the upper surface of the second circuit board 260. In another embodiment, the upper surface of the protruding portion 37B may be positioned at the same height as the upper surface of the second circuit board 260.

The heat dissipation member 380 may be disposed on the first surface 801A (or upper surface) of the first region 801 of the second substrate unit 800 facing the heat dissipation member 280 in the optical axis direction.

The separation distance G1 (or gap) in the optical axis direction between the first substrate unit 255 and the second substrate unit 800 may be 0.05 [mm] to 0.7 [mm]. For example, the separation distance G1 may be the distance between the lower surface of the heat dissipation member 280 and the upper surface of the heat dissipation member 380.

In another embodiment, G1 may be 0.15 [mm] to 0.5 [mm]. In another embodiment, G1 may be 0.15 [mm] to 0.3 [mm]. In another embodiment, G1 may be 0.2 [mm] to 0.3 [mm].

The second substrate unit 800 may include a first conductive layer 93 that is exposed to the first surface 801A and comes into contact with the heat dissipation member 380, for example, the lower surface of the heat dissipation member 380. For example, the first conductive layer 93 may be thermally bonded to the lower surface of the heat dissipation member 380 or may be bonded by a conductive adhesive, for example, solder. In addition, for example, the first conductive layer (93) may be conductively connected to the heat dissipation member 380.

The second substrate unit 800 may include a second conductive layer 92A that is connected to the first conductive layer 93 and exposed from the second surface 801B (or lower surface) of the second substrate unit 800, which is the opposite surface of the first surface 801A of the second substrate unit 800. For example, the second conductive layer 92A may be conductively or electrically connected to a ground of the second substrate unit 800.

The first conductive layer 93 may be in the form of a via passing through at least a portion of the second substrate unit 800. For example, the first conductive layer 93 may include a first via 93A that passes through the second substrate unit 800 and is open or exposed to the second surface 801B of the second substrate unit 800. In addition, the first conductive layer 93 may include a second via 93B, and one end of the second via 93B may be in contact with the lower surface of the heat dissipation member 380 and the other end of the second via 93B may be in contact with, coupled to, or connected to the second conductive layer 92A.

In FIG. 20B, the second conductive layer 92A may be disposed in, coupled to, or attached to a groove formed in the second surface 801B of the second substrate unit 800. In another embodiment, the second conductive layer may be disposed on, bonded to, or attached to the second surface 801B of the second substrate unit 800, which is a plane in which no groove is formed.

The first conductive layer 93 and the second conductive layer 92A may serve as a heat dissipation pattern or heat dissipation pad for heat dissipation of the second substrate unit 800. That is, since the first conductive layer 93 and the second conductive layer 92A are simply for the purpose of heat dissipation, they may not be conductively connected to other wirings of the second substrate unit 800 except for the ground of the second substrate unit 800. At this time, the other wirings may be wirings conductively connected to electronic components (or circuit components) such as the controller 830 or 780, the image sensor 810, or the support board 310.

The second conductive layer 92A may be conductively connected to the cover member 300 (e.g., the side plate 302) through solder, conductive adhesive, or conductive tape. Or, in another embodiment, the second conductive layer 92A connected to the ground of the second substrate unit 800 and the cover member 300 may be conductively connected by the bracket. The bracket may be a mechanism in which the camera device is received or accommodated in order to protect the camera device. For example, the bracket may be made of a conductive material. Since the ground and heat dissipation member 380 of the second substrate unit 800 and the cover member 300 are conductively connected, the camera device 10 may be protected from static electricity and heat dissipation efficiency may be improved.

In another embodiment, at least one of the first conductive layer and the second conductive layer of the second substrate unit 800 may be applied or analogically applied to the second circuit board 260. For example, the second circuit board 260 according to another embodiment may include at least one third conductive layer that is in contact with the heat dissipation member 280, and at least a portion of the third conductive layer may be exposed from the second circuit board 260.

Since the heat dissipation member 380 is disposed on the first surface of the second substrate unit 800, the distance from the heat dissipation member 280 may be reduced, thereby improving the heat dissipation efficiency.

The heat dissipated from the heat dissipation member 280 may be transferred to the heat dissipation member 380 through convection or radiation, and the transferred heat may be released to the outside through the heat dissipation member 380, thereby improving the heat dissipation effect. Since the upper surface of the heat dissipation member 380 and the lower surface of the heat dissipation member 280 are disposed to face each other or overlap each other in the optical axis direction, heat may be well transferred from the heat dissipation member 280 to the heat dissipation member 380.

For example, the heat dissipation member 280 and the heat dissipation member 380 may be formed of the same material. In another embodiment, the heat dissipation member 280 and the heat dissipation member 380 may be formed of different materials. For example, the thermal conductivity of the heat dissipation member 280 may be applied to or analogically applied to the heat dissipation member 380.

In addition, the heat dissipation member 380 may stably support the second substrate unit 800 and may act as a reinforcing member to inhibit the second substrate unit 800 from being damaged by external impact or contact.

In another embodiment, the heat dissipation member 380 may be formed of a heat dissipation member with high thermal conductivity, for example, a heat dissipation epoxy, a heat dissipation plastic, or a heat dissipation synthetic resin.

The heat dissipation member 380 may include at least one groove or at least one unevenness to enhance the heat dissipation effect. For example, a groove or unevenness having a preset pattern may be formed on at least one of the upper or lower surfaces of the heat dissipation member 380.

In another embodiment, the heat dissipation member 380 may include a hole or a through hole instead of a groove. For example, the heat dissipation member 380 according to another embodiment may include a plurality of through holes. The description of the preset pattern of the heat dissipation member 280 may be applied or analogically applied to the heat dissipation member 380.

A camera device according to another embodiment may include a heat dissipation member disposed under a second substrate unit 800, and in this case, the description of the material of the heat dissipation member 280, or 380 may be applied or analogically applied.

The support board 310 may support the OIS moving unit so that the moving unit moves in a direction perpendicular to the optical axis direction with respect to the stationary unit, and may conductively connect the first substrate unit 255 and the second substrate unit 800.

The support board 310 may be expressed as a “support member”, a “connection board”, or a “connection portion”. Alternatively, the support board 310 may be alternatively expressed as an “interposer”. Alternatively, the “interposer” may include the first circuit board 250 and the support board 310 that are formed integrally.

In another embodiment, instead of the support board 310, a support member may be provided, one end of the support member is connected to the moving unit, for example, the first substrate unit 255, and the other end of the support member is connected to the stationary unit, for example, the second substrate unit 800. For example, the support member may include at least one of a plate spring or a suspension wire. For example, the support member may conductively connect the first substrate unit 255 and the second substrate unit 800.

The support board 310 may include a flexible substrate or may be a flexible substrate. For example, the support board 310 may include a flexible printed circuit board (FPCB). At least a portion of the support board 310 may have flexibility. The first circuit board 250 and the support board 310 may be connected to each other.

Referring to FIG. 16, for example, the support board 310 may include a connection portion 320 connected to the first circuit board 250. For example, the first circuit board 250 and the support board 310 may be formed integrally. In another embodiment, the first circuit board 250 and the support board 310 may be configured separately rather than integrally, and may be connected to each other by the connection portion 320 and may be conductively connected. Or, in another embodiment, the connection portion 320 may be formed integrally with at least one of the support board 310 or the first circuit board 250.

In addition, the support board 310 may be conductively connected to the first circuit board 250. The support board 310 may be conductively connected to the second substrate unit 800. For example, one end of the support board 310 may be connected or coupled to the first substrate portion 255, for example, the first circuit board 250. In addition, the other end of the support board 310 may be connected or coupled to the second substrate unit 800.

The support board 310 may support the OIS moving unit with respect to the stationary unit. In addition, the support board 310 may guide the movement of the OIS moving unit. The support board 310 may guide the OIS moving unit to move in a direction perpendicular to the optical axis direction. The support board 310 may guide the OIS moving unit to rotate, tilt, or roll about the optical axis with the optical axis as an axis. The support board 310 may limit the movement of the OIS moving unit in the optical axis direction.

A part of the support board 310 may be coupled, attached, or fixed to the base 210 that is the stationary unit, and another part of the support board 310 may be coupled, attached, or fixed to the holder 270 that is OIS moving unit.

For example, a part of the body 86 and 87 of the support board 310 may be coupled to the base 210 (e.g., the protruding portions 216A and 216B), and another part of the body 86 and 87 may be coupled to the holder 270 (e.g., the protruding portions 27A and 27B).

The connection portion 320 of the support board 310 may be connected to the first substrate part 255 (e.g., the first circuit board 250) and may be conductively connected to the first substrate part 255. The extension members 7A to 7D of the support board 310 can be coupled with the second substrate unit 800 (e.g., terminals 800B) and can be conductively or electrically connected to the second substrate unit 800 (e.g., terminals 800B).

For example, the support board 310 can include a circuit member and an elastic member coupled to the circuit member. The elastic member is for elastically supporting the OIS moving unit and can be implemented as an elastic body, for example, a spring. The elastic member can include a metal or be made of an elastic material. The circuit member is for conductively connecting the first circuit board 250 and the second substrate unit 800 and can be a flexible substrate or can include at least one of a flexible substrate and a rigid substrate. For example, the circuit member can be an FPCB.

For example, the support board 310 may include at least one connection portion 320A and 320B that is connected to the first substrate unit 255 (e.g., the first circuit board 250) and conductively connected to the first substrate unit 255 (e.g., the first circuit substrate 250).

In addition, the support board 310 may include at least one extension member 7A to 7D that is connected to the second substrate unit 800 and conductively connected to the second substrate unit 800, and the at least one extension member 7A to 7D may include a plurality of terminals 311.

For example, the support board 310 may be disposed to surround the OIS moving unit, e.g., the first substrate unit 255. For example, the support board 310 may be disposed to surround four side portions 33A to 33D (see FIG. 16) or outer side surfaces of the first circuit board 250.

For example, the support board 310 may not overlap the OIS moving unit, for example, the first substrate unit 255 in the optical axis direction, and at least a portion of the support board 310 may overlap the OIS moving unit, for example, the first substrate unit 255 in the direction perpendicular to the optical axis direction.

For example, the support board 310 may include a plurality of support boards that are separated or spaced from each other. In another embodiment, the support board 310 may be formed in a single board.

The support board 310 may include a body 86 and 87. For example, the body 86 and 87 may be disposed to surround the OIS moving unit, for example, the first substrate unit 255. For example, the body 86 and 87 may not overlap the OIS moving unit, for example, the first substrate unit 255 in the optical axis direction, and at least a portion of the body 86 and 87 may overlap the OIS moving unit, for example, the first substrate unit 255 in the direction perpendicular to the optical axis direction.

For example, the body 86 and 87 may have a flat plate shape in the optical axis direction or in a direction parallel to the optical axis direction. For example, when viewed from the top, the outer shape of the body 86 and 87 may have a polygonal shape, for example, a quadrangle shape or a circle.

For example, the body 86 and 87 may include a plurality of parts that are separated or spaced from each other. In another embodiment, the body may be formed as a single body.

In addition, the support board 310 may include an extension member that extends from the body 86 and 87 and is coupled with the second substrate unit 800. For example, the extension member of the support board 310 may extend toward the second substrate unit 800, and one end of the extension member of the support board 310 may be coupled with the second substrate unit 800. A plurality of terminals for conductively connecting to the second substrate unit 800 by solder or a conductive adhesive may be formed at one end of the extension member of the support board 310. For example, the extension member of the support board 310 may be expressed as a “terminal portion,” a “protruding portion,” or a leg member.

The extension members 7A to 7D may extend from the body 86 and 87 toward the second substrate unit 800. For example, the extension members 7A to 7D may extend in a first direction from the body 86 and 87. In addition, the extension members 7A to 7D may extend in a second horizontal direction (X-axis direction).

For example, the extension members 7A to 7D of the support board 310 may include a first portion extending in the optical axis direction from the body 86 and 87 and a second portion extending in a direction perpendicular to the optical axis from the first portion. For example, the extension members 7A to 7D of the support board 310 may be fixed or coupled to the stationary unit (e.g., base 210). For example, when the OIS moving unit moves, the body 86 and 87 of the support board 310 may be movable, and the extension members 7A to 7D of the support board 310 may be fixed and not move.

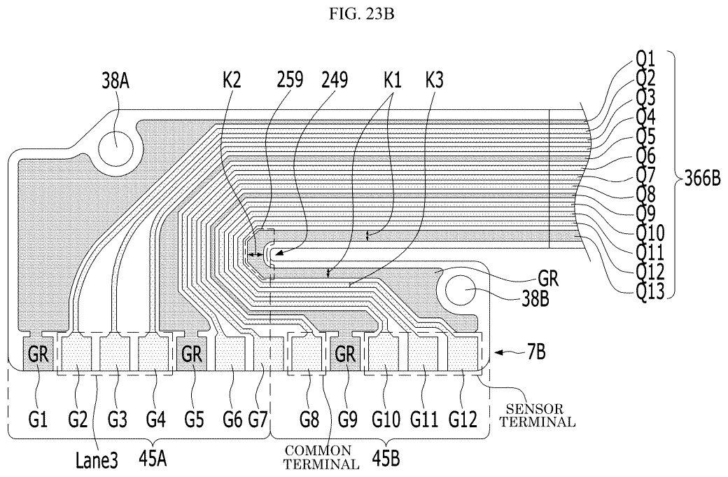

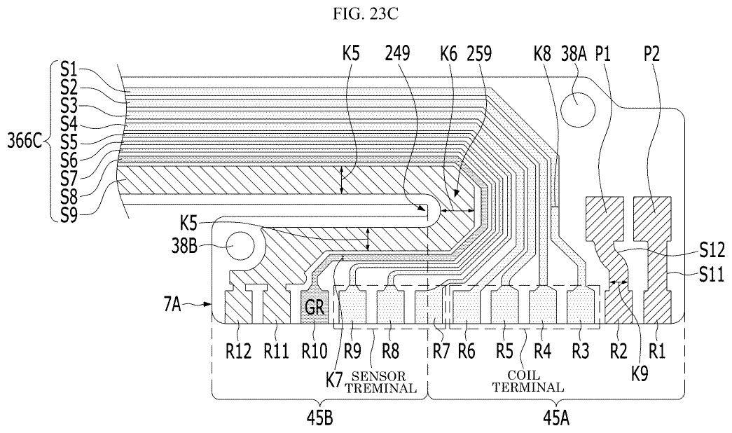

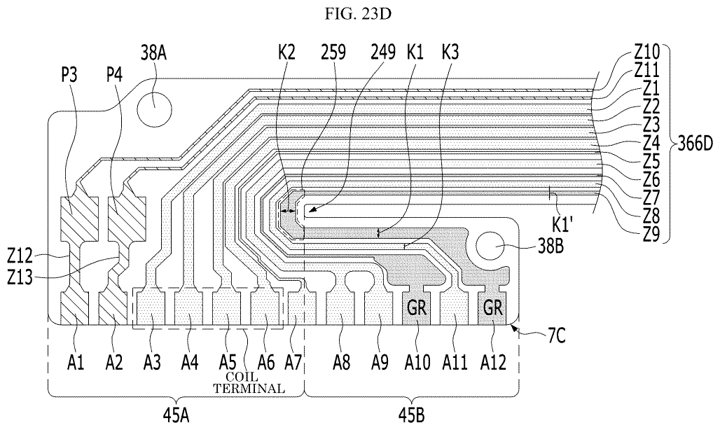

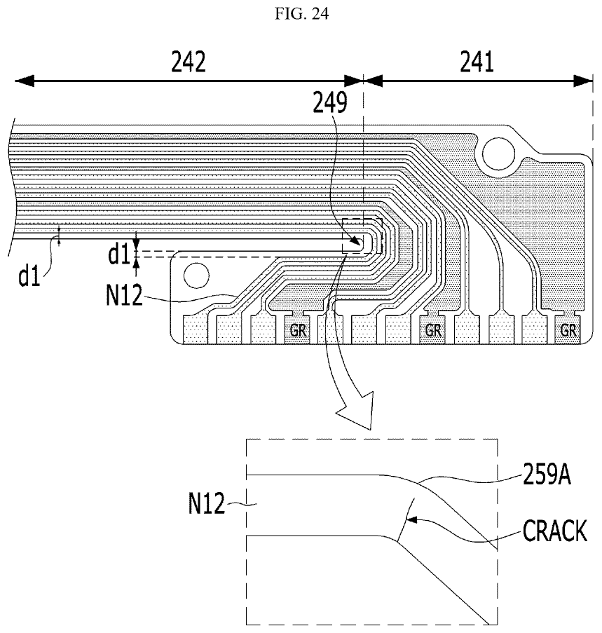

Referring to FIGS. 23A and 23B, the extension members 7A to 7D may include a first extension portion 45A (or a first portion) extending in a direction from the body 86 and 87 toward the second substrate unit 800 and a second extension portion 45B (or a second portion) extending in a direction different from the extension direction of the first extension portion 45A.

For example, the support board 310 may include a first support board 310-1 and a second support board 310-2 spaced apart from each other. The first and second support boards 310-1 and 310-2 may be formed left-right symmetrically. In another embodiment, the first support board 310-1 and the second support board 310-2 may be formed as one substrate formed integrally. In another embodiment, the support board 310 may include three or more support boards.

For example, the first and second support boards 310-1 and 310-2 may be disposed to surround four side portions 33A to 33D of the first circuit board 250.

For example, the first support board 310-1 may include a first body 86 and at least one extension members 7A and 7B extending from the first body 86. At least one extension members 7A and 7B of the first support board 310-1 may include a plurality of terminals 311.

The second support board 310-2 may include a second body 87 and at least one extension member 7C and 7D extending from the second body 87. At least one extension member 7C and 7D of the second support board 310-2 may include a plurality of terminals 311.

The first circuit board 250 may include first and second side portions 33A and 33B positioned opposite each other, and third and fourth side portions 33C and 33D positioned between the first side portion 33A and the second side portion 33B and positioned opposite each other.

For example, the first connection portion 320A may connect the first body 86 and the first side portion 33A of the first circuit board 250. The second connection portion 320B may connect the second body 87 and the second side portion 33B of the first circuit board 250.

The first body 86 may include a first portion 6A corresponding to or opposite the first side portion 33A of the first circuit board 250, a second portion 6B corresponding to a part (or one side) of the third side portion 33C of the first circuit board 250, and a third portion 6C corresponding to a part (or one side) of the fourth side portion 33D of the first circuit board 250. In addition, the first body 86 may include a first bend portion 6D connecting one end of the first portion 6A and the second portion 6B and bent from one end of the first portion 6A, and a second bend portion 6E connecting the other end of the first portion 6A and the third portion 6C and bent from the other end of the first portion 6A. For example, the first body 86 may have a ‘⊏’ shape.

For example, the first support board 310-1 may include an extension member 7A and an extension member 7B. For example, the extension member 7A may be connected to one side of the first body 86, and the extension member 7B may be connected to the other side of the first body 86.

For example, the extension member 7A may be extended or protruded from the second portion 6B of the first body 86 toward the second substrate unit 800, and the extension member 7B may be extended or protruded from the third portion 6C of the first body 86 toward the second substrate unit 800. The extension member 7B may be located on the opposite side of the extension member 7A with the first substrate unit 255 (e.g., the first circuit board 250) interposed therebetween.

For example, the first connection portion 320A can connect the first portion 6A of the first body 86 and the first side portion 33A of the first circuit board 250. The first connection portion 320A can include a bent portion. For example, the first connection portion 320A can connect the central region of the first portion 6A of the first body 86 and the central region of the first side portion 33A of the first circuit board 250.

The second body 87 may include a first portion 9A corresponding to or opposite the second side portion 33B of the first circuit board 250, a second portion 9B corresponding to or opposite another portion (or the other side) of the third side portion 33C of the first circuit board 250, and a third portion 9C corresponding to or opposite another portion (or the other side) of the fourth side portion 33D of the first circuit board 250. In addition, the second body 87 may include a first bent portion 9D connecting one end of the first portion 9A and the second portion 9B and being bent from one end of the first portion 9A, and a second bent portion 9E connecting the other end of the first portion 9A and the third portion 9C and being bent from the other end of the first portion 9A. For example, the second body 87 may have a ‘⊏’ shape. Also, for example, the second body 87 may have a symmetrical shape with the first body 86 with respect to the optical axis. For example, the second body 87 may be symmetrical with the first body 86 with respect to the optical axis.

For example, the second support board 310-2 may include an extension member 7C and an extension member 7D. For example, the extension member 7C may be connected to one side of the second body 87, and the extension member 7D may be connected to the other side of the second body 87.

The extension member 7C may extend or protrude from the second portion 9B of the second body 87 toward the second substrate unit 800, and the extension member 7D may extend or protrude from the third portion 9C of the second body 87 toward the second substrate unit 800. The extension member 7D may be positioned at the opposite side of the extension member 7C with the first substrate 255 (e.g., the first circuit board 250) interposed therebetween.

For example, when the extension member 7A and the extension member 7C are viewed from the front, the extension 7A and the extension member 7C may be left-right symmetrical. In other embodiments, the extension member 7A and the extension member 7C may not be left-right symmetrical.

Also, for example, when the extension member 7B and the extension member 7D are viewed from the front, the extension member 7B and the extension member 7D may be left-right symmetrical. In another embodiment, the extension member 7B and the extension member 7D may not be left-right symmetrical.

For example, the second connection portion 320B may connect the first portion 9A of the second body 87 and the second side portion 33B of the first circuit board 250. The second connection portion 320B may include a bent portion. For example, the second connection portion 320B may connect the central region of the first portion 9A of the second body 87 and the central region of the second side portion 33B of the first circuit board 250.

Referring to FIG. 16, terminals P1 to P4 for conductively connecting terminals B1 to B4 of the terminal portion 95 of the circuit board 190 of the AF driving unit 100 may be formed at the extension member (e.g., 7A, 7C) of the support board 310. The terminals B1 to B4 of the terminal portion 95 of the circuit board 190 and the terminals P1 to P4 of the extension member 7A and 7C of the support board 310 can be conductively connected by solder or conductive adhesive. That is, the circuit board 190 of the AF driving unit 100 can be conductively connected to the second substrate unit 800 through the support board 310.

Referring to FIG. 16, the support board 310 may include a conductive layer 93-1. In addition, the support board 310 may include a first insulating layer 94-1 disposed on one surface (or first surface) or one side of the conductive layer 93-1. In addition, the support board 310 may include a second insulating layer 94-2 disposed on the other surface (or second surface) or the other side of the conductive layer 93-1. For example, in another embodiment, the support board 310 may include at least one of the first insulating layer 94-1 and the second insulating layer 94-2. The support board 310 may include a protection layer 96 disposed on the first insulating layer 94-1. For example, the protection layer 96 may be an EMI member (e.g., an EMI tape). Or, for example, the protection layer 96 may be a heat dissipation member, e.g., graphite. Or, for example, the protection layer 96 may be an elastic material. Or, for example, the protection layer 96 may be a conductive member. Or, for example, the protection layer 96 may be an insulating member.

FIG. 17A is a first perspective view of the support board 310 coupled to the holder 270 and the base 210, and FIG. 17B is a second perspective view of the support board 310 coupled to the holder 270 and the base 210.

Referring to FIGS. 17A and 17B, the holder 270 may include first to fourth side portions 64A to 64D (see FIG. 18A) corresponding to or opposite the first to fourth side portions 33A to 33D of the first circuit board 250.

The first and second side portions 64A and 64B of the holder 270 may be disposed facing or opposite to each other in a second horizontal direction (e.g., in the X-axis direction). In addition, the third and fourth side portions 64C and 64D of the holder 270 may be disposed facing or opposite to each other in the first horizontal direction (e.g., in the Y-axis direction).

At least a portion of the support board 310 may be attached or coupled to the holder 270. For example, at least one connection portion 320A and 320B of the support board 310 may be coupled to at least one of the first to fourth side portions 64A to 64D of the holder 270 by an adhesive. For example, the first connection portion 320A may be coupled, attached, or fixed to the first side portion 64A of the holder 270 by an adhesive, and the second connection portion 320B may be coupled, attached, or fixed to the second side portion 64B of the holder 270.

A first protruding portion 27A may be formed at the first side portion 64A of the holder 270, and a second protruding portion 27B may be formed at the second side portion 64B of the holder 270.

The support board 310 may be coupled, attached, or fixed to the protruding portions 27A and 27B of the holder 270. The support board 310 may be coupled, attached, or fixed to the outer surface (or inner surface) of the protruding portions 27A and 27B of the holder 270.

For example, a portion of the support board 310 may be coupled, attached, or fixed to the first protruding portion 27A and the second protruding portion 27B of the holder 270. The body 86 and 87 of the support board 310 may be coupled, attached, or fixed to the first and second protruding portions 27A and 27B of the holder 270.

For example, the first support board 310-1 may be coupled, attached, or fixed to the first protruding portion 27A, and the second support board 310-2 may be coupled, attached, or fixed to the second protruding portion 27B. For example, the first portion 6A of the first body 86 may be coupled, attached, or fixed to the outer surface (or inner surface) of the first protruding portion 27A, and the first portion 9A of the second body 87 may be coupled, attached, or fixed to the outer surface (or inner surface) of the second protruding portion 27B.

The base 210 may include first to fourth side portions 65A to 65D (see FIG. 14) corresponding to or opposite to the first to fourth side portions 33A to 33D of the first circuit board 250. In addition, the first to fourth side portions 65A to 65D of the base 210 may correspond to or be opposite to the first to fourth side portions 64A to 64D of the holder 270.

The first and second side portions 65A and 65B of the base 210 may be disposed facing or opposite to each other in a first horizontal direction (e.g., in the Y-axis direction). In addition, the third and fourth side portions 65C and 65D of the base 210 may be disposed facing or opposite to each other in a second horizontal direction (e.g., in the X-axis direction).

At least a portion of the support board 310 may be coupled, attached, or fixed to the base 210. For example, the body 86 and 87 of the support board 310 may be coupled to the base 210 by an adhesive. For example, a part of the body 86 and 87 of the support board 310 connected to the extension members 7A to 7D may be coupled with the base 210.

For example, at least a part of the support board 310 may be coupled, attached, or fixed to the protrusion 216A and 216B formed on the base 210. For example, the support board 310 may be coupled, attached, or fixed to an outer surface (or inner surface) of the protrusion 216A and 216B of the base 210. A first protrusion 216A may be formed on the third side portion 65C of the base 210, and a second protrusion 216B may be formed on the fourth side portion 65D of the base 210.

For example, the body 86 and 87 of the support board 310 may be coupled, attached, or fixed to the first and second protrusions 216A and 216B of the base 210.

For example, one end (e.g., the second portion 6B) of the first support board 310-1 may be coupled, attached, or fixed to one region of the first protrusion 216A of the base 210, and the other end (e.g., the third portion 6C) of the first support board 310-1 may be coupled, attached, or fixed to one region of the second protrusion 216B of the base 210.

For example, one end (e.g., the second portion 9B) of the second support board 310-2 may be coupled, attached, or fixed to another region of the first protrusion 216A of the base 210, and the other end (e.g., the third portion 9C) of the second support board 310-2 may be coupled, attached, or fixed to another region of the second protrusion 216B of the base 210.

A first bonding region 69A may be formed between the first body 86 of the first support board 310-1 and the first protrusion 27A of the holder 270, and a second bonding region 69B may be formed between the second body 87 of the second support board 310-2 and the second protrusion 27B of the holder 270.

In addition, a third bonding region 59A may be formed between one end of each of the first and second support boards 310-1 and 310-2 and the first protrusion 216A of the base 210. A fourth bonding region 59B may be formed between the other end of each of the first and second support boards 310-1 and 310-2 and the second protrusion 216B of the base 210.

By the support board 310 and the first to fourth bonding the regions 69A, 69B, 59A, and 59B, the OIS moving unit can be elastically supported with respect to the stationary unit. The terminals 311 of the support board 310 can be coupled to the terminals 800B of the second substrate unit 800 by solder 902 (see FIGS. 17A and 17B) or conductive adhesive, and can be conductively or electrically connected to the terminals 800B of the second substrate unit 800.

For example, in another embodiment, the support member may be an elastic member that does not include the substrate, such as a spring, a wire, a shape memory alloy, or a ball member. For example, when the support member is formed of wires, a plurality of wires may be disposed at the base 210 or at least one of the corners and side portions of the second substrate unit 800, and may connect the first substrate unit 255 (e.g., the second circuit board 260) and the second substrate unit 800 (or the base 210) to each other. For example, one end of each of the plurality of wires may be coupled to the first substrate unit 255 (e.g., the second circuit board 260), and the other end of each of the plurality of wires may be coupled to the second substrate unit 800 (or the base 210).

The image sensor unit 350 may include at least one of the controller 830, a memory 512, and a capacitor 514.

The controller 830 may be disposed to be spaced apart from the first substrate unit 255. For example, the controller 830 may be disposed at the second substrate unit 800.

The memory 512 may be disposed at any one of the first substrate unit 255 or the second substrate unit 800. For example, the memory 512 may be disposed or mounted on the first region 801 of the second substrate unit 800. For example, the memory 512 may be spatially avoided or separated from the heat dissipation member 380. For example, the heat dissipation member 380 may include an escape groove or an opening to avoid spatial interference with the memory 512, and the memory 512 may be disposed within the escape groove or the opening of the heat dissipation member 380. The capacitor 514 may be disposed at at least one of the first substrate unit 255 and the second substrate unit 800.

The memory 512 may store a first data value (or code value) corresponding to the output of the second position sensor 240 according to the displacement (or stroke) of the OIS moving unit in a direction perpendicular to the optical axis (e.g., in the X-axis direction or the Y-axis direction) for OIS feedback driving. In addition, the memory 512 may store a second data value (or code value) corresponding to the output of the first position sensor 170 according to the displacement (or stroke) of the bobbin 110 in a first direction (e.g., in the optical axis direction or the Z-axis direction) for AF feedback driving.

For example, each of the first and second data values can be stored in the memory 512 in the form of a lookup table. Or, each of the first and second data values can be stored in the memory 512 in the form of a mathematical formula or an algorithm. In addition, the memory 512 can store a mathematical formula, an algorithm, or a program for the operation of the controller 830. For example, the memory 512 can be a nonvolatile memory, such as Electrically Erasable Programmable Read-Only Memory (EEPROM).

The controller 830 can be positioned at the outside of the cover member 300 or can be disposed at an region of the second substrate unit 800 located outside the cover member 300.

Referring to FIG. 20A, the second substrate unit 800 may include an extension region 808 connected to the first region 801 and extending from the first region 801. The extension region 808 may extend from the first side portion 85A of the first region 801. For example, the extension region 808 may protrude from an outer surface of the first side portion 85A of the first region. For example, the extension region 808 may extend or protrude in a second horizontal direction (e.g., in the X-axis direction).

The extension region 808 may be located on the outer side of the cover member 300 or outside the cover member 300.

The extension region 808 may also be expressed as a “fourth region,” a “protruding region,” an “extended portion,” or a “protruding portion.” The extension region 808 does not overlap with the AF moving portion and the OIS moving unit in the optical axis direction. For example, the extension region 808 may extend in the same direction as the third region 803 (e.g., the second horizontal direction).

The controller 830 may be disposed at the extension region 808 of the second substrate unit 800. For example, the controller 830 may be disposed or mounted on an upper surface of the extension region 808 of the second substrate unit 800. In another embodiment, the controller 830 may be disposed or mounted on a lower surface of the extension region 808. For example, the controller 830 may not overlap with the cover member 300 in the optical axis direction. Also, for example, the extension region 808 may not overlap with the cover member 300 in the optical axis direction. For example, an area of the upper surface of the extension region 808 may be greater than or equal to an area of a lower surface of the controller 830.

Since the extension region 808 and the third region 803 are connected to the first side portion 85A of the second substrate unit 800, the area occupied by the camera device 10 in the direction perpendicular to the optical axis can be reduced. Accordingly, the embodiment can minimize the increase in the size of the camera device 10 due to the extension region 808.

In another embodiment, the extension region may be connected to any one of the second to fourth side portions 85B, 85C, and 85D of the first region 801 of the second substrate unit 800, or may protrude from any one of the second to fourth side portions 85B, 85C, and 85D of the first region 801.

The controller 830 may be located on the outside of the cover member 300 or may be located outside the cover member 300. For example, the controller 830 may be located on the outside of a space formed by the cover member 300, the base 210, and the first region 801 of the second substrate unit 800.

For example, the controller 830 does not overlap with the lens module 400, the AF moving unit, the OIS moving unit, and the first region 801 of the second substrate unit 800 in the optical axis direction. At least one capacitor 514 may be disposed or mounted on the upper surface of the extension region 808.

In a sensor shift camera device in which an image sensor moves for image shake correction, since the OIS moving unit including the image sensor and the first substrate unit is disposed apart from the stationary unit including the second substrate unit, the heat generated in the OIS moving unit may be vulnerable to being discharged to the outside through the stationary unit. In addition, in the sensor shift camera device, the AF driving unit and the OIS driving unit may be structured to be trapped in the cover member for the purpose of inhibiting foreign matter defects, and thus, heat may not be easily released outside the camera device.

The image sensor, the second coil, and the controller may correspond to heat sources. Here, the “controller” may be a driver IC that controls the AF driving or/and the OIS driving.

The camera device 10 may include a heat dissipation member 870 that is disposed on, coupled to, or attached to the extension region 808 to improve the heat dissipation effect. The heat dissipation member 870 may be in contact with the extension region 808. For example, the heat dissipation member 870 may be disposed under the extension region 808. For example, the heat dissipation member 870 may be disposed on, coupled to, or fixed to the lower surface of the extension region 808. The heat dissipation member 870 may be a plate-shaped member, and the description of the material of the heat dissipation member 280 may be applied or analogically applied to the heat dissipation member 870. At least a portion of the heat dissipation member 870 may overlap the controller 830 in the optical axis direction.

The camera device 10 may include a cover can 405 disposed on the extension region 808 and accommodating the controller 830 inside in order to protect the controller 830 from external impact. The cover can 405 may include a top plate 405A and a side plate 405B connected to the top plate 405A and extending from the top plate 405A toward the extension region 808.

The cover can 405 may be disposed on, coupled to, or fixed to the upper surface of the extension region 808. For example, a lower portion, lower end, or lower surface of the side plate 405B of the cover can 405 may be coupled, attached, or fixed to the upper surface of the extension region 808.

Since the cover can 405 accommodate the controller 830 inside, heat generated from the controller 830 may be suppressed from being emitted outside the cover can 405 and transferred to the image sensor. The description of the material of the heat dissipation member 280 or the material of the cover member 300 may be applied or analogically applied to the cover can 405.

The camera device 10 may further include a heat dissipation layer 860 disposed on the controller 830. The heat dissipation layer 860 may cover a surface of the controller 830. For example, the heat dissipation layer 860 may be disposed to surround the surface of the controller 830. For example, the heat dissipation layer 860 can contact and surround the upper surface and side surfaces of the controller 830. The heat dissipation layer 860 can be formed of a heat dissipation plastic or a heat dissipation resin, for example, a heat dissipation epoxy. The heat dissipation layer 860 can improve the heat dissipation efficiency and heat dissipation performance of the controller 830.

In another embodiment, the heat dissipation layer can be disposed on at least one of the upper surface and side surfaces of the controller 830. For example, the heat dissipation layer can expose at least a portion of the controller 830.

The controller 830 can be conductively connected to the second position sensor 240. The controller 830 can adjust or control the driving signal provided to the second coil 230 using the output signal received from the sensors 240A, 240B, and 240C of the second position sensor 240 and the first data value stored in the memory 512, and perform a feedback OIS operation.

In addition, the controller 830 can be conductively connected to the first position sensor 170. For example, when the first position sensor 170 is implemented as a Hall sensor alone, the first position sensor 170 can be conductively connected to the controller 830. At this time, the controller 830 can control the driving signal provided to the first coil 120 using the output signal of the first position sensor 170 and the second data value stored in the memory 512, and perform a feedback auto-focusing operation through this.

The controller 830 can be implemented in the form of a driver IC, but is not limited thereto. For example, the controller 830 may be conductively connected to the terminals 800B of the second substrate unit 800.

The controller 830 may control the first position sensor implemented with only a Hall sensor and/or the second position sensor implemented with only a Hall sensor. For example, the controller 830 may supply a driving signal to the first position sensor implemented with only a Hall sensor and/or the second position sensor implemented with only a Hall sensor, and may receive an output signal of the first position sensor and/or an output signal of the second position sensor.

In another embodiment, the first position sensor may be implemented with only a Hall sensor, and the second position sensor may be in the form of a driver IC including a Hall sensor, and in this case, the controller 830 may be conductively connected to the first position sensor, supply a driving signal to the first position sensor, and receive an output signal from the first position sensor.

For example, the controller 830 may include a driving driver for driving at least one of the first position sensor and the second position sensor.

The image sensor unit 350 may further include a motion sensor (not shown) disposed at one of the first substrate unit 255 and the second substrate unit 800. The motion sensor may be conductively connected to the controller 830. The motion sensor may output rotational angular velocity information due to the movement of the camera device 10. For example, the motion sensor may be implemented as a two-axis or three-axis gyro sensor or an angular velocity sensor. For example, the motion sensor may output information on the amount of movement in the X-axis direction, the amount of movement in the Y-axis direction, and the amount of rotation due to the movement of the camera device 10.

In another embodiment, the motion sensor may be omitted from the camera device 10, and when the motion sensor is omitted from the camera device, the camera device 10 may receive positional information due to the movement of the camera device 10 from a motion sensor provided in the optical device 200A.

The image sensor unit 350 may further include a filter 610 disposed between the lens module 400 and the image sensor 810. In addition, the image sensor unit 350 may further include a filter holder 600 for arranging, settling, or accommodating the filter. The filter holder 600 may be expressed as a “sensor base”.

The filter 610 may block or allow a specific frequency band of a light passing through the lens barrel 400 from passing through or entering the image sensor 810. For example, the filter 610 may be an infrared cut filter. For example, the filter 610 may be disposed parallel to an x-y plane perpendicular to the optical axis OA. The filter 610 may be disposed under the lens module 400.

The filter holder 600 may be disposed under the AF driving unit 100. For example, the filter holder 600 may be arranged on the first substrate unit 255. For example, the filter holder 600 may be disposed on the upper surface of the second circuit board 260 of the first substrate unit 255.

The filter holder 600 may be bonded to a portion of the second circuit board 260 around the image sensor 810 by an adhesive, and may be exposed by an opening 250A of the first circuit board 250. For example, the opening 250A of the first circuit board 250 may expose the filter holder 600 disposed on the second circuit board 260 and the filter 610 disposed on the filter holder 600. The filter holder 600 may have an opening 61A formed at a portion where the filter 610 is mounted or disposed so that light passing through the filter 610 may be incident on the image sensor 810. The opening 61A of the filter holder 600 may be in the form of a through hole penetrating the filter holder 600 in the optical axis direction. For example, the opening 61A of the filter holder 600 may penetrate the center of the filter holder 600 and may be disposed to correspond to or face the image sensor 810.

The filter holder 600 may have a seating portion 500 that is depressed from the upper surface thereof and on which the filter 610 is mounted, and the filter 610 may be disposed, seated, or mounted on the seating portion 500. The seating portion 500 may be formed to surround the opening 61A. In another embodiment, the seating portion of the filter holder may be in the form of a protrusion that protrudes from the upper surface of the filter.

The image sensor unit 350 may further include an adhesive disposed between the filter 610 and the seating portion 500, and the filter 610 may be coupled or attached to the filter holder 600 by the adhesive.

In another embodiment, the filter holder may be coupled to the holder 270 or may be coupled to the AF driving unit 100.

Referring to FIG. 3, the cover member 300 may be a box-shaped with a bottom open and include an upper plate 301 and a side plate 302. For example, the side plate 302 may be connected to the upper plate 301. For example, the side plate 302 may extend downward from the upper plate 301.

A lower portion of the side plate 302 of the cover member 300 may be coupled to the base 210. The shape of the upper plate 301 of the cover member 300 may be a polygon, for example, a quadrangle or an octagon. For example, the side plate 302 may include four side plates that are connected to each other. An opening 303 may be formed on the upper plate 301 of the cover member 300 to expose the lens of the lens module 400 coupled with the bobbin 110 to external light.

Referring to FIG. 1 and FIG. 3, a groove 304 may be formed on the side plate 302 of the cover member 300 to expose the terminal 95 of the circuit board 190 and the terminal 800B of the second substrate unit corresponding thereto.

For example, the cover member 300 may be formed of a metal material. For example, the cover member 300 may be formed of SUS (Steel Use Stainless) (e.g., SUS 4 series). In addition, the cover member 300 may be formed of Steel Plate Cold Commercial (SPC). For example, the cover member 300 may be formed of SUS material containing 50 percent ([%)) or more of Fe. In addition, for example, a surface of the cover member 300 may be plated with an anti-oxidation metal, for example, nickel, to inhibit oxidation. In addition, for example, in another embodiment, the cover member 300 may be formed of a magnetic material or a metal material having magnetism.

In another embodiment, the cover member 300 may be formed of an injection-molded material, for example, a plastic or resin material. In addition, the cover member 300 may be made of an insulating material or a material that blocks electromagnetic waves.

The cover member 300 and the base 210 may accommodate the AF driving unit 100 and the OIS moving unit, protect the AF driving unit 100 and the OIS moving unit from external impact, and inhibit foreign substances from entering from the outside.

For example, at the initial position of the OIS moving unit, an outer surface of the holder 270 may be spaced apart from an inner surface of the base 210 by a preset distance. Also, for example, at the initial position of the OIS moving unit, the lower surface of the holder 270 and the first substrate unit 255 may be spaced apart from the base 210 by a preset distance.

The controller 830 may supply at least one driving signal to at least one of the first to fourth coil units 230-1 to 230-4, and may move the OIS moving unit in the X-axis direction and/or the Y-axis direction by controlling the at least one driving signal, or may rotate, tilt, or roll the OIS moving unit within a preset angular range around the optical axis.

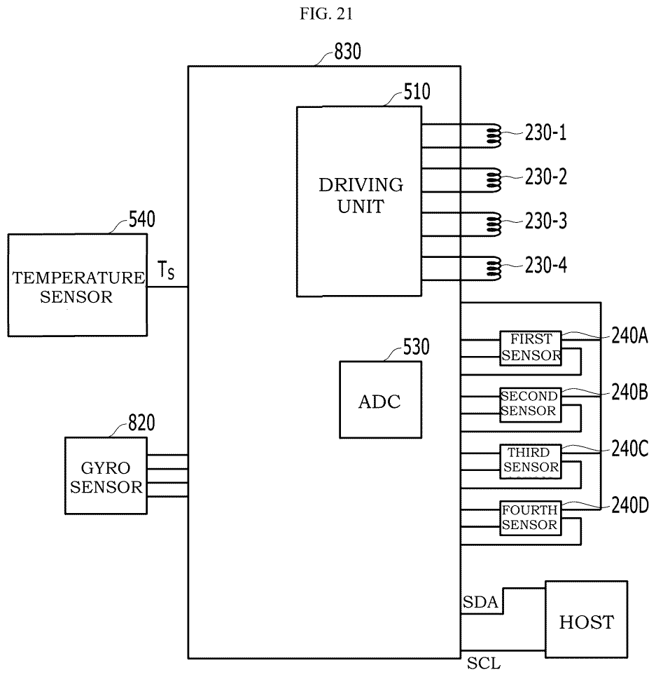

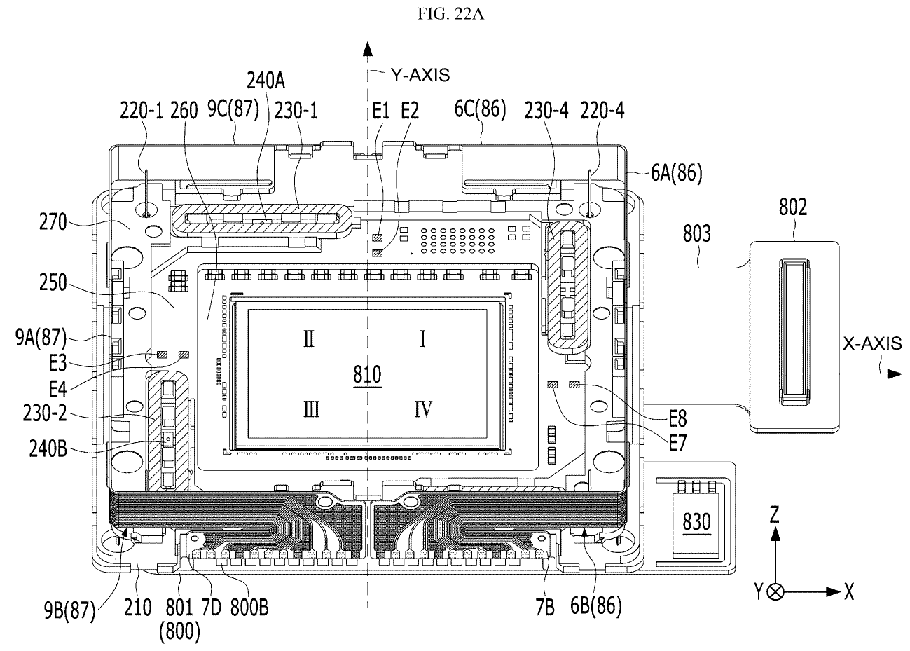

FIG. 21 shows a block diagram of the configuration of the controller 830 and the first to third sensors 240A, 240B, and 240C. The controller 830 may perform communication, such as I2C communication, for exchanging data with the host using a clock signal (SCL) and a data signal (SDA). For example, the host may be the controller 780 of the optical device 200A.

The controller 830 may be conductively connected to the second coil 230. The controller 830 may include a driving unit 510 for providing a driving signal for driving the first to fourth coil units 230-1 to 230-4. For example, the driving unit 510 may include an H bridge circuit or an H bridge driver that may change the polarity of the driving signal. At this time, the driving signal may be a PWM signal to reduce the consumption current, and the driving frequency of the PWM signal may be 20 [KHz] or more, which is outside the audible frequency range. In another embodiment, the driving signal may be a DC signal.

Each of the first to third sensors 240A to 240C may include two input terminals and two output terminals. The controller 830 may supply power or a driving signal to the two input terminals of each of the first to third sensors 240A to 240C. For example, one of the two input terminals of the first to third sensors 240A to 240C may be commonly connected to each other. For example, the two input terminals may be a (+) input terminal and a (−) input terminal (e.g., a ground terminal).

For example, the controller 830 may receive the first output voltage of the first sensor 240A, the second output voltage of the second sensor 240B, and the third output voltage of the third sensor 240C, and control the movement (or displacement) of the OIS moving unit in the X-axis direction or the Y-axis direction using the received first to third output voltages. In addition, the controller 830 can control rotation, tilting, or rolling of the OIS moving unit based on the optical axis using the received first to third output voltages.

In addition, the controller 830 can include an analog-to-digital converter 530 that receives output voltages output from two output terminals of each of the first to third sensors 240A to 240C and outputs data values, digital values, or code values according to the results of analog-to-digital conversion of the received output voltages. The controller 830 can control the movement (or displacement) of the OIS moving unit in the X-axis or Y-axis direction or the rotation, tilting, or rolling of the OIS moving unit based on the optical axis using the data values output from the analog-to-digital converter 530.

The temperature sensor 540 can measure the ambient temperature (e.g., temperature of the first to third sensors 240A, 240B, and 240C) and output a temperature detection signal Ts according to the measured result. For example, the temperature sensor 540 can be a thermistor.

The resistance value of the resistor included in the temperature sensor 540 can change depending on the ambient temperature, and thus, value of the temperature detection signal Ts can change depending on the ambient temperature. Through calibration, a mathematical formula or lookup table regarding the relationship between the ambient temperature and the temperature detection signal Ts can be stored in the memory or the controller 830 or 780.

Since the output values of the first to third sensors 240A, 240B, and 240C are also affected by the temperature, compensation of the output values of the first to third sensors 240A, 240B, and 240C according to the ambient temperature is necessary for accurate and reliable OIS feedback operation.

For this purpose, for example, the controller 830 or 780 can compensate the output value (or data value regarding the output) of each of the first to third sensors 240A, 240B, and 240C using the ambient temperature measured by the temperature sensor 540 and the temperature compensation algorithm or compensation formula. The temperature compensation algorithm or compensation formula can be stored in the controller 830 or 780 or the memory.

The camera device may further include a fourth sensor 240D corresponding to or opposite the fourth magnet unit 130-4 in the optical axis direction. The fourth sensor 240D may be disposed on the first substrate unit 255 (e.g., the first circuit board 250). For example, the fourth sensor 240D may be disposed adjacent to any corner of the first circuit board 250 where the first to third sensors 240A to 240C are not disposed. The description of the arrangement relationship between the first sensor 240A and the first coil unit 230-1 may be applied or analogically applied to the arrangement between the fourth sensor 240D and the fourth coil unit 230-4.

For example, the fourth sensor 240D may be positioned to be diagonally opposite to the second sensor 240B. For example, the output voltage of the fourth sensor 240D may be used to detect the X-axis movement or the Y-axis movement of the OIS moving unit.

In another embodiment, the fourth sensor 240D may represent the first position sensor 170 of the AF driving unit 100.

The controller 830 may be conductively connected to at least one of the first position sensor 170, the second coil 230, and the second position sensor 240 through the second substrate unit 800, the support board 310, and the first substrate unit 255.

In another embodiment, the controller 830 may be disposed on the first substrate unit 255. For example, in another embodiment, the controller 830 may be disposed on the first circuit board 250.

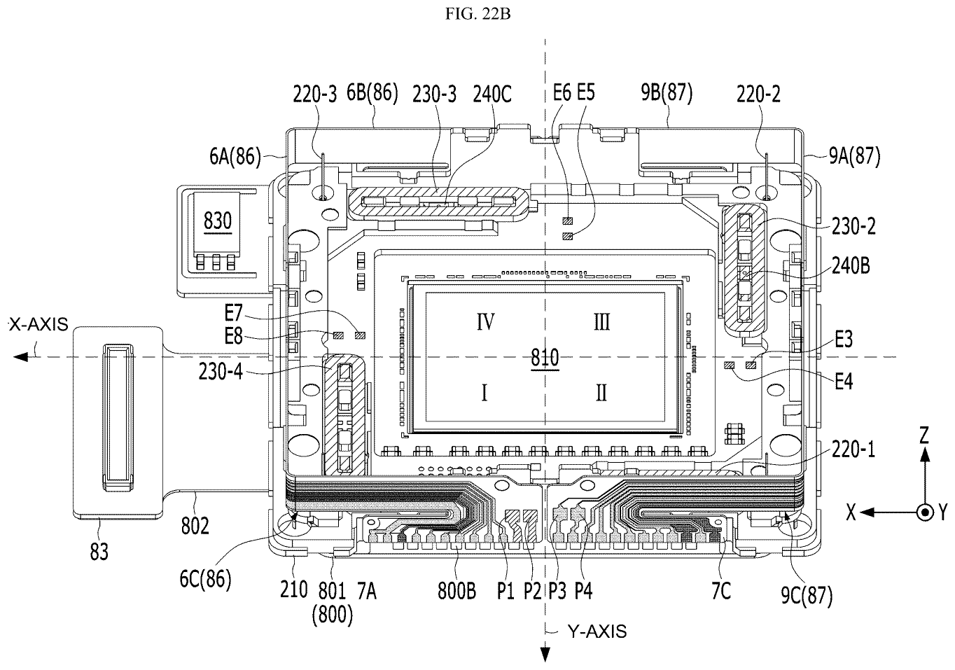

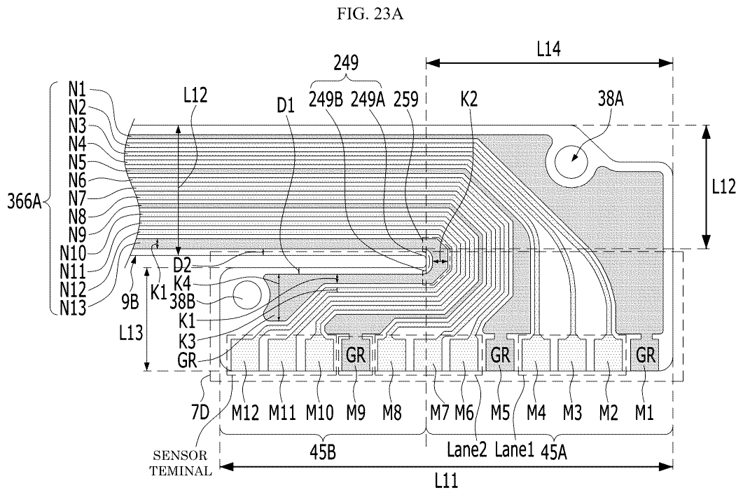

FIG. 22A shows a conductive pattern of two adjacent extension members 7B and 7D of FIG. 17A, FIG. 22B shows a conductive pattern of two adjacent extension members 7A and 7C of FIG. 17B, FIG. 23A is an enlarged view of the extension member 7D of FIG. 22A, FIG. 23B is an enlarged view of the extension member 7B of FIG. 22A, FIG. 23C is an enlarged view of the extension member 7A of FIG. 22B, and FIG. 23D is an enlarged view of the extension member 7C of FIG. 22B.

Referring to FIGS. 22A to 23D, the extension members 7A to 7D may extend from the body 86 and 87 toward the second substrate unit 800. For example, the extension members 7A to 7D may extend in a first direction from the body 86 and 87. In addition, the extension members 7A to 7D may be extended in the second horizontal direction (X-axis direction).

Referring to FIG. 22A, the two extension members 7D and 7B may be symmetrical from left to right when the two extension members 7D and 7B are viewed from the front. For example, the two extension members 7D and 7B may be symmetrical from left to right with respect to a straight line that is parallel to the optical axis and passes through a midpoint between the two extension members 7D and 7B.

Referring to FIG. 22B, the other two extension members 7A and 7C may be symmetrical from left to right when the two extension members 7A and 7C are viewed from the front. For example, the other two extension members 7A and 7C may be symmetrical from left to right with respect to a straight line that is parallel to the optical axis and passes through a midpoint between the two other two extension members 7A and 7C.

Referring to FIG. 23A, the extension member 7D may include a first extension portion 45A (or a first portion) extending in a direction from the body 86 and 87 toward the second substrate unit 800 and a second extension portion 45B (or a second portion) extending in a direction different from the extension direction of the first extension portion.

For example, the first extension portion 45A may extend in a first direction (e.g., in the Z-axis direction). For example, the second extension portion 45B may extend in a second horizontal direction (e.g., in the X-axis direction). For example, the second extension portion 45B may extend in a leftward or rightward direction with respect to one end of the body 86 and 87 or a center line. Here, the center line may be an imaginary straight line passing through the midpoint between two adjacent extension members (e.g., 7D and 7D, or 7A and 7C).

For example, the second extension portion 45B may extend to the left or right from the first extension portion 45A. When viewed from the front, an overall shape of the extension member 7D may be an L-shape (“^{└}”) or a shape (“^{┘}”) that is symmetrical to the left and right of the L-shape (“^{└}”).

The horizontal length L11 of the extension member 7D may be greater than the vertical length L13 of the extension member 7D (L11>L13). This is to facilitate the disposition or arrangement of terminals in the second horizontal direction.

For example, the horizontal length L14 of the first extension portion 45A may be greater than the length L12 of the body 86 and 87 in the first direction. In other embodiments, L14 may be less than or equal to L12. For example, the horizontal direction of the extension member 7D may be the second horizontal direction (X-axis direction), and the vertical direction of the extension member 7D may be the first direction (e.g., Z-axis direction) which is the optical axis direction.

For example, the vertical length L13 of the extension member 7D may be smaller than the horizontal length L14 of the first extension portion 45A. In another embodiment, L13 may be larger than or equal to L14.

For example, a separation distance D2 between the body 86 and 87 and the extension member 7D in the first direction may be smaller than the vertical length L13 of the extension member 7D. This is to secure the length L13 of the extension member 7D for disposing the wirings N1 to N13.

The extension member 7D may include a first hole 38A formed in the body 86 and 87 and a second hole 38B formed in the extension member 7D. The first hole 38A may be positioned adjacent to a portion where the body 86 and 87 and the extension member 7D are connected, and the second hole 38B may be formed adjacent to an end of the extension member 7D or an end of a wiring N13 described later. For example, each of the first and second holes 38A and 38B may be a through hole.

The first hole 38A may be coupled with a protrusion 49A of the base 210. For example, an adhesive may be injected into the first hole 38A to couple the base 210 and the body 86 and 87. The second hole 38B may be combined with the protrusion 49B of the base 210. For example, an adhesive may be injected into the second hole 38B to couple the base 210 and the extension member. In another embodiment, the protrusions 49A and 49B of the base 210 may be omitted, and the first and second holes 38A, and 38B may be holes for injecting an adhesive for combining the base 210 and the body 86 and 87 and the extension member 7D. In another embodiment, at least one of the first hole 38A and the second hole 38B may be omitted.

In another embodiment, for example, an adhesive may be injected into the first and second holes 38A and 38B to couple the base 210 and the body 86 and 87 and the extension member 7D.

The support board 310 may include a bent region 249. For example, the support board 310 may include the bent region 249 that is bent from the body 86 and 87. For example, the support board 310 may include the bent region 249 formed between the body 86 and 87 and the extension members 7A to 7D. Or, for example, the support board 310 may include the bent region formed at the extension members 7A to 7D.

For example, at least one extension member of the support board 310 may include the bent region 249. For example, each of the extension members 7A to 7D may include the bent region 249.

The bent region 249 may be expressed as a “curved portion,” a “bent portion,” or a “rounded portion.” In addition, the bent region 249 may be expressed as a narrow region (or “first region”) in the support board 310. In addition, the bent region 249 may be expressed as a neck portion.

The bent region 249 may be formed at a portion where the body 86 and 87 and the extension members 7A to 7D meet. Or, for example, the bent region 249 may include a first bent region 249A formed between the body 86 and 87 and the first extension portion 45A of the extension members 7A to 7D. In addition, the bent region 249 may include a second bent region 249B formed between the first extension portion 45A and the second extension portion 45B. In other embodiments, three or more bent regions may be formed.

Each of the extension members 7A to 7D may include a plurality of terminals 311 (see FIG. 16). For example, the plurality of terminals 311 may be disposed at a lower end or lower surface of the extension members 7A to 7D. For example, the plurality of terminals 311 may be disposed to contact the lower end or lower surface of the extension members 7A to 7D. For example, the plurality of terminals 311 may be disposed or arranged to be spaced apart from each other in the second horizontal direction (e.g., in the X-axis direction).

The support board 310 may include wirings connecting the plurality of terminals of the extension members 7A to 7D and the first substrate unit 255 (e.g., the first circuit board 250). For example, the wirings may be formed in the body 86 and 87 and the extension members 7A to 7D.

Referring to FIG. 23A, the support board 310 may include a conductive pattern 366A connecting a plurality of terminals (e.g., M1 to M12) of the extension member 7D and the first substrate unit 255 (e.g., the first circuit board 250). For example, the conductive pattern 366A may include a plurality of wirings N1 to N13. In addition, for example, the conductive pattern 366A may further include a plurality of terminals M1 to M12.

For example, the term “wiring” may be expressed as “conductive layer,” “conductive line,” “conductive pattern,” or “circuit pattern.” For example, the plurality of wirings N1 to N13 may be formed at the body 86 and 87 and the extension member 7D.

For example, each of the plurality of terminals (e.g., M1 to M12) may be connected to a corresponding one of the plurality of wirings N1 to N12. One of the plurality of wirings N1 to N13 (e.g., N13) may not be connected to the terminals of the extension member 7D.

The plurality of wirings N1 to N13 may include at least one ground wiring, and a plurality of signal wirings. For example, the signal wiring may be a wiring that is conductively connected to the second position sensor 240, the second coil 230, or the image sensor 810. For example, the signal wiring may include a wiring for a signal supplied to the second position sensor 240 or a signal output from the second position sensor. For example, the signal wiring may include a wiring for a driving signal (e.g., a driving current) supplied to the second coil 230. In addition, for example, the signal wiring may include a wiring for supplying power related to the image sensor 810 or/and a wiring for a data signal, a control signal, or other signals related to the image sensor 810. For example, the data signal related to the image sensor 810 may be a signal used in a communication protocol. For example, the communication protocol may be a mobile protocol, such as Mobile Industry Processor Interface (MIPI).

For example, the plurality of wirings N1 to N13 may include a plurality of ground wirings and a plurality of signal wirings. For example, at least one of one or more signal wirings and one or more ground wirings may be disposed between the wiring (e.g., N13) closest to the bent region 249 and the wiring N1 farthest from the bent region 249. When the bent region 249 is expressed as a neck portion, N13 may be the wiring closest to one side or one end of the neck portion 249. The one side or the one end of the neck portion 249 may be a point of the neck portion 249 closest to the second extension portion 45B when the neck portion 249 is viewed at front side.

For example, a predetermined number of signal wirings and one ground wiring may be repeatedly disposed at least once. For example, the predetermined number may be two or more. For example, in FIG. 23A, the predetermined number may be three.

Among the plurality of wirings N1 to N13, the wiring N13 closest to the bent region 249 may be a ground wiring. The ground wiring may be a wiring that is conductively or electrically connected to the ground (or ground power) of the image sensor 810 or/and the ground (or ground power) of the first substrate unit 255.

For example, among the plurality of wirings N1 to N13, the wiring (e.g., N1) farthest from the bent region 249 may be a ground wiring. For example, the wiring N1 may be connected to the ground of the image sensor 810 or the ground of the first substrate unit 255. Or, for example, the wiring N1 may be conductively or electrically connected to the ground of the first substrate unit 255.

In FIG. 23A, the wiring N1 may be in a form that is avoided from the first hole 38A, and the wiring N13 may be in a form that is avoided from the second hole 38B. In an embodiment where at least one of the first hole 38A and the second hole 38B is omitted, a portion of the wiring N1 may be filled in a region that the first hole 38A is omitted, and a portion of the wiring N13 may be filled in a region that the second hole 38B is omitted.

At least one signal wiring may be disposed between the wiring N13 closest to the bent region 249 and the wiring (e.g., N1) farthest from the bent region 249.

For example, among the plurality of wirings N1 to N13, the width K1 or K2 of the wiring N13 closest to the bent region 249 may be larger than the width K3 of the wiring N12 secondly closest to the bent region 249 (K1, K2>K3). For example, the width may be the line width of the wiring.

The wiring N13 closest to the bent region 249 may include a bent region 259. The bent region 259 of the wiring N13 may have a shape corresponding to the bent region 249 of the support board. The bent region 259 of the wiring N13 may be disposed at a position corresponding to the bent region 249 of the support board 310.

For example, the bent region 259 may be expressed as a “curved portion,” a “bent portion,” or a “rounded portion.”

For example, the width K4 of the end of the wiring N13 closest to the bent region 249 may be larger than the widths K1 and K2 of other parts of the wiring N13.

For example, the wiring N1 positioned farthest from the bent region 249 may include a portion having a width larger than that of the wiring N13 closest to the bent region 249. For example, the wiring N1 positioned farthest from the bent region 249 may include a portion having a width larger than that of the wiring N12 secondly closest to the bent region 249. For example, the wiring N1 positioned farthest from the bent region 249 may include a portion having a width larger than those of the remaining wirings N2 to N13.

At least a portion of the bent region 259 of the wiring N13 closest to the bent region 249 may have a width greater than that of another portion of the wiring N13 excluding the bent region 259 or may include a portion having a width greater than that of another portion of the wiring N13.

For example, the width K2 of the bent region 259 of the wiring N13 closest to the bent region 249 may be greater than the width K1 of the wiring N13 formed in the body 86 and 87. In other embodiments, K2 and K1 may be equal to each other. Also, for example, the width K2 of the bent region 259 of the wiring N13 may be greater than the width of a portion of the wiring N13 formed in the second extension portion 45B of the extension member 7D. In another embodiment, the width K2 of the bent region 259 of the wiring N13 may be equal to the width of a portion of the wiring N13 formed in the second extension portion 45B of the extension member 7D.

For example, signal wirings N2 to N4, N6 to N8, and N10 to N12 may be disposed or positioned between the ground wirings N1 and N13.

For example, the width K1 of the wiring N13 formed in the extension member 7D may be larger than the width of the signal wirings N2 to N4, N6 to N8, and N10 to N12. In another embodiment, for example, the width K1 of the wiring N13 formed in the extension member 7D may be smaller than or equal to the width of the signal wirings N2 to N4, N6 to N8, and N10 to N12.

Also, for example, the width of the wiring N1 formed in the extension member 7D may be larger than the width of the signal wiring N2 to N4, N6 to N8, and N10 to N12.

For example, the ground wiring N5 and N9 formed in the extension member 7D may include a portion having a width larger than the width of the signal wiring N2 to N4, N6 to N8, and N10 to N12.

Referring to FIG. 23B, the extension member 7B may include a first extension portion 45A (or first portion) extending in a first direction and a second extension portion 45B (or second portion) extending in a second horizontal direction (e.g., X-axis direction).

The extension member 7B may include a plurality of terminals G1 to G12. The support board 310 may include a conductive pattern 366B that connects a plurality of terminals G1 to G12 of the extension member 7B and the first substrate unit 255 (e.g., the first circuit board 250). For example, the conductive pattern 366B may include a plurality of wirings Q1 to Q13. For example, the conductive pattern 366B may further include a plurality of terminals G1 to G12.

The extension member 7B may include a first extension portion 45A (or first portion) extending in a first direction and a second extension portion 45B (or second portion) extending in a second horizontal direction (e.g., X-axis direction). The second extension portion 45B of the extension member 7B and the extension portion of the extension member 7D may extend in opposite directions.

The description of the extension member 7D in FIG. 23A may be applied or analogically applied to the extension member 7B of FIG. 23B.

Referring to FIG. 23C, the extension member 7A may include a bent region 249. The extension member 7A may include a plurality of terminals R1 to R12. The support board 310 may include a conductive pattern 366C connecting the plurality of terminals R1 to R12 of the extension member 7A and the first substrate unit 255 (e.g., the first circuit board 250). For example, the conductive pattern 366C may include a plurality of wirings S1 to S9. In addition, for example, the conductive pattern 366C may further include a plurality of terminals R11 to R12. Also, for example, the conductive pattern 366C may further include terminals P1 and P2 and wirings S11 and S12.

For example, a plurality of wirings S1 to S9 may be connected to corresponding terminals among a plurality of terminals (e.g., R1 to R12).

The extension member 7A may include two terminals P1 and P2 for conductively connecting to the terminals B1 and B2 of the terminal portion 95 of the circuit board 190. The terminals P1 and P2 may be disposed above the plurality of terminals R1 to R12 of the extension member. For example, the terminals P1 and P2 may be disposed above the two terminals R1 and R2.

The extension member 7A may include a wiring S11 connecting the terminal P1 and the terminal R1 and a wiring S12 connecting the terminal P2 and the terminal R2.

The plurality of wirings S1 to S9 may include at least one ground wiring (e.g., S8) and a plurality of signal wirings S1 to S7 and S9.

Among the plurality of wirings S1 to S9, the wiring S9 closest to the bent region 249 may be a power wiring for supplying power to the image sensor 810. For example, S9 may be a wiring for supplying a preset voltage VDD. For example, the preset voltage VDD may be a voltage different from the voltage of the ground. For example, the preset voltage may be higher than the voltage of the ground.

For example, the secondly closest wiring S8 to the bent region 249 may be a ground wiring. In another embodiment, the secondly closest wiring S8 to the bent region 249 may be a signal wiring.

The wiring S9 closest to the bent region 249 may be commonly connected to two terminals R11 and R12. For example, the two terminals R11 and R12 of the extension member 7A may be power terminals for supplying power to the image sensor 810. This is to reduce a contact resistance occurring at the terminal portion because the current consumption due to the voltage supplied to the image sensor 810 is large.

For example, among the plurality of wirings S1 to S9, the width K5 or K6 of the wiring S9 closest to the bent region 249 may be larger than the width K7 of the wiring S8 secondly closest to the bent region 249 (K5, K6>K7).

The wiring S9 closest to the bent region 249 of the extension member 7A may include the bent region 259. For example, the width of the end of the wiring S9 closest to the bent region 249 of the extension member 7A may be larger than the width K5 or K6 of the other part of the wiring S9.

For example, the width K6 of the bent region 259 of the wiring S9 closest to the bent region 249 of the extension member 7A may be larger than the width K5 of the wiring S9 formed in the body 86 and 87. In another embodiment, K5 and K6 may be equal to each other. Also, for example, the width K6 of the bent region 259 of the wiring S9 may be larger than the width of a portion of the wiring S9 formed in the second extension portion 45B of the extension member 7A. In another embodiment, the width K6 of the bent region 259 of the wiring S9 may be equal to the width of a portion of the wiring S9 formed in the second extension portion 45B of the extension member 7A.

For example, the extension member 7A may include signal wirings S3 to S7. For example, the width K5 of the wiring S9 formed in the extension member 7A may be larger than the width K8 of the signal wirings S3 to S7. Also, for example, the width K9 of the wirings S11 and S12 formed in the extension member 7A may be larger than the width K8 of the signal wirings S3 to S7. In other embodiments, K9 may be equal to or smaller than K8.

The description of the extension member 7D in FIG. 23A may be applied or analogically applied to the extension member 7A of FIG. 23C.

Referring to FIG. 23D, the extension member 7C may include a bent region 249. The extension member 7C may include a plurality of terminals A1 to A12. The support board 310 may include a conductive pattern 366D connecting the plurality of terminals A1 to A12 of the extension member 7C and the first substrate unit 255 (e.g., the first circuit board 250). For example, the conductive pattern 366D may include a plurality of wirings Z1 to Z9. For example, the conductive pattern 366D may further include a plurality of terminals A1 to A12. For example, the conductive pattern 366D may further include terminals P3 and P4 and wirings Z12 and Z13.

For example, the plurality of wirings Z1 to Z11 may be connected to corresponding terminals among the plurality of terminals (e.g., A1 to A12). For example, one wiring Z6 may be commonly connected to two terminals A8 and A9, and each of the ten wirings Z1 to Z5, and Z7 to Z11 may be connected to a corresponding one of the ten terminals A1 to A7, and A10 to A12.

The extension member 7C may include two terminals P3 and P4 for conductively connecting with the terminals B3 and B4 of the terminal portion 95 of the circuit board 190. The terminals P3 and P4 may be disposed above the plurality of terminals A1 to A12 of the extension member 7C. For example, the terminals P3 and P4 may be disposed above the two terminals (A1, A2).

The terminals P3 and P4 may be terminals for transmitting and receiving a clock signal CLK and a data signal SDA for data communication using a protocol, for example, I2C communication.

For example, the extension member 7C may include a wiring Z12 connecting the terminal A1 and the terminal P3 and a wiring Z13 connecting the terminal A2 and the terminal P4. The extension member 7C may include a wiring Z10 connecting the terminal P3 and the first substrate unit 255 (the first circuit board 250) and a wiring Z11 connecting the terminal P4 and the first substrate unit 255 (the first circuit board 250).

The plurality of wirings Z1 to Z9 may include at least one ground wiring (e.g., Z7, Z9) and a plurality of signal wirings Z1 to Z6, Z8.

Among the plurality of wirings Z1 to Z11, the wiring Z9 closest to the bent region 249 may be a ground wiring.

For example, the wiring Z8 secondly closest to the bent region 249 of the extension member 7C may be a signal wiring. Also, for example, the wiring Z8 third closest to the bent region 249 of the extension member 7C may be a ground wiring.

For example, the width of the wiring Z9 closest to the bent region 249 of the extension member 7C may be larger than the width of the wiring Z8 secondly closest to the bent region 249 of the extension member 7C.

The wiring Z9 closest to the bent region 249 of the extension member 7C may include a bent region 259. For example, the end of the wiring Z9 closest to the bent region 249 of the extension member 7C may have a larger width than other parts of the wiring Z9.

For example, the width of the bent region 259 of the wiring Z9 may be larger than the width of the wiring Z9 formed in the body 86 and 87. In other embodiments, the former and the latter may be equal to each other. Also, for example, the width of the bent region 259 of the wiring Z9 may be larger than the width of a portion of the wiring Z9 formed in the second extension portion 45B of the extension member 7C. In another embodiment, the width K2 of the bent region 259 of the wiring Z9 may be equal to the width of a portion of the wiring Z9 formed in the second extension portion 45B of the extension member 7D.

For example, the wiring Z9 may include a portion having a wider width than the signal wiring Z1 to Z8. For example, the wiring Z9 may include a portion having a wider width than the wiring Z10 and Z11.

Also, for example, the width K1′ of the wiring Z9 formed in the extension member 7C may be larger than the widths of the wirings Z1 to Z8, Z10 to Z11. Also, for example, the width K1′ of the wiring Z9 formed on the body 86 and 87 may be equal to or smaller than those of the wirings Z1 to Z8 and Z10 to Z11. In another embodiment, the width of the wiring Z9 formed on the body 86 and 87 may be larger than those of the wirings Z1 to Z8 and Z10 to Z11.

Also, for example, the width K1′ of the wiring Z9 formed in the body 86 and 87 may be smaller than the width K1 of the wiring Z9 formed on the extension member 7C. In another embodiment, the width K1′ of the wiring Z9 formed in the body 86 and 87 may be equal to the width K1 of the wiring Z9 formed in the extension member 7C.

For example, the ground wiring Z7 and Z9 formed in the extension member 7C may include a portion having a width greater than the width of the signal wiring Z1 to Z6, and Z8.

The description of the extension member 7D in FIG. 23A may be applied or analogically applied to the extension member 7C of FIG. 23D.

In the embodiments according to FIGS. 23A to 23D, the width of the first wiring closest to the bent region among the plurality of wirings of each of the four extension members 7A to 7D is described as being greater than the width of the second wiring secondly closest to the bent region, but in another embodiment, the width of the first wiring of one of the four extension members may be greater than the width of the second wiring, and the width of the first wiring of each of the remaining extension members may be equal to the width of the second wiring. In another embodiment, the width of the first wiring of each of two or three of the four extension members may be greater than the width of the second wiring, and the width of the first wiring of each of the remaining extension members may be equal to the width of the second wiring.

Also, in another embodiment, in each of the four extension members, the wiring farthest from the bent region may be a ground wiring. In another embodiment, in at least one of the four extension members, the wiring farthest from the bent region may be a ground wiring, and in the remaining extension members, the wiring farthest from the bent region may not be a ground wiring.

FIG. 24 shows a comparative example in which the ground wiring N13 is omitted in the extension member of FIG. 23A.

Referring to FIG. 24, the support board of the comparative example may include a fixed portion (hereinafter referred to as a “stationary portion, 241”) that does not move when the OIS moving unit moves by the OIS driving and a movable portion (hereinafter referred to as a “movable portion 242”). For example, the stationary portion 241 of the support board of the comparative example may include an extension member coupled to the base 210 and a portion of the body coupled to the base 210. Also, for example, the movable portion 242 of the support board of the comparative example may include another portion of the body connecting the stationary portion of the support board and the OIS moving unit. The description of the “stationary portion” and the “movable portion” of the comparative example of FIG. 24 may be applied or analogically applied to the support board 310 according to the embodiment including the extension members 7A to 7D of FIGS. 23A to 23D.

A bent region 249 may be formed between the stationary portion 241 and the movable portion 242 of the support board of the comparative example. For example, the bent region 249 may be formed at the point where the movable portion 242 is connected to the stationary portion 241. When the movable portion 242 of the support board of the comparative example moves during OIS operation, the bent region 249 may be damaged by impact or stress.

As a result of the impact test on the bent region 249 by the OIS driving, the impact is concentrated on the wiring N12 closest to the bent region, and thus a crack occurs in the bent region 259A of the wiring N12 of the comparative example. The crack in the wiring N12 of the comparative example can deteriorate the reliability of the OIS driving. In addition, if the wiring N12 of the comparative example is a signal wiring, it can cause a defect in the OIS driving or a malfunction.

In the embodiment, the width of the wiring (e.g., N13, Q13, Z9, S9) closest to the bent region 249 of the support board 310 is made larger than the width of the other wiring (e.g., N12, Q12, S8) of the support board 310. That is, the width K2 of the bent region 259 of the wiring (e.g., N13, Q13, Z9, S9) is larger than the width of the other wiring (e.g., N12, Q12, S8). As a result, the impact or stress caused by the movement of the movable portion 242 of the support board 310 during OIS operation can be sufficiently withstood, and cracks can be inhibited from occurring in the bent region 259.

In addition, in the embodiment, in order to inhibit cracks, a ground wiring can be additionally disposed as the wiring (e.g., N13, Q13, Z9) closest to the bent region 249. In addition, when the ground wiring is set as the wiring (e.g., N13, Q13, Z9) closest to the bent region 249, the ground wiring can absorb the impact, and thus, the impact applied to the signal wiring disposed adjacent to the ground wiring can be alleviated, and cracks can be inhibited from occurring in the signal wiring. That is, the ground wiring (e.g., N13, Q13, Z9) can act as a buffer to alleviate or absorb the impact, and even if a crack occurs in the ground wiring, it does not affect the performance of the camera module.

Or, in the embodiment, the power supply wiring of the image sensor 810 can be set to the wiring (e.g., S9) closest to the bent region 249 to inhibit cracks. In this way, by making the width of the power supply wiring (e.g., S9) larger than that of the signal wiring, cracks due to impact can be inhibited.

In the embodiment, a gap D1 can be reduced compared to the comparative example in order to inhibit an increase in the size of the extension member due to the addition of the ground wiring (e.g., N13, Q13, Z9). The gap D1 may be the distance between the wiring (e.g., N13, Q13, Z9) closest to the bent region 249 and the outer surface (or outer side) of the extension member 7B to 7D.

In the comparative example, the outer shape of the support board may be formed through a mold punching processing, and a tolerance of the mold punching processing may be 150 micrometers. For example, the gap d1 of the comparative example of FIG. 24 may be about 150 micrometers. The gap d1 may be the distance between the signal wiring N12 closest to the bent region 249 and the outer surface (or outer side) of the extension member 7B to 7D.

However, in the embodiment, the outer shape of the support board 310 may be formed through laser processing, and at this time, a tolerance of the laser processing may be 100 micrometers. For example, the gap D1 of FIG. 23A may be 100 micrometers. In this embodiment, by reducing the tolerance through laser processing, it is possible to secure additional arrangement space for ground wiring (e.g., N13, Q13, Z9) without increasing the overall size of the extension member.

In the embodiment, in order to inhibit cracks, the width K1 and K2 of the ground wiring (e.g., N13, Q13, Z9) may be 1.2 to 3 times the width K3 of the signal wiring. Alternatively, for example, the width K1 and K2 of the ground wiring (e.g., N13, Q13, Z9) may be 1.2 to 2 times the width K3 of the signal wiring. Or, for example, the width K1 and K2 of the ground wiring (e.g., N13, Q13, Z9) may be 1.2 to 1.5 times the width K3 of the signal wiring.

If the width K1 and K2 of the ground wiring (e.g., N13, Q13, Z9) is less than 1.2 times the width K3 of the signal wiring, the width of the wiring (e.g., N13, Q13, Z9) may be too small to absorb the impact, causing cracks to occur in the signal wiring (e.g., N12, Z8, Q11). In addition, if the width K1 and K2 of the wiring (e.g., N13, Q13, Z9) is more than 3 times the width K3 of the signal wiring, the width of the wiring (e.g., N13, Q13, Z9) may increase too much, causing the size of the camera module to increase.

In an embodiment, the width K1 and K2 of the ground wiring (e.g., N13, Q13, Z9) may be 125 micrometers to 200 micrometers to inhibit cracking. Or, for example, the width K1 and K2 of the ground wiring (e.g., N13, Q13, Z9) may be 125 micrometers to 165 micrometers to inhibit cracking. Or, for example, the width K1 and K2 of the ground wiring (e.g., N13, Q13, Z9) may be 130 micrometers to 150 micrometers to inhibit cracking. When K1 is less than 125 micrometers, the wiring (e.g., N13, Q13, Z9) may not sufficiently absorb impact, which may cause cracks to occur in the signal wiring (e.g., N12, Z8, Q11).

When K1 exceeds 200 micrometers, the size of the extension member 7B to 7D may increase, thereby increasing the size of the camera module.

Also, for example, K2 may be 1.2 to 3 times that of K1. Or, for example, K2 may be 1.2 to 2 times that of K1. Or, for example, K2 may be 1.2 to 1.5 times that of K1.

For example, a spacing distance between the signal wiring and the ground wiring N13, N9, N5, and N1 may be 60 to 75 micrometers. Also, for example, a spacing distance between the signal wirings may be 60 to 75 micrometers.

In addition, in the embodiment, in order to inhibit cracks, the power supply wiring of the image sensor 810 can be set to the wiring (e.g., S9) closest to the bent region 249 of the extension member 7A, and by making the width K5 and K6 of the power supply wiring (e.g., S9) larger than the width of the signal wiring S1 to S7, cracks caused by impact can be inhibited from occurring in the bent region 259 of the power supply wiring (e.g., S9).

In addition, by arranging the ground wiring S8 next to the power supply wiring S9, the ground wiring S8 can alleviate the impact, thereby inhibiting cracks from occurring in the signal wiring (S1 to S7).

For example, the width K5 and K6 of the power supply wiring S9 can be larger than the width K1 and K2 of the ground wiring N13, A13, and Z9 of the extension member 7B to 7D. For example, the width K5 and K6 of the power supply wiring S9 may be 1.2 to 3 times the width K1 and K2 of the ground wiring N13, A13, and Z9 of the extension members 7B to 7D. Or, for example, the width K5 and K6 of the power supply wiring S9 may be 1.2 to 2 times the width K1 and K2 of the ground wiring N13, A13, and Z9 of the extension members 7B to 7D. Or, for example, the width K5 and K6 of the power supply wiring S9 may be 1.5 to 2 times the width K1 and K2 of the ground wiring N13, A13, and Z9 of the extension member 7B to 7D.

In the embodiment, the ground wirings N1 and N13, Q11 and Q13 are disposed on ab edge of the support board 310 or the extension member 7B and 7D so that the ground wirings N1 and N13, Q11 and Q13 can serve to block noise introduced from the outside from being transmitted to the signal wirings. This can improve the performance of the camera module, for example, the performance of the image sensor.

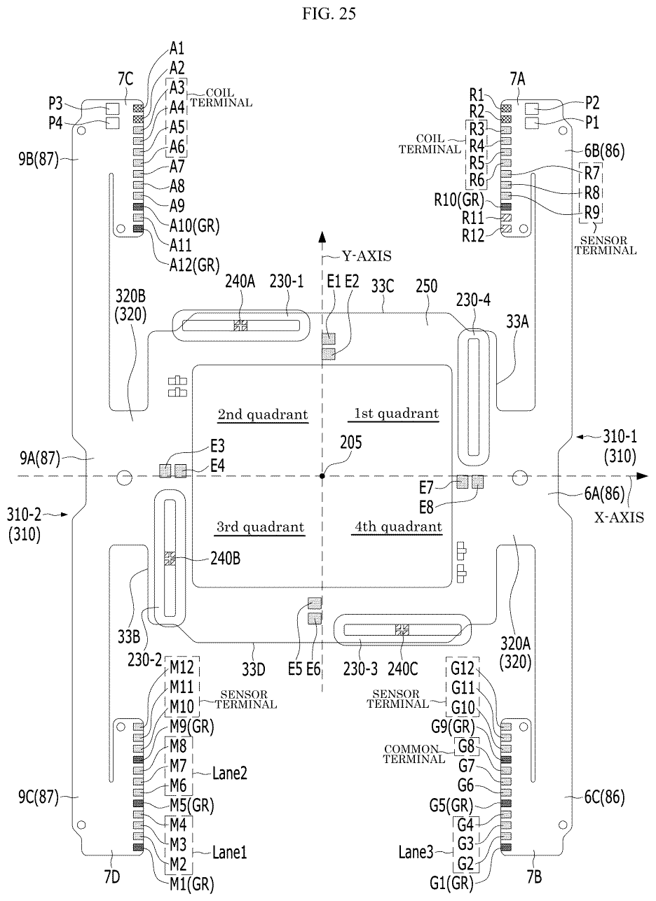

FIG. 25 shows the arrangement of terminals of the extension members 7A to 7D of the support board 310. FIG. 25 is a drawing of the extension members of the support board 310 unfolded when viewed from the top. The body 86 and 87 of the support board 310 of FIG. 25 may be folded or bent as shown in FIGS. 22A and 22B and coupled to the base 210, and the terminals of the extension members 7A to 7D may be coupled to the terminals of the second substrate unit 800. In addition, an x-y coordinate system perpendicular to the optical axis and having a center 205 as the origin (0,0) may be represented. For example, the center 205 may be a center of the first circuit board 250, a center of the image sensor 810, or the point where the optical axis meets the x-y coordinate plane.

Referring to FIGS. 22A, 22B, and 25, the support board 310 may include a plurality of wirings (e.g., N2 to N4, N6 to N8, and Q2 to Q4) and a plurality of terminals (e.g., M2 to M4, M6 to M8, G2 to G4) for transmitting and receiving data signals related to the image sensor 810.

For example, when MIPI communication protocol is a C-PHY method, a total of 9 wirings and 9 terminals are required. In the C-PHY method, a trio structure may be used, and one unit lane may include three terminals. In the C-PHY method, three unit lanes are required. In addition, for example, one unit lane in the C-PHY method may further include three wirings connected to three terminals.

For example, when the MIPI communication protocol is the D-PHY method, a total of 10 wirings and 10 terminals are required. In the D-PHY method, a dual structure can be used, and one unit lane can include two wirings. In the D-PHY method, a total of 5 unit lanes are required. In addition, for example, in the D-PHY method, one unit lane can further include two wirings connected to two terminals.

In the embodiment, the case where the MIPI communication protocol is the C-PHY method is described, but in other embodiments, the D-PHY method may be applied.

At least one unit lane for transmitting and receiving a data signal related to the image sensor 810 can be disposed at at least one of the extension members 7A to 7D of the support board 310. For example, at least one unit lane may be disposed at each of the four extension members 7A to 7D. Also, for example, at least one unit lane may be disposed at each of two adjacent extension members (e.g., 7D and 7B, or 7A and 7C) among the four extension members 7A to 7D.

For example, the number of unit lane disposed at one of the extension members 7A to 7D may be different from the number of unit lane disposed at another of the extension members 7A to 7D. For example, referring to FIGS. 23A and 23B, two unit lanes Lane1 and Lane 2 may be disposed at one of the two extension members 7D and 7B (e.g., 7D), and a single unit lane Lane3 may be disposed at the other one 7B. In another embodiment, the number of unit lane disposed at at least one of the extension members 7A to 7D may be equal to the number of unit lane disposed at at least another of the extension members 7A to 7D.

A ground terminal GR may be disposed on both sides of each unit lane Lane1, Lane2, or Lane3. In addition, a ground wiring connected to the ground terminal may be arranged on both sides of each unit lane Lane1, Lane2, or Lane3. For example, the ground wiring may be a wiring connected to the ground terminal GR in FIGS. 23A to 23D.

For example, at least one of the extension members 7A to 7D may include one or two or more ground terminals GR. For example, the extension member 7D may include two or more ground terminals GR.

For example, the ground terminal of the extension portion 7A to 7D may be connected to the ground terminals among the terminals of the second substrate unit 800 by solder.

By surrounding and shielding the lane Lane1, Lane2, or Lane3 with the ground terminal GR and the ground wiring, the embodiment can block noise radiated from the outside from being transferred to the terminal and the wiring belonging to the lane Lane1, Lane2, or Lane3.

For example, the lane Lane1, Lane2, or Lane3 may be disposed at two extension members (e.g., 7D, 7B) that are disposed adjacently. For example, the lane Lane1, Lane2, or Lane3 may be disposed at two extension members (e.g., 7D, 7B) that correspond to, oppose, or overlap one side (e.g., 33D) of the first circuit board 250. Also, for example, the lane Lane1, Lane2, or Lane3 may be disposed in the third and fourth quadrants (or the first and second quadrants). For example, at least one of the three unit lanes Lane1, Lane2, or Lane3 may be disposed in the third quadrant (or the first quadrant), and at least another one of the three unit lanes Lane1, Lane2, or Lane3 may be disposed in the fourth quadrant (or the second quadrant).

The lanes Lane1, Lane2, or Lane3 may be disposed at two extension members (e.g., 7D, 7B) corresponding to, opposing, or overlapping one side of the first circuit board 250 with respect to the first circuit board 250. Also, for example, lane Lane1, Lane2, or Lane3 may be disposed at two extension members (e.g., 7D, 7B) that are coupled to one side portion (or one outer surface) of the base 210, for example, one protrusion (216A, or 216B).

Thereby, the embodiment can match the length of the wiring of each unit lane or reduce the difference in the wiring length of each lane. Also, this can reduce the difference in the resistance value of the wiring belonging to each lane, and improve the performance of the image sensor 810.

For example, the length of the wiring of each unit lane may be a length from the terminals M2 to M4, M6 to M8, and G2 to G4 of the extension member (e.g., 7D, 7B) to the terminals (or pads) of the first circuit board 250 to which the image sensor 810 is conductively connected.

In another embodiment, each of the three unit lanes may be disposed at a corresponding one of three extension members selected from the four extension members 7A to 7D.

In another embodiment, at least one of the three unit lanes may be disposed at one of two extension members located opposite each other, and at least another one of the three unit lanes may be disposed at the other of the two extension members located opposite each other.

For example, the lane may be disposed closer to a second end of the extension member 7D and 7B than to a first end of the extension member 7D and 7B. For example, the second end of the extension member 7D and 7B may be one end of a portion (the first extension portion 45A) extending from the body 86 and 87.

For example, the first end of the extension member 7D and 7B may be one end located opposite the second end of the extension 7D and 7B. For example, the first end of the extension member 7D and 7B may be one end of the second extension portion 45B.

Or, for example, the lane may be disposed so as to be biased toward the second end of the extension member 7D and 7B rather than the first end. Or, for example, the lane may be disposed in the order immediately following the ground wiring disposed adjacent to the outermost end of the extension member 7D and 7B (e.g., the second end of the extension 7D and 7B). This arrangement can reduce the number of ground terminals required to shield the lane, thereby reducing the number of terminals of the extension member for soldering.

In another embodiment where the D-PHY method is applied, the description of the C-PHY method can be applied analogically.

The support board 310 can include a plurality of wirings (e.g., Z1 to Z4 and S1 to S4) and a plurality of terminals (e.g., A3 to A6 and R3 to R6, hereinafter referred to as “coil terminals”) that are conductively connected to a plurality of coil units 230-1 to 230-4.

For example, two wirings and two terminals can be connected to each coil unit.

For example, four coil terminals for conductively connecting to two coil units (e.g., 230-1, 230-3) among four coil units 230-1 to 230-4 can be disposed at one of the four extension members 7A to 7D.

For example, four coil terminals for conductively connecting with two other coil units (e.g., 230-2, 230-4) among the four coil units 230-1 to 230-4 may be disposed at any other one of the four extension members 7A to 7D.

For example, four coil terminals for two coil units (e.g., 230-1 and 230-3 or 230-2 and 230-4) may be disposed at any one of the two extension members (e.g., 7C and 7A) adjacent to one (e.g. 230-1 or 230-4) of the two coil units (e.g., 230-1 and 230-3 or 230-2 and 230-4).

For example, the four coil terminals may be disposed at the extension member (e.g., 7A) that is located further from the one coil unit (e.g., 230-1) among the two adjacent extension members (e.g., 7C and 7A). In another embodiment, for example, the four coil terminals may be disposed at the extension member (e.g., 7C) that is located closer to the one coil unit (e.g., 230-1) among the two adjacent extensions (e.g., 7C and 7A).

For example, the coil terminals may be disposed at two adjacently disposed extension members (e.g., 7A, 7C). For example, the coil terminals may be disposed at two extension members (e.g., 7C, 7A) that correspond to, oppose, or overlap one other side portion (e.g., 33C) of the first circuit board 250. Also, for example, the coil terminals may be disposed at the first and second quadrants (or the third and fourth quadrants). For example, some of the coil terminals may be disposed at the first quadrant (or the third quadrant), and the remaining of the coil terminals may be disposed at the second quadrant (or the fourth quadrant).

The coil terminals may be disposed at two extension members (e.g., 7A, 7C) corresponding to, opposing, or overlapping one side portion of the first circuit board 250. Also, for example, the coil terminals may be disposed at two extension members (e.g., 7C, 7A) coupled to another side portion (another outer surface) of the base 210, for example, to the protrusion (216A or 216B).

For example, the coil terminals and the terminals of the lanes Lane1, Lane2, or Lane3 may be positioned opposite to each other with respect to the optical axis. For example, the terminal for the coil and the terminal for the lane Lane1, Lane2, or Lane3 may be positioned opposite to each other with respect to the first circuit board 250.

Therefore, the embodiment can reduce the length of the wiring between the coil terminal and the coil units 230-1 to 230-4, reduce power consumption, reduce the influence of noise, and improve OIS performance.

In addition, in the embodiment the lengths of the wirings between the coil terminals and the coil units 230-1 to 230-4 can be coincident or the difference (or deviation) in the lengths of the wirings can be reduced. In addition, in the embodiment the difference in the resistance values of the wirings connected to the coil units 230-1 to 230-4 can be reduced, and OIS performance can be improved.

In another embodiment, two coil terminals corresponding to each of the four coil units 230-1 to 230-4 may be disposed at a corresponding one of the four extension members 7A to 7D. For example, the coil terminal may be disposed at the extension member of the support board 310 that is located most adjacent to the coil unit 230-1.

Also, in another embodiment, four coil terminals conductively connected to two coil units (e.g., 230-1, 230-2) may be disposed at one of the four extension members 7A to 7D. For example, the four coil terminals may be disposed at the extension member that is most adjacent to one of the two coil units 230-1 and 230-2.

The four coil terminals conductively connected to the other two coil units (e.g., 230-3, 230-4) may be disposed at any one of the four extension members 7A to 7D. For example, the four coil terminals may be disposed at the extension member that is closest to any one of the two coil units 230-3 and 230-4.

The support board 310 may include a plurality of wirings S5 to S7, N10 to N12, Q8, and Q10 to Q12 and a plurality of terminals R7 to R9, M10 to M12, and G8 to G12 that are conductively connected to the first to third sensors 240A to 240C.

Each sensor 240A to 240C may include two output terminals for outputting an output signal and two input terminals into which a driving power source (or a driving signal) is input. One of the two input terminals of each sensor 240A to 240C may be commonly connected. At this time, the commonly connected terminal may be referred to as a “common terminal” and may be commonly grounded. Therefore, three individual terminals may be assigned to each sensor, and three sensors may share one common terminal.

A “sensor terminal” may be disposed at each of three selected extension members (e.g., 7A, 7B, 7D) among the four extension members 7A to 7D of the support board 310. The sensor terminal may include three terminals. For example, the three terminals of the sensor terminal may be disposed a sequential arrangement order. In another embodiment, the three terminals of the sensor terminal may not be disposed sequentially. The common terminal (e.g., G8) may be disposed at any one of the three selected extension members (e.g., 7A, 7B, 7D).

A ground terminal G9 may be disposed between the common terminal (e.g., G8) and the sensor terminal for ground shielding.

For example, among the extension members 7A to 7D of the support board 310, the sensor terminals (e.g., M10 to M12, G10 to G12) for the sensor 240B or 240C may be disposed at the extension member (e.g., 7D, 7B) of the support board 310 that is closest to the sensor 240B or 240C.

In FIG. 25, the sensor terminals R7 to R9 for the sensor 240A are disposed at the extension member 7A of the support board 310, but in other embodiments, the sensor terminals for the sensor 240A may be disposed at the extension member 7C that is closest to the sensor 240A.

For example, the camera device 10 according to an embodiment may include the stationary unit including the second substrate unit 800, the moving unit including the first substrate unit 255 disposed on the second substrate unit 800 and an image sensor 810 conductively connected to the first substrate unit 255, and the support portion 310 that connects the first substrate unit 255 and the second substrate unit 800 and supports the moving unit so that the moving unit can move in a direction perpendicular to the optical axis direction.

The support portion 310 may include an extension member 7A to 7D including a plurality of wirings S1 to S9, Q1 to Q13, Z1 to Z11, and N1 to N13 conductively connected to the second substrate unit 800. The support portion 310 may include a bent region 249.

For example, among the plurality of wirings S1 to S9, Q1 to Q13, Z1 to Z11, N1 to N13, the width of the first wiring (e.g., N13, Q13, S9, Z9) closest to the bent region 249 may be larger than the width of the second wiring (e.g., N12, Q12, S8, Z8) secondly closest to the bent region 249.

For example, the first wiring (e.g., N13, Q13, Z9) may be a ground wiring conductively connected to the ground of the first substrate unit 255. For example, the first wiring (e.g., N13, Q13, Z9) may be a ground wiring.

For example, the first wiring (e.g., N13, Q13, S9, Z9) may include a bent region 259 corresponding to the bend region 249. At least a portion of the bent region 259 may have a larger width than another portion of the first wiring (e.g., N13, Q13, S9, Z9) excluding the bent region 259.

For example, the second wiring (e.g., N12, Q12) may be a wiring connected to the sensor 240. In another embodiment, the second wiring may be a wiring for utilizing a communication protocol related to the image sensor 810 or a wiring connected to the OIS coil 230.

For example, the width of the third wiring (e.g., N1, Q1) that is disposed farthest from the bent region 249 among the plurality of wirings N1 to N13 and Q1 to Q13 may be greater than the width of the second wiring (e.g., N12, Q12). The third wiring (e.g., N1, Q1) may be a ground wiring that is conductively connected to the ground of the first substrate unit 255.

For example, the fourth wiring (e.g., N2, Q2) that is closest to the third wiring (e.g., N1, Q1) among the plurality of wirings N1 to N13 and Q1 to Q13 may be a wiring for using a communication protocol related to the image sensor 810. For example, the width of the third wiring (e.g., N1, Q1) may be greater than the width of the fourth wiring (e.g., N2, Q2). For example, the third wiring (e.g., N1, Q1) may include a portion having a width greater than the width of the fourth wiring (e.g., N2, Q2).

The stationary unit may include the base 210 coupled with the second substrate unit 800. The support portion 310 may include the body 86 and 87 coupled with the first substrate unit 255 and an extension member 7A to 7D extending from the body 86 and 87 and coupled with the base 210.

The extension member 7A to 7D may include the first extension portion 45A extending from the body 86 and 87 toward the second substrate unit 800 and the second extension portion 45B extending in a direction different from the extension direction of the first extension portion 45A.

The bent region 249 may include a first bent region 249A formed between the body 86 and 87 and the first extension portion 45A and a second bent region 249B formed between the first extension portion 45A and the second extension portion 45B.

A camera device according to another embodiment may include the stationary unit including the second substrate unit 800, the moving unit including the first substrate unit 255 disposed on the second substrate unit 800 and the image sensor 810 conductively connected to the first substrate unit 255, and the support portion 310 connecting the first substrate unit 255 and the second substrate unit 800 and supporting the moving portion so that the moving unit can move in a direction perpendicular to the optical axis direction.

For example, the support portion 310 may include first and second extension members 7D and 7B and third and fourth extension members 7A and 7C positioned on opposite sides of the first and second extension members 7D and 7B with the first substrate unit 255 interposed therebetween.

For example, at least one unit lane Lane1 and Lane2 for transmitting and receiving data signals related to the image sensor 810 is disposed at each of the first and second extension members 7D and 7B, and the unit lane includes a plurality of terminals (e.g., M2 to M4, M6 to M8).

Each of the first and second extension members 7D and 7B may include two ground terminals GR conductively connected to the ground of the first substrate unit 255. The unit lane may be disposed between the two ground terminals GR. For example, the unit lane may include three terminals.

For example, one unit lane Lane3 may be disposed at the extension member 7B, and two unit lanes Lane1 and Lane 2 may be disposed at the extension member 7D.

The camera device according to an embodiment may include first to fourth coil units 230-1 to 230-4 disposed on the first substrate unit 255 and first to third sensors 240A to 240C disposed on the first substrate unit 255.

For example, one of the extension members 7A and 7C may include a first coil terminal that is conductively connected to the first and third coil units 230-1 and 230-3. The remaining one of the extension members 7A and 7C may include a second coil terminal that is conductively connected to the second and fourth coil units 230-2 and 230-4.

For example, the sensor 240A may be disposed most adjacent to the extension member 7C among the extension members 7A to 7D, the sensor 240B may be disposed most adjacent to the extension member 7D among the extension members 7A to 7D, and the sensor 240C may be disposed most adjacent to the extension member 7B among the extension members 7A to 7D.

The sensor terminal (e.g., G10 to G12) that is conductively connected to the sensor 240C may be disposed at the extension member 7B. The sensor terminal (e.g., M10 to M12) that is conductively connected to the sensor 240B may be disposed at the extension member 7D. The sensor terminal R7 to R9 conductively connected to the sensor 240A may be disposed at one (e.g., 7A) of the extension members 7A and 7D.

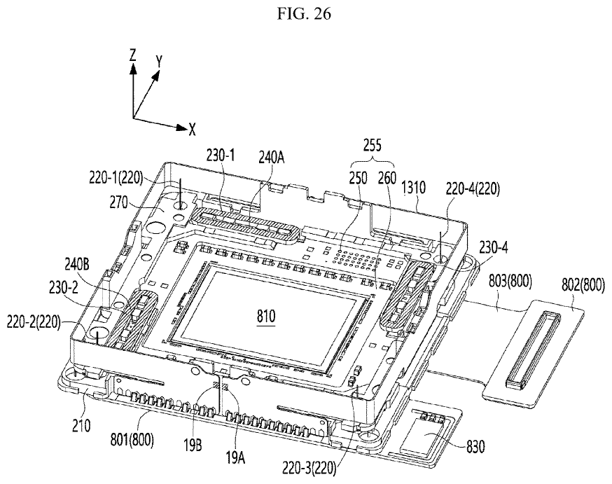

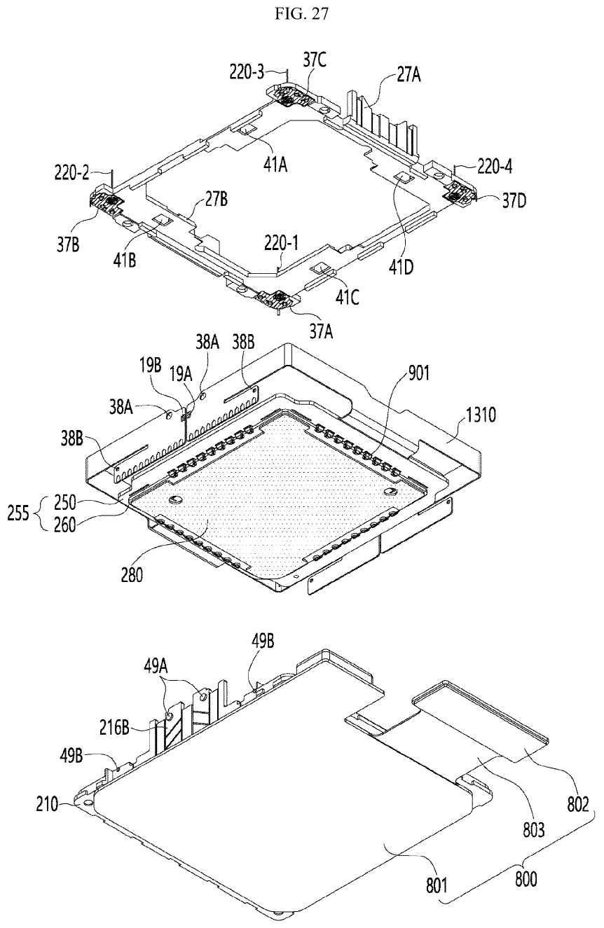

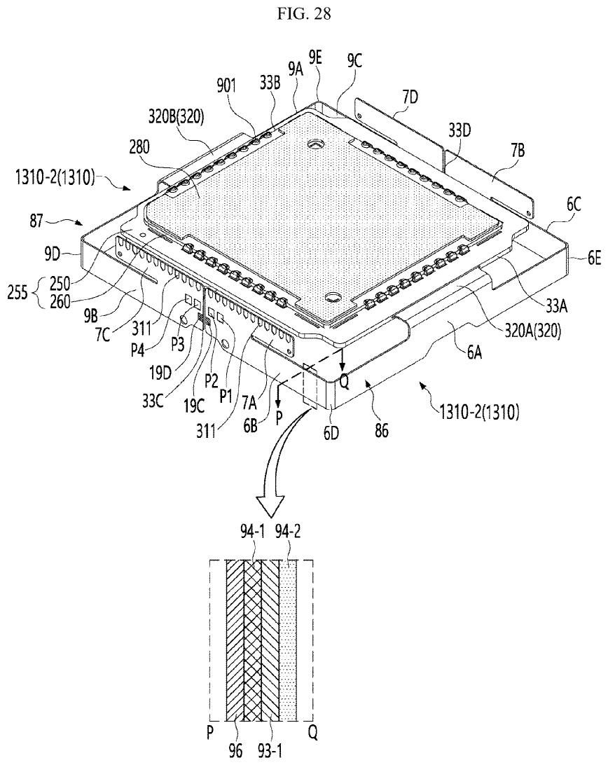

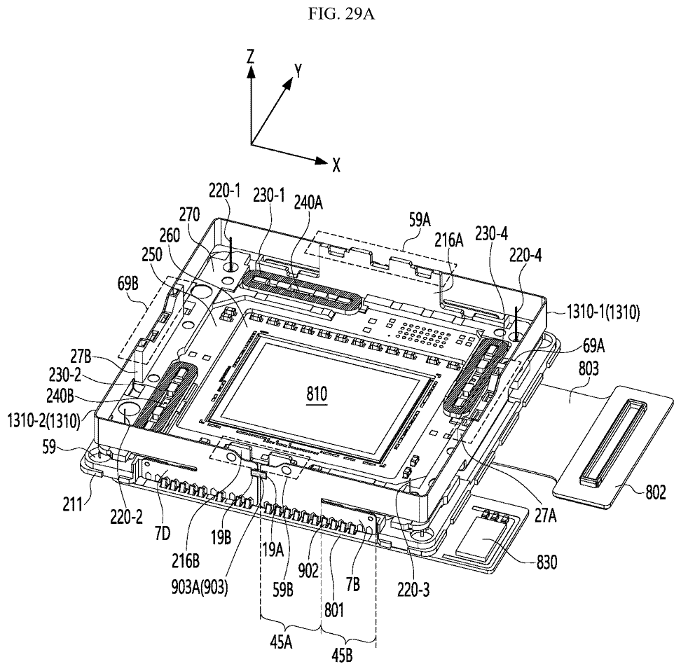

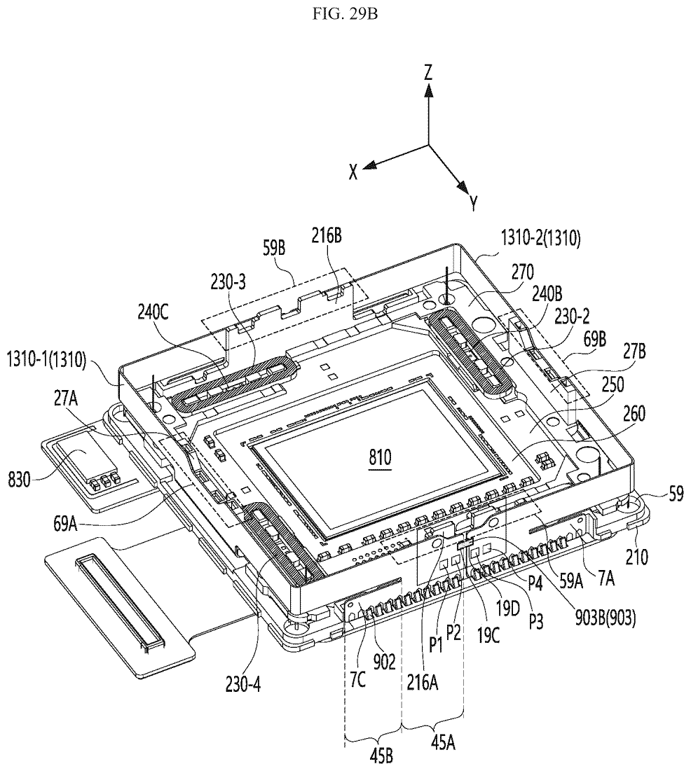

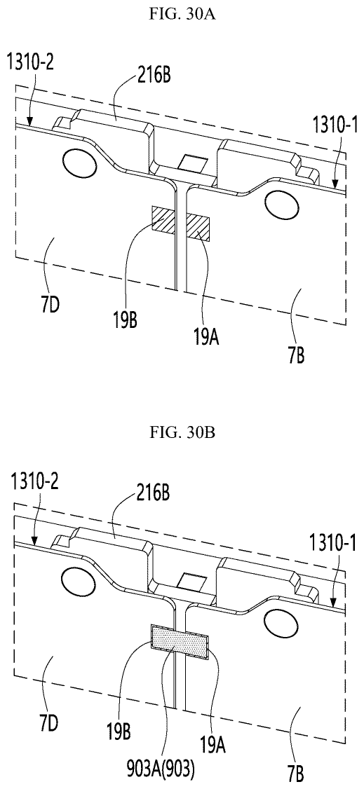

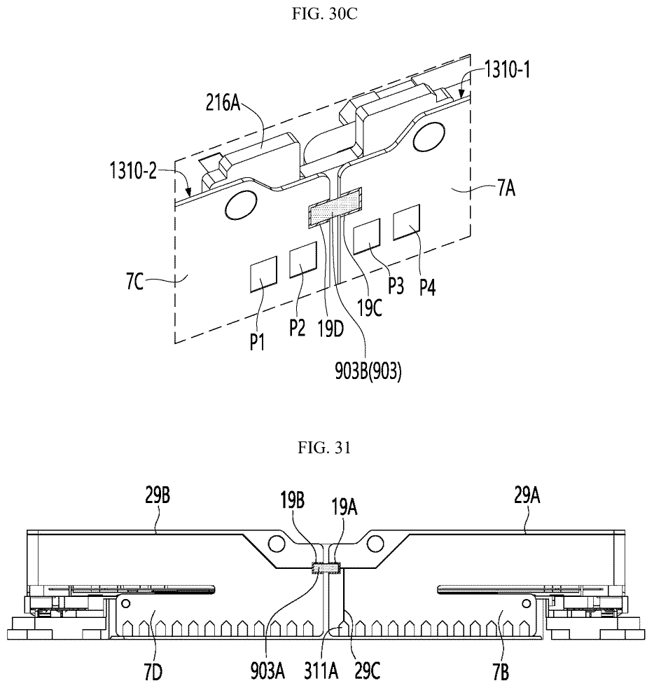

FIG. 26 is a perspective view of the image sensor unit according to another embodiment, FIG. 27 is a bottom perspective view of the holder 270, the terminal member 37, the first substrate unit 255, the support board 1310, the heat dissipation member 280, the base 210, and the second substrate unit 800 of FIG. 26, FIG. 28 is a perspective view of the first substrate unit 255, the support board 1310, and the heat dissipation member 280 of FIG. 27, FIG. 29A is a first perspective view of the support board 1310 coupled to the holder 270 and the base 210 of FIG. 27, FIG. 29B is a second perspective view of the support board 1310 coupled to the holder 270 and the base 210 of FIG. 27, and FIG. 30A is an enlarged view of the terminal 19A of the first support board 1310-1 and the terminal 19B of the second support board 1310-2 in FIG. 27, FIG. 30B shows the terminal 19A of the first support board 1310-1 and the terminal 19B of the second support board 1310-2 in FIG. 30A, and a solder or conductive adhesive 903A, FIG. 30C shows the terminal 19C of the first support board 1310-1 and the terminal 19D of the second support board 1310-2, and a solder or conductive adhesive 903B, and FIG. 31 shows an conductive connection relationship of the first circuit board 250 of FIG. 27, the terminal 19A of the first support board 1310-1, the terminal 19B of the second support board 1310-2, and the terminal 311 of the support board 1310.

Referring to FIGS. 26 to 31, the first support board 1310-1 may include at least one terminal (or pad) 19A and 19C for conductively bonding with the second support board 1310-2 by means of solder or conductive adhesive 903A and 903B.

The second support board 1310-2 may include at least one terminal (or pad) 19B and 19D for conductively bonding with the first support board 1310 by means of solder or conductive adhesive 903A and 903B. For example, the conductive adhesive 903A and 903B may be a conductive tape or a conductive resin. For example, the conductive adhesive 903A and 903B may be a conductive epoxy (e.g., Ag epoxy).

Solder or conductive adhesive 903A can conductively connect the terminal 19A of the first support board 1310-1 and the terminal 19B of the second support board 1310-2. For example, the terminal 19A of the first support board 1310-1 and the terminal 19B of the second support board 1310-2 can be conductively connected by the solder or conductive adhesive 903A.

The terminals 19A and 19C of the first support board 1310-1 and the terminals 19B and 19D of the second support board 1310-2 may be expressed as “access terminals,” “connection terminals,” “connector,” “pads,” “connection pads,” “connection pads,” or “connection portion.”

The solder or conductive adhesive 903B can conductively connect the terminal 19C of the first support board 1310-1 and the terminal 19D of the second support board 1310-2. For example, the second terminal 19A of the first support board 1310-1 and the second terminal 19B of the second support board 1310-2 can be conductively connected by the solder or conductive adhesive 903B.

For example, the terminal 19A of the first support board 1310-1 can be disposed at one end of the first support board 1310-1, and the terminal 19C of the first support board 1310-1 can be disposed at the other end of the first support board 1310-1.

For example, the terminal 19A may be disposed at a first region of the body 86 adjacent to the extension member 7B of the first support board 1310-1. Or, in another embodiment, for example, the terminal 19A may be disposed at a first region of the extension member 7B of the first support board 1310-1. For example, the terminal 19A may be disposed to contact a side surface of the first region of the body 86 or to contact a side surface of the first region of the extension member 7B.

For example, the terminal 19C may be disposed at a second region of the body 86 adjacent to the extension member 7A of the first support board 1310-1. Or, in another embodiment, for example, the terminal 19C may be disposed at a first region of the extension member 7A of the first support board 1310-1. For example, the terminal 19C may be disposed to contact the side surface of the second region of the body 86 or to contact the side surface of the first region of the extension member 7A.

For example, the terminal 19A and the terminal 19C of the first support board 1310-1 may be positioned opposite each other in the third direction (e.g., the Y-axis direction).

For example, the terminal 19B of the second support board 1310-2 may be disposed at one end of the second support board 1310-2, and the terminal 19D of the second support board 1310-2 may be disposed at the other end of the second support board 1310-2.

For example, the terminal 19B of the second support board 1310-2 may be disposed at the first region of the body 87 adjacent to the extension member 7D of the second support board 1310-2. Or in another embodiment, for example, the terminal 19B may be disposed at the first region of the extension member 7D of the second support board 1310-2. For example, the terminal 19B may be disposed to contact the side surface of the first region of the body 87 or to contact the side surface of the first region of the extension member 7D.

For example, the terminal 19D of the second support board 1310-2 may be disposed at the second region of the body 87 adjacent to the extension member 7C of the second support board 1310-2. Or in another embodiment, for example, the terminal 19D may be disposed at the first region of the extension member 7C of the second support board 1310-2. For example, the terminal 19D may be disposed to contact the side surface of the second region of the body 87 or to contact the side surface of the first region of the extension member 7C.

For example, the terminal 19B and the terminal 19D of the second support board 1310-2 may be positioned opposite each other in the third direction (e.g., the Y-axis direction).

The solder or conductive adhesive 903A may be disposed on the terminal 19A of the first support board 1310-1 and the first terminal 91B of the second support board 1310-2. For example, the solder or conductive adhesive 903A may be coupled to the terminal 19A of the first support board 1310-1 and the second terminal 91B of the second support board 1310-2.

The solder or conductive adhesive 903B may be disposed on the terminal 19C of the first support board 1310-1 and the second terminal 91D of the second support board 1310-2. For example, the solder or conductive adhesive 903B may be coupled to the terminal 19C of the first support board 1310-1 and the second terminal 91D of the second support board 1310-2.

For example, the terminals 19A to 19D of the support board 1310 may be disposed closer to the first circuit board 250 than to the second substrate unit 800. In another embodiment, the terminals 19A to 19D may be disposed closer to the second substrate unit 800 than to the first circuit board 250.

For example, the terminal 19A of the first support board 1310-1 and the terminal 19B of the second support board 1310-2 may face each other or overlap each other in the second direction (e.g., the X-axis direction).

Also, for example, the terminal 19C of the first support board 1310-1 and the terminal 19D of the second support board 1310-2 may face each other or overlap each other in the second direction (e.g., in the X-axis direction).

The terminal 19A (or terminal 19C) of the first support board 1310-1 and the terminal 19B) (or terminal 19D) of the second support board 1310-2 may be spaced apart from each other, but in other embodiments, the terminal 19A (or terminal 19C) of the first support board 1310-1 and the terminal 19B) (or terminal 19D) of the second support board 1310-2 may be in direct contact with each other.

In FIGS. 30A to 30C, the number of each of first terminal of the first and second support boards 1310-1 and 1310-2 corresponding to, opposing, or overlapping each other is 1, but in other embodiments, it may be 2 or more. In addition, in FIGS. 30A to 30C, the number of second terminal of each of the first and second support boards 1310-1 and 1310-2 corresponding to, opposing, or overlapping each other is 1, but in other embodiments, it may be 2 or more.

The terminals 19A and 19C of the first support board 1310-1 and the terminals 19B and 19D of the second support board 1310-2 may be fixed to or supported by the stationary unit. For example, the extension members 7A to 7D may be fixed or coupled to the stationary unit, for example, the base 210.

For example, the terminals 19A and 19C of the first support board 1310-1 and the first terminals 19C and 19D of the second support board 1310-2 may be fixed to a portion of the support board 1310 that does not move during the OIS driving. For example, the terminals 19A and 19C of the first support board 1310-1 and the first terminals 19C and 19D of the second support board 1310-2 may be fixed or supported to the base 210.

For example, the terminals 19A and 19C of the first support board 1310-1 and the first terminals 19C and 19D of the second support board 1310-2 may be disposed or formed on a portion of the support board 1310 that is coupled, attached, or fixed to the base 210.

In case that the terminals 19A to 19D are disposed on a movable portion of the support board 1310 (e.g., a movable portion of the body 86 and 87 of the support substrate), the solder or conductive adhesive 903A or 903B may be affected by the movement of the support board 1310 during the OIS driving, and thus the solder or conductive adhesive 903A or 903B may be damaged or broken. This may result in a deterioration in the reliability of the conductive connection between the terminals 19A to 19D and a deterioration in the performance or malfunction of the camera device.

For example, the terminal 19A of the first support board 1310-1 and the terminal 19B of the second support board 1310-2 may be disposed on the protrusion 216B of the base 210. For example, the terminal 19A of the first support board 1310-1 may be disposed or formed on a portion of the first support board 1310-1 (e.g., the first region of the body 86 or the first region of the extension member 7B) that is coupled, attached, or fixed to the protrusion 216B of the base 210. The terminal 19B of the second support board 1310-2 may be disposed or formed on a portion of the second support board 1310-2 (e.g., the first region of the body 87 or the first region of the extension member 7D) that is coupled, attached, or fixed to the protrusion 216B of the base 210.

The terminal 19C of the first support board 1310-1 and the terminal 19D of the second support board 1310-2 may be disposed on the protrusion 216A of the base 210.

For example, the terminal 19C of the first support board 1310-1 may be disposed or formed on another portion of the first support board 1310-1 (e.g., the second portion of the body 86 or the first portion of the extension member 7A) that is coupled, attached, or fixed to the protrusion 216A of the base 210. The terminal 19D of the second support board 1310-2 may be disposed or formed on another portion of the second support board 1310-2 (e.g., the second portion of the body 87 or the first portion of the extension member 7C) that is coupled, attached, or fixed to the protrusion 216A of the base 210.

For example, at least one of the terminals 19A to 19D may be disposed above the terminals 311 of the support board 1310. For example, terminals 19A and 19C of the first support board 1310-1 may be disposed above the plurality of terminals 311 of the first support board 1310-1. For example, terminals 19B and 19D of the second support board 1310-2 may be disposed above the plurality of terminals 311 of the second support board 1310-2.

For example, terminals 19C of the first support board 1310-1 may be disposed above the terminals P3 and P4 of the first support board 1310-1, and terminals 19D of the second support board 1310-2 may be disposed above the terminals P1 and P2 of the second support board 1310-2. In another embodiment, the second terminal of the first support board 1310-1 may be positioned below the terminals P3 and P4 of the first support board 1310-1, and the second terminal of the second support board 1310-2 may be positioned below the terminals P1 and P2 of the second support board 1310-2.

Referring to FIG. 31, the terminal 19A of the first support board 1310-1 may be conductively or electrically connected to the first circuit board 250. For example, the first support board 1310-1 may include a wiring 29A that conductively or electrically connects the terminal 19A and the first circuit board 250. For example, the wiring 29A may be positioned or formed in the body 86 and the first connection portion 320A.

The second terminal 19B of the second support board 1310-2 may be conductively or electrically connected to the first circuit board 250. For example, the second support board 1310-2 may include a wiring 29B that conductively or electrically connects the second terminal 19B and the first circuit board 250. For example, the wiring 29B may be disposed or formed in the body 87 and the second connection portion 320B.

For example, the terminal 19A and the terminal 19B may be conductively connected to a circuit element disposed on the first circuit board 250. For example, the circuit element may be the second position sensor 240, the second coil 230, the image sensor 810, or a capacitor.

The terminal 19A of the first support board 1310-1 may be conductively or electrically connected to the terminal 311 of the first support board 1310-1. For example, the first support board 1310-1 may include a wiring 29C that conductively or electrically connects the terminal 19A of the first support board 1310-1 and the terminal 311 of the first support board 1310-1. For example, the wiring 29C may be disposed or formed in the body 86 and the extension member 7B of the first support board 1310-1.

For example, the second terminal 19B of the second support board 1310-2 may be conductively connected to the terminal 311 of the first support board 1310-1, and may not be conductively connected to the terminal 311 of the second support board 1310-2.

That is, the first circuit element disposed on the first circuit board 250 may be conductively connected to the terminal 19A of the first support board 1310-1, and the second circuit element disposed on the first circuit board 250 may be conductively connected to the terminal 19B of the second support board 1310-2. The first circuit element and the second circuit element of the first circuit board 250 can be commonly connected to the terminal 311 of the first support board 1310-1 through the terminal 19A of the first support board 1310-1 and the terminal 19B of the second support board 1310-2.

Due to the constraints on the size design of the camera device 10, there may be constraints on the number of terminals 311 that can be disposed on the support board 1310. Therefore, it is requested to reduce the number of terminals 311 of the support board 1310 and the number of terminals 800B of the second substrate unit 800. In addition, as the number of circuit elements disposed on the first circuit board 250 increases, constraints on the number of wirings and the design of the wirings of the first circuit board 250 may occur. In addition, due to the constraints of the design of the wiring, the wirings of the first circuit board 250 may be designed to overlap each other, and it may cause noise transfer between the overlapped wirings and a deterioration in the performance of the camera device 10.

The embodiment may include terminals 19A and 19B, or 19C and 19D disposed at opposing or adjacent regions of two support boards 1310-1 and 1310-2 connected to the first circuit board 250. In the embodiment, the two terminals 19A and 19B, or 19C and 19D may be conductively or electrically connected to each other. In addition, in the embodiment, each of the two terminals 19A and 19B, or 19C and 19D may be conductively connected to a corresponding one of two different circuit elements disposed on the first circuit board 250. In addition, two terminals 19A and 19B, or 19C and 19D may be commonly connected to one terminal of the support board 1310. As a result, in the embodiment the number of terminals 311 of the support board 1310 can be reduced.

The embodiment may reduce the number of wirings of the first circuit board 250 for conductive connection between the circuit elements of the first circuit board 250 and the terminal 311A of the support board 1310 through conductive connection between the extension members of the support board 1310.

In the embodiment, the freedom of design of the first circuit board 250 can be improved as the number of wirings is reduced. In addition, in the embodiment, wirings (inner layer) connected between the circuit elements of the first circuit board 250 may be omitted.

In the embodiment, since the wiring which is an inner layer, is omitted, and the transfer of noise occurring between these overlapping wiring layers can be suppressed, and the performance degradation of the camera device 10 caused by the noise transfer can be inhibited.

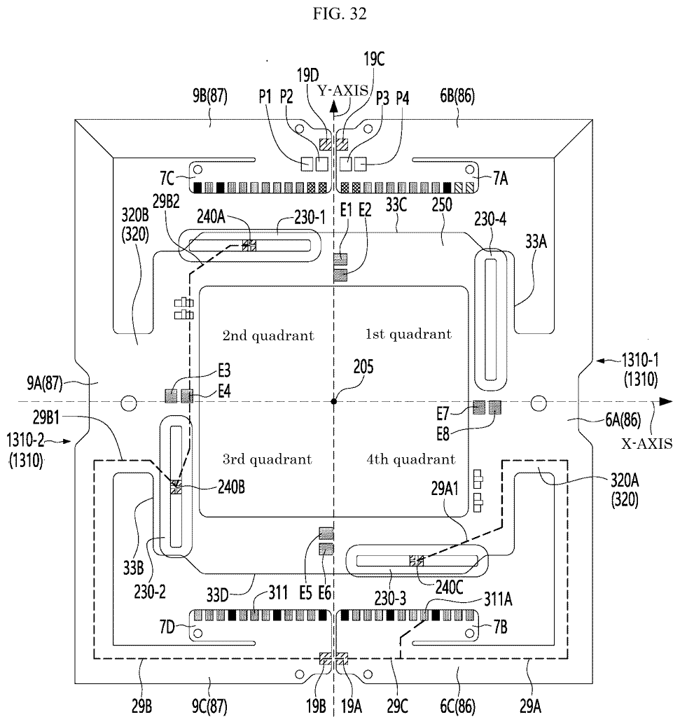

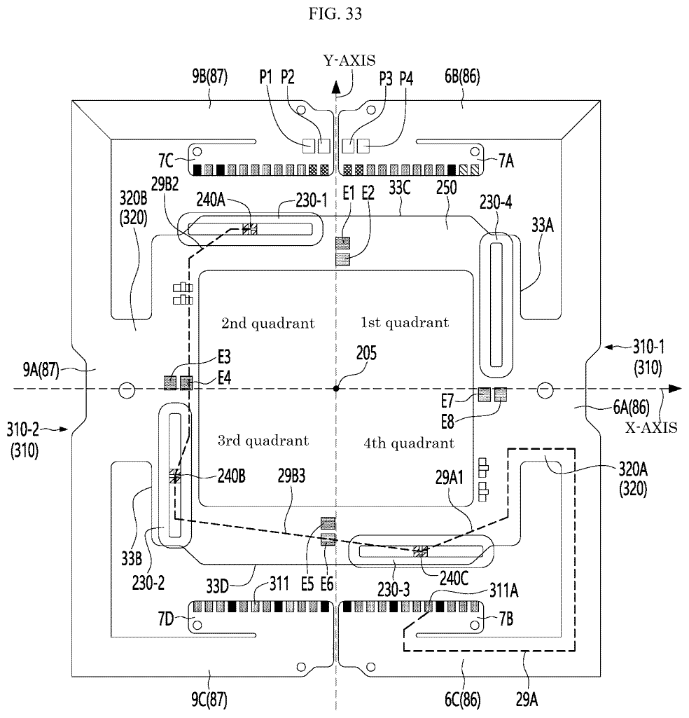

FIG. 32 shows the connection relationship between the terminals 311 of the support board 1310 of FIG. 27 and the circuit elements of the first circuit board 250, and FIG. 33 shows the connection relationship between the terminals 311 of the support board 1310 of FIG. 32 and the circuit elements of the first circuit board 250 in a comparative example in which the terminals 19A and 19B of FIG. 32 are not provided.

FIG. 32 and FIG. 33 are plan views of the support board 1310. The body 86 and 87 of the support board 1310 of FIG. 32 and FIG. 33 can be folded or bent as shown in FIG. 29A and FIG. 29B and coupled to the base 210. In FIG. 32 and FIG. 33, the body 86 and 87 and the extension members 7A to 7D are shown in a plan view.

Also, in FIG. 32 and FIG. 33, an x-y coordinate system perpendicular to the optical axis and having the center 205 as the origin (0,0) may be represented. For example, the center 205 may be the center of the first circuit board 250, the center of the image sensor 810, or the point where the optical axis meets the x-y coordinate plane.

Referring to FIG. 32, the terminals 311 of the support board 1310 may include at least one terminal (hereinafter referred to as a “communication terminal” or “data terminal”) for transmitting and receiving a data signal related to the image sensor 810. For example, the data signal related to the image sensor 810 may be a signal used in a communication protocol. For example, the communication protocol may be a mobile protocol, for example, Mobile Industry Processor Interface (MIPI).

For example, if the MIPI communication protocol is a C-PHY method, there may be 9 communication terminals. In the C-PHY method, a trio structure can be used, and one unit lane can include three communication terminals. In the C-PHY method, three unit lanes are required.

For example, if the MIPI communication protocol is the D-PHY method, there can be 10 communication terminals. In the D-PHY method, a dual structure can be used, and one unit lane can include two communication terminals. In the D-PHY method, a total of five unit lanes are required.

At least one unit lane for transmitting and receiving a data signal related to the image sensor 810 may be disposed at at least one of the extension members 7A to 7D of the support board 1310. For example, at least one unit lane may be disposed at each of the four extension members 7A to 7D. Also, for example, at least one unit lane may be disposed at each of two adjacent extension members (e.g., 7D and 7B, or 7A and 7C) among the four extension members 7A to 7D.

For example, the number of unit lanes disposed at one of the extension members 7A to 7D may be different from the number of unit lanes disposed at another of the extension members 7A to 7D.For example, two unit lanes may be disposed at one of the two extension members 7D and 7B (e.g., 7D), and one unit lane may be disposed at the other one 7B. In another embodiment, the number of unit lanes disposed at at least one of the extension members 7A to 7D may be equal to the number of unit lanes disposed at at least another of the extension members 7A to 7D.

The terminals 311 of the support board 1310 may include at least one ground terminal. For example, the terminals 311 of the support board 1310 may include ground terminals disposed on both sides of each unit lane. For example, at least one of the extension members 7A to 7D may include one or more ground terminals. For example, the extension member 7D may include two or more ground terminals. For example, the ground terminal of the support board 1310 may be a terminal that is conductively or electrically connected to the ground of the first circuit board 250 or/and the ground of the second substrate unit 800. For example, the ground terminal of the extension members 7A to 7D may be connected to the ground terminals among the terminals of the second substrate unit 800 by solder.

By disposing the lane between the ground terminals and shielding them, the embodiment can shield noise radiated from the outside from being transferred to the terminal belonging to the lane.

The terminals 311 of the support board 1310 may include at least one terminal (e.g., referred to as a “coil terminal” hereinafter) conductively connected to a plurality of coil units 230-1 to 230-4. For example, two coil terminals may be connected to each of the coil units 230-1 to 230-4. For example, each of the four coil units 230-1 to 230-4 may be disposed at a corresponding one of the first to fourth quadrants.

A coil terminal may be disposed at at least one of the plurality of extension members 7A to 7D of the support board 1310.

For example, four coil terminals for conductively connecting with two coil units (e.g., 230-1, 230-3) among the four coil units 230-1 to 230-4 may be disposed at one of the four extension members 7A to 7D.

For example, four coil terminals for conductively connecting with the other two coil units (e.g., 230-2, 230-4) among the four coil units 230-1 to 230-4 may be disposed at another one of the four extension members 7A to 7D.

The support board 1310 may include at least one terminal (hereinafter referred to as a “sensor terminal”) conductively connected with the first to third sensors 240A to 240C.

Each of the sensors 240A to 240C may include two output terminals for outputting output signals and two input terminals for inputting driving power (or driving signals).

One of the two input terminals of each of the sensors 240A to 240C may be commonly connected. At this time, the commonly connected terminal may be referred to as a “common terminal.” For example, the driving power (or driving signal) applied to the common terminal may be a first power signal (VDD) having a first voltage or a second power signal (VSS (or GND)) having a second voltage. For example, the first voltage may be higher than the second voltage. For example, the second voltage may be a grounded voltage or a ground voltage.

Therefore, the support board 1310 may include three individual sensor terminals assigned to each of the sensors and one common terminal 311A shared by the three sensors. The common terminal of each of the sensors 240A to 240C may be conductively or electrically connected to the common terminal 311A of the support board 1310. For example, the common terminal 311A may be a common power terminal.

The sensor terminal may be disposed at at least one of the plurality of extension members of the support board 1310. For example, the sensor terminal may be disposed at each of three selected extension members (e.g., 7A, 7B, 7D) among the four extension members 7A to 7D of the support board 1310. The number of sensor terminals disposed at each of the extension members (e.g., 7A, 7B, 7D) may be three. For example, the three sensor terminals may be disposed at a sequential arrangement order. In another embodiment, the three terminals of the sensor terminal may not be disposed sequentially.

The common terminal (e.g., 311A) may be positioned on any one of three selected extension members (e.g., 7A, 7B, 7D) from among the plurality of extension members. In other embodiments, the common terminal (e.g., 311A) may be positioned on another extension member other than the three selected extension members.

For example, the extension member 7B may include the terminal 311 that couples with the second substrate unit 800 (or terminal 800B) and the terminal 19A that is conductively or electrically connected to the terminal 311A of the extension member 7B. The terminal 19A of the extension member 7B may be conductively or electrically connected to a circuit element, e.g., a sensor 240C.

The extension member 7D may include the terminal 19B that is conductively or electrically connected to the terminal 19A of the extension member 7B. The terminal 19B of the extension member 7D may be conductively or electrically connected to another circuit element, e.g., the sensor 240B.

The terminal 19A of the extension member 7B and the terminal 19B of the extension member 7D may not be conductively or electrically connected to the terminal 311 of the extension member 7D.

The support board 1310 may include the wiring 29A for connecting the terminal 19A of the extension member 7B and a circuit element (e.g., the sensor 240C, the wiring 29B for connecting the terminal 19B of the extension member 7D and a circuit element (e.g., the sensor 240B, and the wiring 29C for connecting the terminal 19A of the extension member 7B and the terminal 311A. The position of the terminal 311A illustrated in FIGS. 32 and 33 may be different from the position of the terminal 311A illustrated in FIG. 31. For example, any one of the plurality of terminals 311 of the extension member 7B may be the common terminal 311A, and the common terminal may be disposed at an end of the extension member 7B or may be in the center of the extension member 7B.

For example, the wiring 29C may be disposed or formed in the extension member 7B. In addition, the wiring 29A may be disposed or formed in the extension member 7B and the body 86. For example, at least a portion of the wiring 29A may be disposed or formed in the connection portion 320A.

The wiring 29B may be disposed or formed in the extension member 7D and the body 87. For example, at least a portion of the wiring 29B may be disposed or formed in the connection portion 320B.

The circuit element (e.g., 240C) may include a terminal (not shown) (e.g., a power input terminal) that is conductively or electrically connected to the terminal 19A of the extension member 7B, and the circuit element (e.g., 240B) may include a terminal (not shown) (e.g., a power input terminal) that is conductively or electrically connected to the terminal 19B of the extension member 7D.

The first circuit board 250 may include a wiring 29A1 that conductively or electrically connects the wiring 29A of the first support board 1310-1 and the terminal (e.g., power input terminal) of the circuit element (e.g., 240C). In addition, the first circuit board 250 may include a wiring 29B1 that conductively or electrically connects the wiring 29B of the second support board 1310-2 and the terminal (e.g., power input terminal) of the circuit element (e.g., 250B).

In addition, the first circuit board 250 may include a wiring 29B2 that conductively or electrically connects between the terminal (e.g., power input terminal) of the circuit element (e.g., 240A) and the wiring 29B1 (or the power input terminal of the circuit element (e.g., 240B).

The first circuit board 250 may not include a wiring that conductively connects the wiring 29A1 and the wiring 29B1. For example, the first circuit board 250 may not include a wiring that conductively connects the circuit element 240C and the circuit element 240B.

For example, the wiring 29A1 and the wiring 29B1 of the first circuit board 250 may be the uppermost wiring layer (or conductive layer) among the plurality of wiring layers (or conductive layers) of the first circuit board 250 that are spaced apart in a direction parallel to the optical axis. For example, the uppermost wiring layer (or conductive layer) may be a wiring layer (or conductive layer) closest to the circuit element of the first circuit board 250. Also, for example, the wiring 29B2 may be a wiring layer (e.g., an inner layer) located below the uppermost wiring layer of the first circuit board 250.

The circuit element (e.g., 240C) may be disposed closer to the extension member 7B than to the extension member 7D, and the circuit element (e.g., 240B) may be disposed closer to the extension member 7D than to the extension member 7B. Also, for example, the circuit element (e.g., 240C) may be disposed closer to the terminal 19A of the extension member 7B than to the terminal 19B of the extension member 7D, and the circuit element (e.g., 240B) may be disposed closer to the terminal 19B of the extension member 7D than to the terminal 19A of the extension member 7B.

For example, the terminal 19A and the terminal 311A of the extension member 7B may be disposed to overlap in a direction parallel to the optical axis direction. In another embodiment, the terminal 19A and the terminal 311A of the extension member 7B may not overlap in a direction parallel to the optical axis direction.

For example, the terminal 19A of the extension member 7B and the terminal 19B of the extension member 7D may be disposed so as to overlap in a direction perpendicular to the optical axis direction and in which the first extension and the second extension face each other.

The description of the terminals 19A and 311A of the extension member 7B, the terminal 19B of the extension member 7D, the wirings 29A, 29B, 29C, 29A1, 29B1, and 29B2, and the circuit elements 240A to 240C may be applied to or analogically applied to the conductive connection of the terminal 19C of the extension member 7A, the terminal 19D of the extension member 7C, and the circuit elements of the first circuit board 250.

In the embodiment of FIG. 32, the conductive connection between the power input terminal of each of the sensors 240A, 240B, and 240C and the common terminal 311A of the support board 1310 is described using the terminal 19A of the extension member 7B and the terminal 19B of the extension member 7D for the sensors 240A, 240B, and 240C, but in other embodiments, the above-described description may be applied to other circuit elements.

Instead of the conductive connection by the wiring 29B1 of the first circuit board 250 of FIG. 32 and the wiring 29B of the support board 1310, the first circuit board 250 of the comparative example of FIG. 33 includes the wiring 29B3. The wiring 29B3 can conductively or electrically connect between a terminal (e.g., a power input terminal) of a circuit element (e.g., 240C) and a terminal (e.g., a power input terminal) of a circuit element (e.g., 240B). Also, for example, the wiring 29B3 can conductively or electrically connect between the wiring 29A1 and the wiring 29B2 of the first circuit board 250. For example, the wiring 29B3 can be a wiring layer located below the uppermost wiring layer of the first circuit board 250.

In the first circuit board 250 according to the embodiment, the wiring 29B3 of the comparative example can be omitted, thereby reducing the constraints on the design space of the first circuit board 250 and improving the degree of freedom in the wiring design of the first circuit board 250.

In addition, the wiring 29B3, which is an inner layer, may overlap with other wiring layers of the first circuit board 250, and may cause noise transfer due to the wiring overlapping. However, in the embodiment, since the wiring 29B3 may be omitted, noise transfer due to the wiring overlapping may be reduced, thereby inhibiting performance degradation of the camera device due to noise. In addition, a ground shield pattern may be disposed in the region of the first circuit board 250 where the wiring 29B3 is omitted, or a design for signal compensation may be possible.

In FIGS. 26 to 33, the same reference numerals as in FIGS. 1 to 25 represent the same configuration as in the embodiment of FIGS. 1 to 25, and the descriptions of FIGS. 1 to 25 may be applied or analogically applied.

In other embodiments, the description of the terminals 19A to 19D of the support board 1310 and the solder or conductive adhesive 903B of FIGS. 26 to 33 may be applied or analogized to the embodiments of FIGS. 1 to 25.

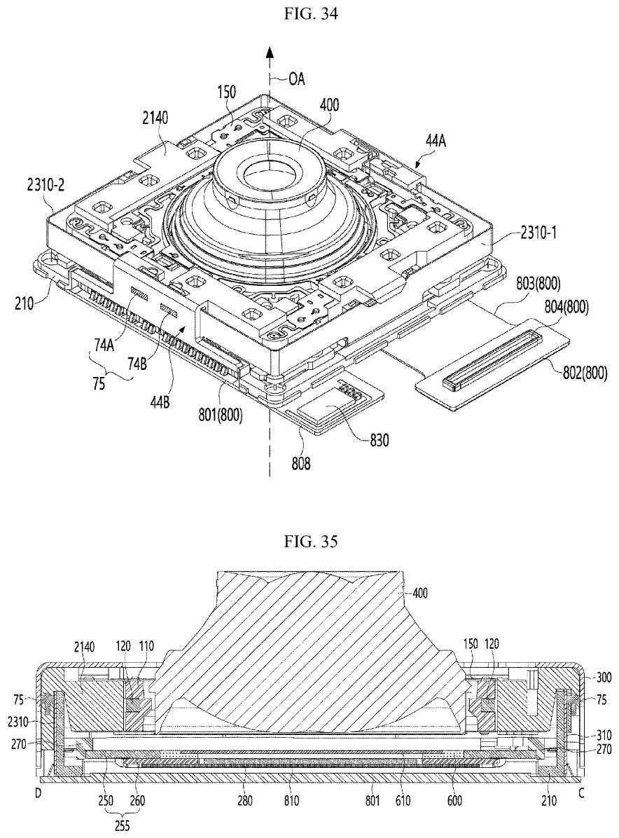

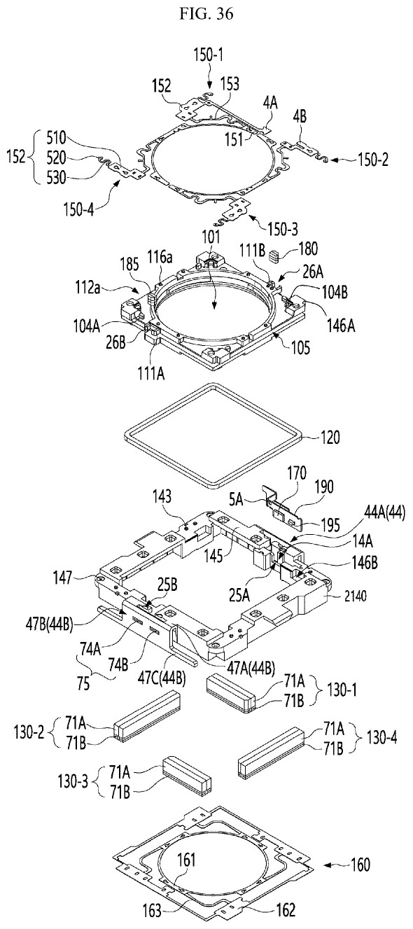

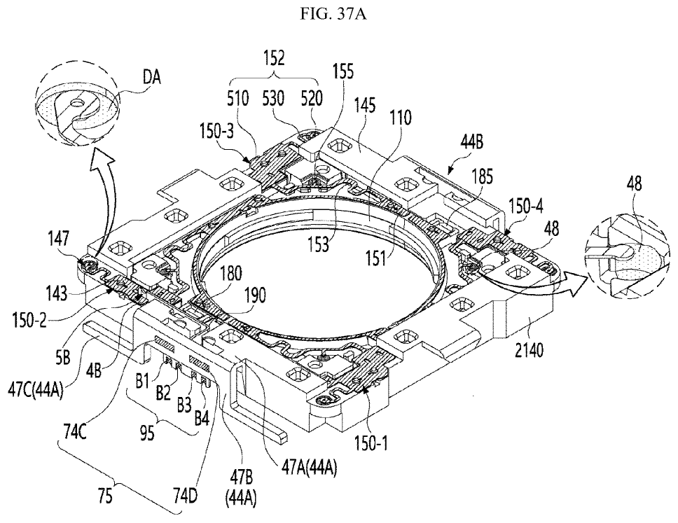

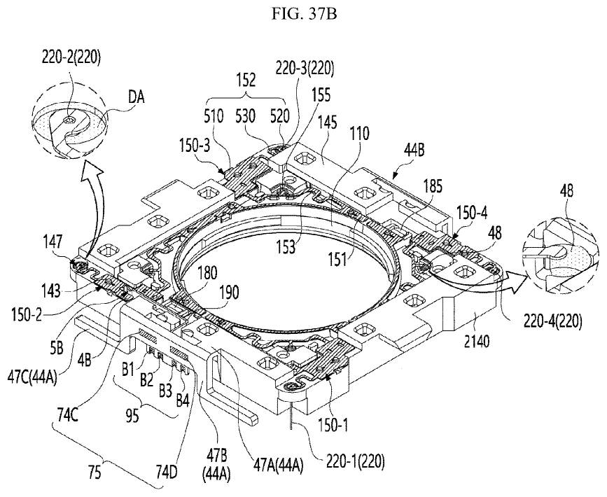

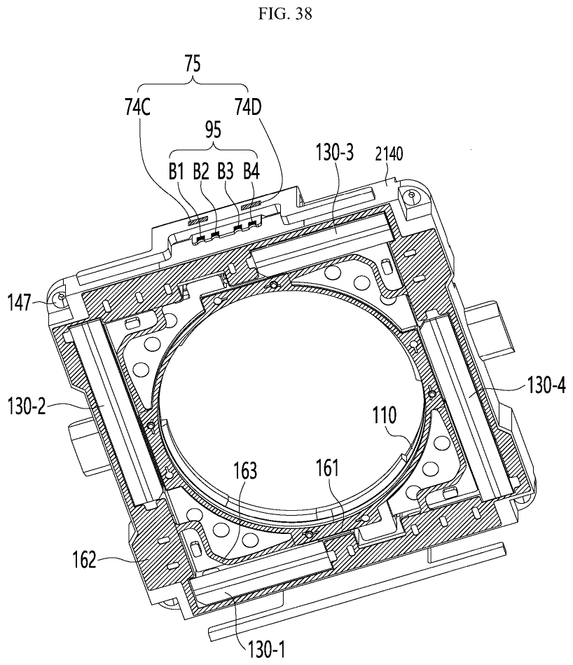

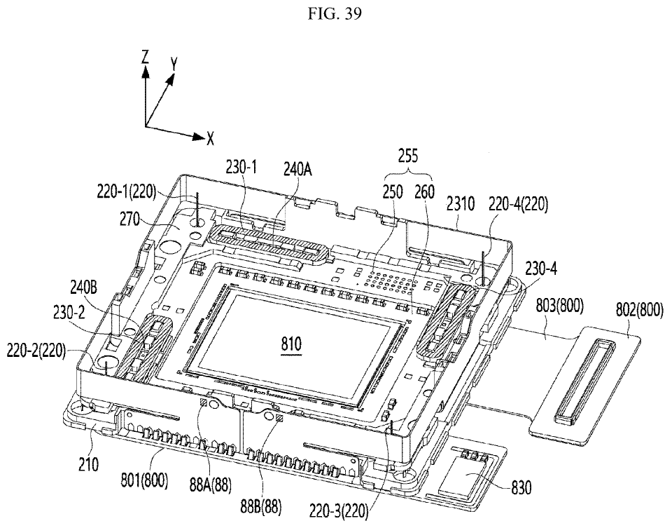

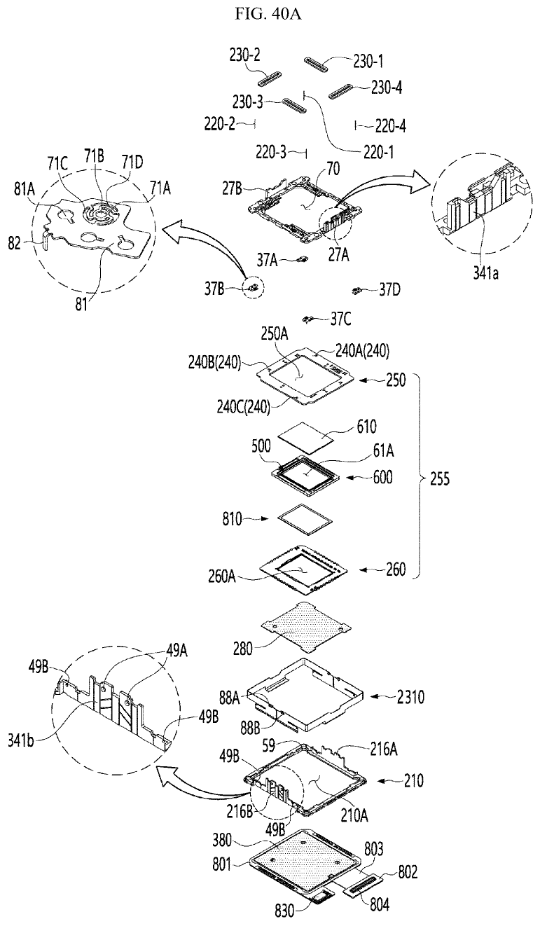

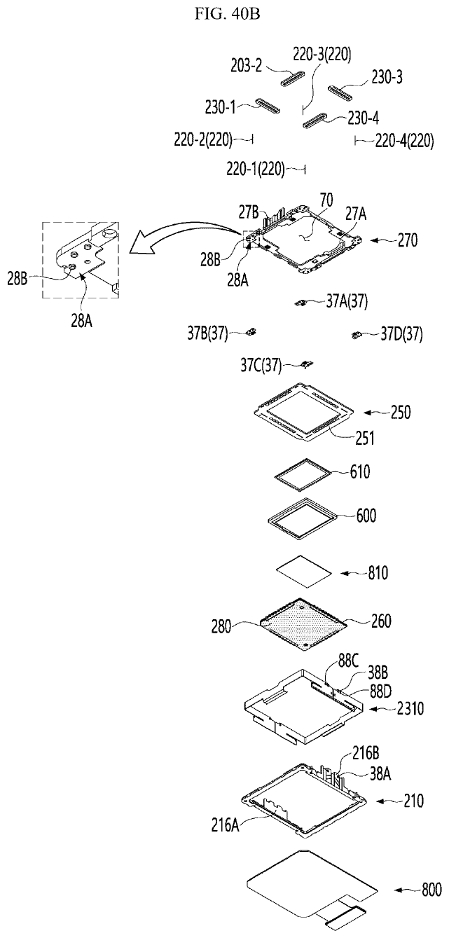

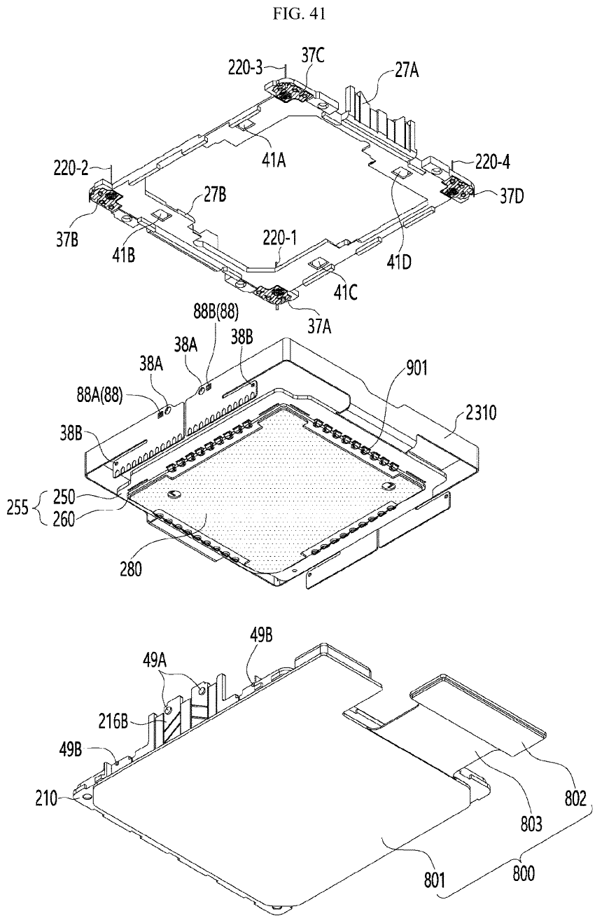

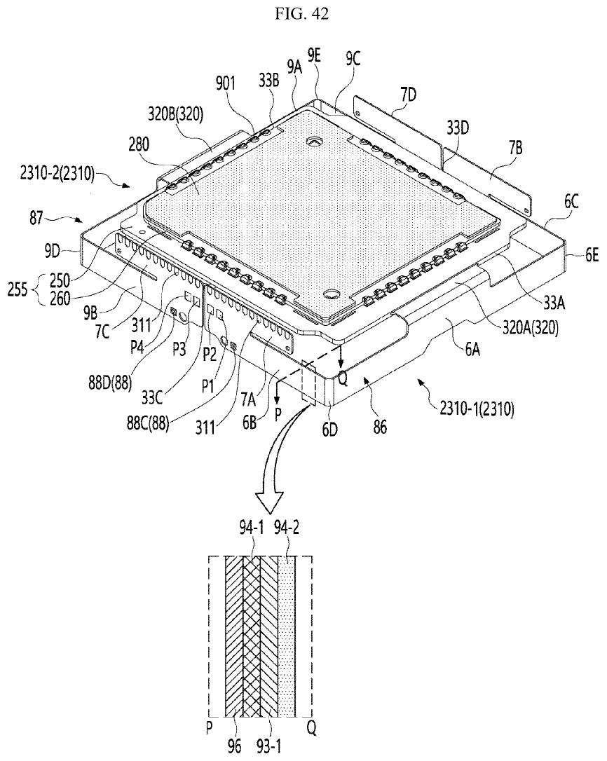

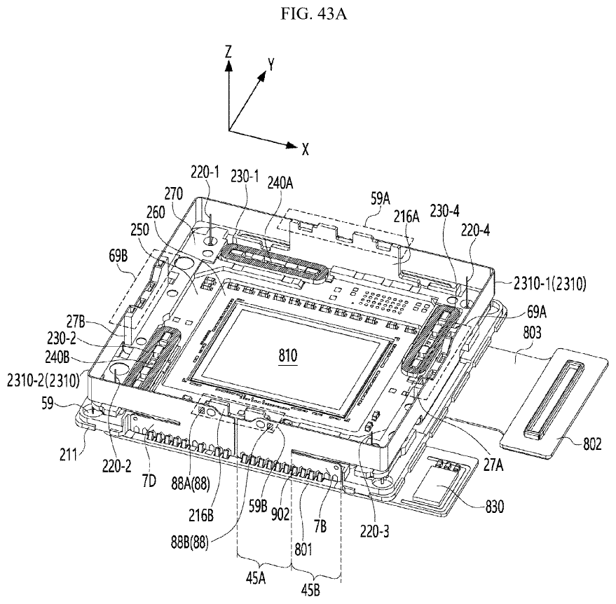

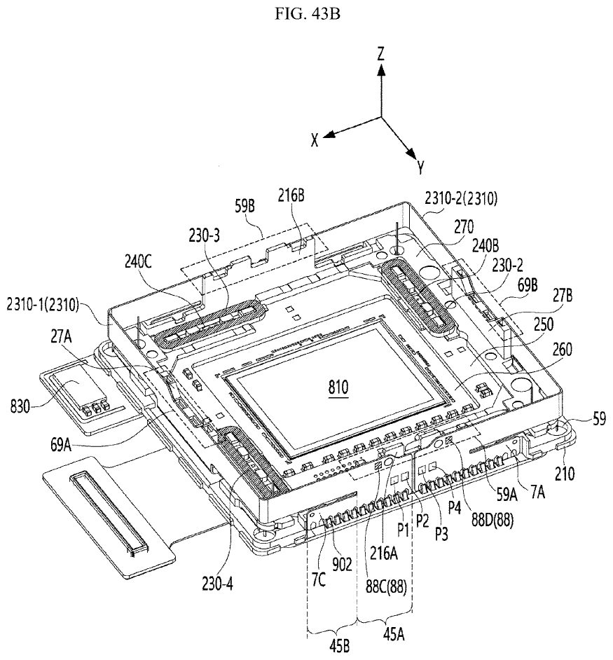

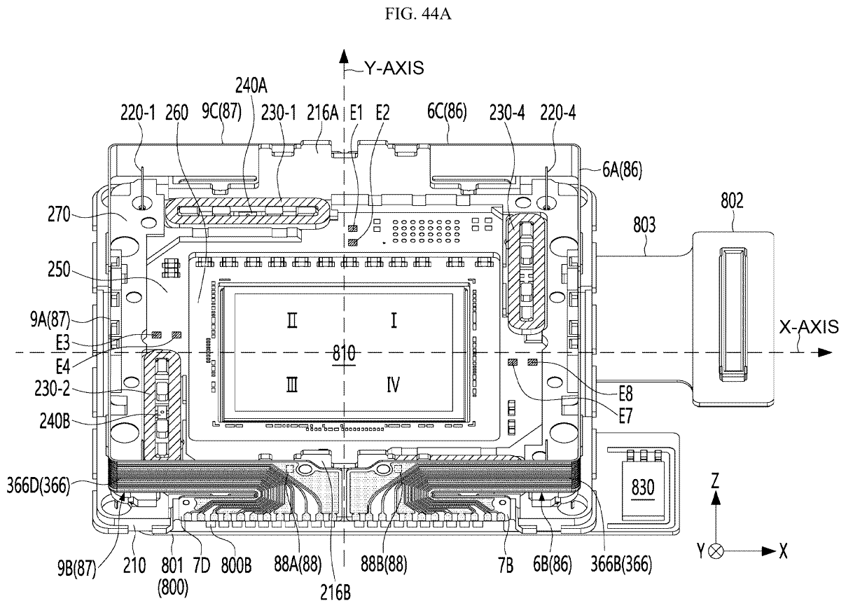

FIG. 34 is a perspective view of a camera device according to another embodiment with the cover member removed, FIG. 35 is a cross-sectional view of the camera device of FIG. 34 in the CD direction of FIG. 1, FIG. 36 is an exploded perspective view of the AF driving unit of the camera device of FIG. 34, FIG. 37A is a perspective view of the bobbin 110, the housing 2140, the circuit board 190, the upper elastic member 150, the sensing magnet 180, and the balancing magnet 185 of an embodiment according to FIG. 34, FIG. 37B is a perspective view of FIG. 37A with the wire 220 added, FIG. 38 is a bottom perspective view of the housing 2140, the bobbin 110, the lower elastic member 160, the magnet 130, and the circuit board 190 of FIG. 36, and FIG. 39 is a perspective view of the image sensor unit 350 of the camera device of FIG. 34, FIG. 40A is a first perspective view of the image sensor unit 350 of FIG. 39, FIG. 40B is a second perspective view of the image sensor unit 350 of FIG. 39, FIG. 41 is a bottom perspective view of the holder 270, the terminal member 37, the first substrate unit 255, the support board 2310, the heat dissipation member 280, the base 210, and the second substrate unit 800 of FIG. 40A, FIG. 42 is a perspective view of the first substrate unit 255, the support board 2310, and the heat dissipation member 280, FIG. 43A is a first perspective view of the support board 2310 coupled to the holder 270 and the base 210 of FIG. 39, and FIG. 43B is a second perspective view of the support board 2310 coupled to the holder 270 and the base 210 of FIG. 39.

Referring to FIGS. 34 to 43B, the stationary unit may include a portion 44 that surrounds at least a portion of at least one of the circuit board 190 and the support board 2310. The portion 44 may be a protrusion or an extension member of the station unit.

For example, the portion 44 may be a part of the housing 2140. In another embodiment, the portion 44 may be a part of the base 210. In another embodiment, the portion 44 may be a member provided separately from the housing 2140 and the base 210, and in this case, the separate member may be connected or coupled to the stationary unit.

For example, the housing 2140 may include an extension portion 44 that surrounds at least a portion of the support board 2310. For example, the extension portion 44 may be disposed or formed on an outer surface of the housing 2140. For example, the extension portion 44 may be disposed or formed on the outer surface of the side portion of the housing 2140. The extension portion 44 may be expressed as a “protection portion,” a “support portion,” a “protrusion portion,” or a guide portion.

For example, the extension portion 44 may wrap at least a portion of the body 86 and 87 of the support board 2310. Also, for example, the extension portion 44 may wrap at least a portion of the extension members 7A to 7D of the support board 2310.

For example, the extension portion 44 may wrap at least a portion of the circuit board 190. For example, at least a portion of the circuit board 190 may be disposed within the extension portion 44 or coupled to the extension portion 44.

For example, the extension portion 44 of the housing 2140 may wrap at least a portion of the circuit board 190 and at least a portion of the support board 2310. For example, the housing 2140 may include a first extension portion 44A disposed on the first side portion of the housing 2140 and a second extension portion 44B disposed on the second side portion of the housing 2140.

The first extension portion 44A and the second extension portion 44B may be disposed on opposite sides with respect to the optical axis OA or the bobbin 110. In other embodiments, one of the first and second protrusions 44A and 44B may be omitted.

For example, the circuit board 190 may be disposed inside the first extension portion 44A. For example, the mounting groove 14A may be formed at the first extension portion 44A.

The support board 2310 may include a first support board 230-1 and a second support board 2310-2.

For example, at least a portion of the body 86 and 87 of the support board 2310 may be disposed inside the extension portion 44. Also, for example, at least a portion of the extension members 7A to 7D of the support board 2310 may be disposed inside the extension portion 44.

For example, the extension portion 44 may include a first portion 47A that is connected or coupled to the housing 2140 and a second portion 47B that is connected to the first portion 47A and spaced from the side portion of the housing 2140. For example, the first portion 47A may be connected to the side portion of the housing 2140 or may extend from the side portion of the housing 2140. For example, each of the first extension portion 44A and the second extension portion 44B of the housing 104 may include the first portion 47A and the second portion 47B. For example, the first portion 47A may be positioned on the upper side of the body 86 and 87 of the support board 2310. Also, the first portion 47A may be positioned on the upper side of the extension member 7A to 7D of the support board 2310.

For example, the second portion 47B may overlap a part of the body 86 and 87 of the support board 2310 that is fixed to the stationary unit (e.g., the base 210 or the protrusion 216A and 216B) in a direction perpendicular to the optical axis.

For example, the second portion 47B may overlap at least a part of the extension member 7A to 7D of the support board 2310 in a direction perpendicular to the optical axis.

For example, the first portion 47A may be connected to the upper side of the housing 2140 (e.g., the upper side of the side portion of housing 2140) or the upper surface of the housing 2140. For example, the first portion 47A of the first extension portion 44A may be connected to the upper surface of the first side portion of the housing 2140, and the first portion 47A of the second extension portion 44B may be connected to the upper surface of the second side portion of the housing 2140. For example, the first portion 47A may protrude from the side portion of the housing 2140 in a direction perpendicular to the optical axis direction or in the direction toward the inner surface of the upper plate 301 of the cover member 300.

For example, at least a part of the circuit board 190 may be disposed between the first portion 47A and the second portion 47B of the first extension portion 44A. At least a part of the circuit board 190 may be positioned further inward than the second portion 47B of the first extension portion 44A.

Also, for example, at least a portion of the support board 2310 may be positioned further inward than the second portion 47B of the extension portion 44. For example, at least a portion of the body 86 and 87 of the support board 2310 and at least a portion of the extension member 7A to 7D may be positioned further inward than the second portion 47B of the extension portion 44.

For example, at least a portion of the body 86 and 87 of the support board 2310 may be inserted or disposed between the second portion 47B of the extension portion 44 and the side portion of the housing 2140. A portion of the body 86 and 87 that is coupled with the stationary unit, for example, the base 210 (or the protrusion 216A and 216B), may be inserted or disposed between the second portion 47B of the extension portion 44 and the side portion of the housing 2140. For example, a part of the body 86 and 87 that is coupled with the base 210 (or the protrusions 216A and 216B) may be inserted or disposed between the second portion 47B of the extension portion 44 and the protrusions 216A and 216B of the base 210.

For example, the second portion 47B may be disposed between the side portion of the housing 2140 and the side plate 302 of the cover member 300. For example, the second portion 47B may be disposed between the protrusions 216A and 216B of the base 210 and the side plate 302 of the cover member 300.

The housing 2140 may include an opening for exposing the terminals B1 to B4 of the terminal portion 95 of the circuit board 190, and the opening may be formed on the side portion of the housing 2140. For example, the first extension portion 44A may include an opening that exposes terminals B1 to B4 of the circuit board 190.

Each of the first extension portion 44A and the second extension portion 44B of the housing 2140 may include a third portion 47C extending from the second portion 47B. For example, the third portion 47C may extend or protrude in a direction parallel to the outer surface of the first side portion (or second side portion) of the housing 2140 (e.g., in the second horizontal direction) from the lower end or lower portion of the second portion 47B.

For example, the third portion 47C may include a 3-1 portion extending from one end of the second portion 47B and a 3-2 portion extending from the other end of the second portion 47B, and the 3-1 portion and the 3-2 portion may extend or protrude in opposite directions. For example, the third portion 47C may be positioned lower than the body 86 and 87 of the support board 2310. For example, the lower surface of the third portion 47C may be positioned lower than the body 86 and 87 of the support board 2310. In another embodiment, at least a portion of the third portion 47C may overlap at least a portion of the body 86 and 87 of the support board 2310 in a direction perpendicular to the optical axis.

An adhesive or a sealing member may be disposed between the extension portion 44 of the housing 2140 and the cover member 300. For example, the adhesive (or sealing member) may be disposed between the extension portion 44 of the housing 2140 and the side plate 302 of the cover member 300 and may bond the two. The extension portion 44 of the housing 2140 can increase the bonding area with the side plate 302 of the cover member 300, and the housing 2140 and the cover member 300 can be stably bonded to each other without interference from the support board 2310.

In addition, since the extension portion 44 of the housing 2140 surrounds at least a part of the support board 2310 and at least a part of the extension member 7A to 7D, it can play a role in protecting the support board 2310 from external impact. In addition, the extension portion 44 can surround or guide a fixing region of the body 86 and 87 coupled or fixed to the stationary unit and the extension member 7A to 7D, thereby protecting the body 86 and 97 of the support board 2310 and the extension member 7A to 7D.

The camera device 10 may include a heat dissipation member 75 disposed on the stationary unit and connecting the support board 2310 and the cover member 300. For example, the heat dissipation member 75 may connect the support board 2310 and the side plate 302 of the cover member 300 or may contact the support board 2310 and the side plate 302 of the cover member 300. For example, the heat dissipation member 75 may play a role in transferring and dissipating the heat of the support board 2310 to the side plate 302 of the cover member 300.

The heat dissipation member 75 may also be expressed as a “heat dissipation plate,” a “heat dissipation sheet,” a “heat dissipation tape,” a “heat dissipation layer,” a “heat dissipation film,” a “heat dissipation board,” a “metal plate,” or a “heat dissipation body.” For example, the heat dissipation member 75 may be a metal material having high thermal conductivity and high heat dissipation efficiency. For example, the heat dissipation member 75 may include at least one of SUS, aluminum, nickel, phosphorus, bronze, or copper. In another embodiment, the heat dissipation member 75 may be formed of a heat dissipation member having high thermal conductivity, such as a heat dissipation epoxy, a heat dissipation plastic (e.g., polyimide), or a heat dissipation synthetic resin.

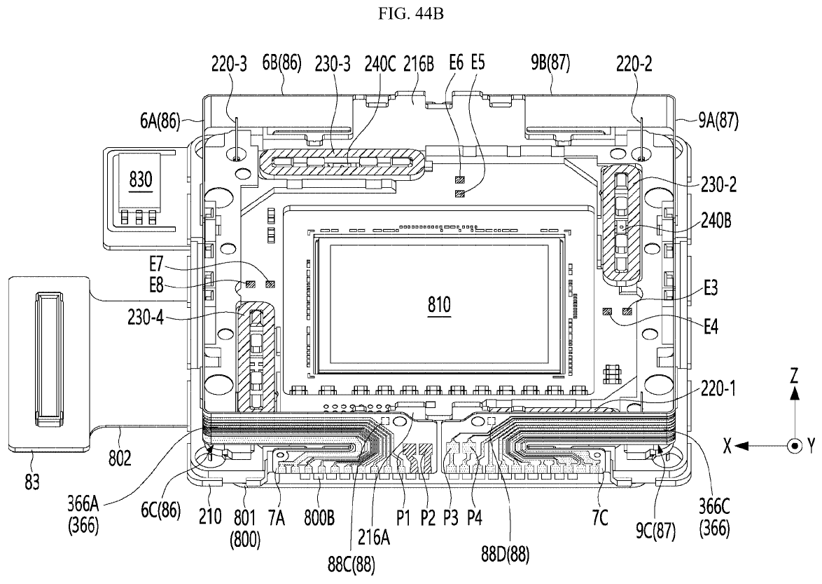

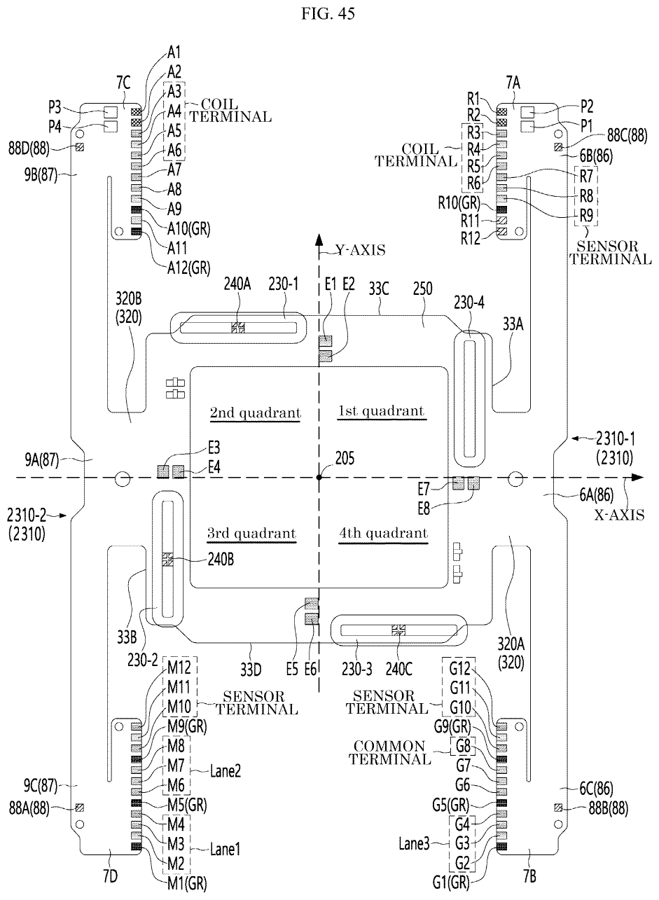

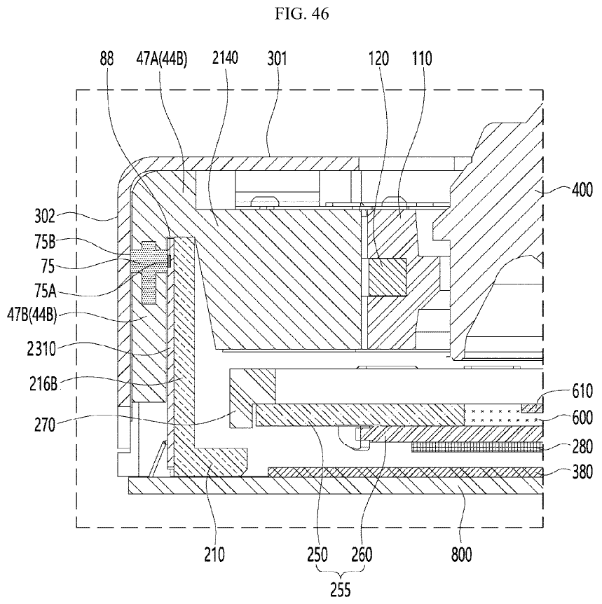

FIG. 44A shows the conductive pattern of two adjacent extension members 7B and 7D of FIG. 43A, FIG. 44B shows the conductive pattern of two adjacent extension members 7A and 7C of FIG. 43B, FIG. 45 shows the arrangement of terminals of the extension members 7A to 7D of the support board 2310 of FIG. 44A, and FIG. 46 is an enlarged view of the heat dissipation member 75 of FIG. 35.

FIG. 45 is a drawing of the extension members of the support board 2310 unfolded when viewed from above. The body 86 and 87 of the support board 2310 of FIG. 45 may be folded or bent as shown in FIGS. 43A and 43B and coupled to the base 210, and the terminals of the extension members 7A to 7D may be coupled to the terminals of the second substrate unit 800. In addition, an x-y coordinate system perpendicular to the optical axis and having the center 205 as the origin (0,0) may be represented. For example, the center 205 may be the center of the first circuit board 250, the center of the image sensor 810, or the point where the optical axis meets the x-y coordinate plane. The terminals R1 to R12, G1 to G12, A1 to A12, and M1 to M12 shown in FIGS. 44A and 44B may be examples of the terminals 311 of the extension members 7A to 7D.

Referring to FIGS. 43A to 45, for example, the extension member 7A may include a plurality of terminals R1 to R12, the extension member 7B may include a plurality of terminals G1 to G12, the extension member 7C may include a plurality of terminals A1 to A12, and the extension member 7D may include a plurality of terminals M1 to M12.

The support board 2310 may include a conductive pattern 366 connecting the plurality of terminals 311 of the extension members 7A to 7D and the first substrate unit 255 (e.g., the first circuit board 250). For example, the conductive pattern 366 may include a plurality of wirings. For example, the term “wiring” may be expressed as “conductive layer,” “conductive line,” “conductive pattern,” or “circuit pattern.” For example, a plurality of wirings of the conductive pattern 366 may be formed on the body 86 and 87 and the extension member 7D. For example, each of the plurality of terminals of the extension members 7A to 7D may be connected or coupled with a corresponding one of the plurality of wirings of the conductive pattern 366.

In addition, for example, the support board 2310 may include a first conductive pattern 366A including a plurality of wirings connecting the terminals R1 to R12 of the extension member 7A and the first substrate unit 255 (e.g., the first circuit board 250). The support board 2310 may include a second conductive pattern 366B including a plurality of wirings connecting the terminals G1 to G12 of the extension member 7B and the first substrate unit 255 (e.g., the first circuit board 250).

For example, the support board 2310 may include a third conductive pattern 366C including a plurality of wirings connecting the terminals A1 to A12 of the extension member 7C and the first substrate unit 255 (e.g., the first circuit board 250). For example, the support board 2310 may include a fourth conductive pattern 366D including a plurality of wirings connecting the terminals M1 to M12 of the extension member 7D and the first substrate unit 255 (e.g., the first circuit board 250).

Referring to FIG. 45, the terminals 311 of the support board 2310 may include at least one terminal (hereinafter referred to as a “communication terminal” or “data terminal”) for transmitting and receiving a data signal related to the image sensor 810. For example, the data signal related to the image sensor 810 may be a signal used in a communication protocol. For example, the communication protocol may be a mobile protocol, for example, Mobile Industry Processor Interface (MIPI).

For example, if the MIPI communication protocol is a C-PHY method, the number of communication terminals may be nine. In the C-PHY method, a trio structure may be used, and one unit lane may include three communication terminals. In the C-PHY method, three unit lanes are required.

For example, if the MIPI communication protocol is a D-PHY method, the number of communication terminals may be ten. In the D-PHY method, a dual structure can be used, and one unit lane can include two communication terminals. In the D-PHY method, a total of five unit lanes are required.

At least one unit lane lane1, Lane2, and Lane3 for transmitting and receiving a data signal related to the image sensor 810 can be disposed at at least one of the extension members 7A to 7D of the support board 2310.

For example, at least one unit lane can be disposed at each of two extension members (e.g., 7D and 7B, or 7A and 7C) that are disposed adjacently among the four extension members 7A to 7D. In another embodiment, for example, at least one unit lane can be disposed at each of the four extension members 7A to 7D.

For example, the number of unit lanes disposed at one of the extension members 7A to 7D may be different from the number of unit lanes disposed at another one of the extension members 7A to 7D. For example, two unit lanes may be disposed at one of the two extension members 7D and 7B (e.g., 7D), and one unit lane may be disposed at the other 7B of the two extension members 7D and 7B. In another embodiment, the number of unit lanes disposed at at least one of the extension members 7A to 7D may be equal to the number of unit lanes disposed at at least another one of the extension members 7A to 7D.

The terminals 311 of the support board 2310 may include at least one ground terminal GR. For example, the terminals 311 of the support board 2310 may include ground terminals GR disposed on both sides of each unit lane. For example, at least one of the extension members 7A to 7D may include one or more ground terminals GR. For example, the extension member 7D may include two or more ground terminals GR. For example, the ground terminal GR of the support board 2310 may be a terminal that is conductively or electrically connected to the ground of the first circuit board 250 or/and the ground of the second substrate unit 800. For example, the ground terminal GR of the extension members 7A to 7D may be soldered to the ground terminals among the terminals of the second substrate unit 800.

By disposing and the lane between the ground terminals GR and shielding them, the embodiment may shield noise radiated from the outside from being transferred to the terminal belonging to the lane.

The terminals 311 of the support board 2310 may include at least one terminal (e.g., referred to as a “coil terminal”) conductively connected to the plurality of coil units 230-1 to 230-4. For example, two coil terminals may be connected to each of the coil units 230-1 to 230-4. For example, each of the four coil units 230-1 to 230-4 may be disposed at a corresponding one of the first to fourth quadrants.

A coil terminal may be disposed at at least one of the plurality of extension members 7A to 7D of the support board 2310.

For example, four coil terminals for conductively connecting with two coil units (e.g., 230-1, 230-3) among the four coil units 230-1 to 230-4 may be disposed on one of the four extension members 7A to 7D.

For example, four coil terminals for conductively connecting with the other two coil units (e.g., 230-2, 230-4) among the four coil units 230-1 to 230-4 may be disposed on another one of the four extension members 7A to 7D.

The support board 2310 may include at least one terminal (hereinafter referred to as a “sensor terminal”) conductively connected with the first to third sensors 240A to 240C.

Each of the sensors 240A to 240C may include two output terminals for outputting output signals and two input terminals for inputting driving power (or driving signals).

One of the two input terminals of each of the sensors 240A to 240C may be commonly connected. At this time, the commonly connected terminal may be referred to as a “common terminal.” For example, the driving power (or driving signal) applied to the common terminal may be a first power signal (VDD) having a first voltage or a second power signal (VSS (or GND)) having a second voltage. For example, the first voltage may be higher than the second voltage. For example, the second voltage may be a grounded voltage or a ground voltage.

Therefore, the support board 2310 may include three individual sensor terminals assigned to each of the sensors and one common terminal (e.g., G8) shared by the three sensors. The common terminal of each of the sensors 240A to 240C may be conductively or electrically connected to a common terminal (e.g., G8) of the support board 2310. For example, the common terminal G8 may be a common power terminal.

The sensor terminal may be disposed at at least one of the plurality of extension members of the support board 2310. For example, the sensor terminal may be disposed at each of three selected extension members (e.g., 7A, 7B, 7D) among the four extension members 7A to 7D of the support board 2310. The number of sensor terminals disposed at each of the extensions (e.g., 7A, 7B, 7D) may be three. For example, the three sensor terminals may be disposed at a sequential arrangement order. In another embodiment, the three terminals of the sensor terminal may not be arranged sequentially.

The common terminal (e.g., 311A) may be disposed at one of three selected extensions (e.g., 7A, 7B, 7D) from among the plurality of extension members. In another embodiment, the common terminal (e.g., 311A) may be disposed at an extension member other than the three selected extensions.

The heat dissipation member 75 may be disposed at the stationary unit. For example, the heat dissipation member 75 may be disposed at the housing 2140 or the base 210.

The heat dissipation member 75 may include a first region connected or coupled with the support board 2310 and a second region connected or coupled with the cover member 300.

For example, the first region of the heat dissipation member 75 may be in contact with the support board 2310, and the second region of the heat dissipation member 75 may be in contact with the side plate 302 of the cover member 300.

For example, the heat dissipation member 75 may be disposed at or coupled to the housing 2140. For example, the heat dissipation member 75 may penetrate or pass through the housing 2140. Or, in another embodiment, the heat dissipation member 75 may be disposed on the upper portion, upper end, lower portion, or lower end of the housing 2140. In another embodiment, a groove may be formed at the housing 2140, and at least a portion of the heat dissipation member 75 may be disposed within the groove of the housing 2140.

For example, the heat dissipation member 75 may be disposed between the housing 2140 and the side plate 302 of the cover member 300. For example, the heat dissipation member 75 may be disposed at the extension portion 44 of the housing 2140. For example, a portion of the heat dissipation member 75 may be in contact with a portion of the support board 2310 that is disposed at, coupled to, or fixed to the stationary unit. For example, another portion of the heat dissipation member 75 may be in contact with the inner surface of the side plate 302 of the cover member 300.

The heat dissipation member 75 may penetrate the extension portion 44 of the housing 2140. For example, the heat dissipation member 75 may be disposed at, coupled to, or fixed to the second region 47B of the extension portion 44 of the housing 2140. For example, the heat dissipation member 75 may pass through the second region 47B of the extension portion 44 of the housing 2140.

For example, the heat dissipation member 75 may be in the form of a heat dissipation material, such as a metal member or a metal plate, inserted into the housing 2140 which is an injection-molded product. For example, the heat dissipation member 75 may include a bent portion or a curved portion.

Referring to FIGS. 43A, 43B, 44A, and 44B, the support board 2310 may include a pad 88 (or terminal) for contacting or connecting with the heat dissipation member 75. For example, a region of the heat dissipation member 75 may be in contact with the pad 88 of the support board 2310.

The pad 88 may be disposed on a region of the support board 2310 that is coupled with the stationary unit. For example, the pad 88 may be disposed on a region of the body 86 and 87 of the support board 2310 that is coupled with the base 210. For example, the pad 88 may be disposed on the protrusions 216A and 216B of the base 210. Also, for example, the pad 86 may overlap the protrusions 216A and 216B of the base 210 in a direction perpendicular to the optical axis.

For example, the pad 88 may be disposed on a region of the body 86 and 87 adjacent to the extension members 7A to 7D.

In another embodiment, the pad 88 may be disposed at the extension members 7A to 7D. In another embodiment, the pad 88 may be disposed at at least one of the extension members 7A to 7D and the body 876 and 87.

The pad 88 may be formed at the conductive pattern 366 of the support board 2310. For example, a portion of the conductive pattern 366 may form the pad 88. For example, the conductive pattern 366 connected to the ground terminal GR may include the pad 88. In another embodiment, the pad 88 may be formed separately from the conductive pattern 366. In another embodiment, the pad 88 may be spaced apart from the conductive pattern 366.

For example, the pad 88 may be connected to the ground terminal GR of the support board 2310. This is to improve heat dissipation efficiency by transferring heat to the grind terminal GR. In another embodiment, the pad 88 may be connected to or in contact with a separate terminal of the support board 2310 other than the ground terminal GR.

Referring to FIGS. 44A, 44B, and 45, two pads 88A and 88B corresponding to the extension members 7B and 7D may be provided on the conductive pattern connected to the ground terminal GR.

The two pads 88C and 88D corresponding to the extension members 7A and 7C may be formed separately from the conductive pattern 366 connected to the terminal 311. For example, the pads 88C and 88D may be spaced apart from the conductive pattern 366. In another embodiment, the pads 88C and 88D may be formed on a conductive pattern that is connected to a ground terminal GR formed on the extension members 7B and 7D.

For example, the pad 88 may be located above the terminal 311 of the support board 2310. For example, the pad 88 may be located above the terminals P1 to P4 of the support board 2310. In another embodiment, the pad 88 may be disposed between the terminals P1 to P4 of the support board 2310 and the terminal 311.

In FIGS. 43A and 43B, the pad 88 includes four pads 88A to 88D corresponding to each of the four extension members 7A to 7D, but in other embodiments, the support board 2310 may include at least one pad corresponding to at least one of the four extension members 7A to 7D.

Also, in FIGS. 43A and 43B, each of the number of the pads 88 and the number of the heat dissipation members is four, but in other embodiments, each of the number of pads 88 and the number of the heat dissipation members may be one or two or more.

The heat dissipation member 75 may include heat dissipation members 74A to 74D corresponding to the pads 88A to 88D of the support board 2310. For example, each of the heat dissipation members 74A to 74D may be connected to or in contact with a corresponding one of the pads 88A to 88D of the support board 2310.

The heat dissipation member 75 may include two heat dissipation members 74C, 74D spaced apart from each other in the extension portion 44A of the housing 2140 and two heat dissipation members 74A, 74B spaced apart from each other in the extension portion 44B of the housing 2140.

In another embodiment, the two heat dissipation members 74C and 74D may be a single heat dissipation member connected to each other, and the two heat dissipation members 74A and 74B may be a single heat dissipation member connected to each other.

Referring to FIG. 46, the heat dissipation member 75 may include a first region 75A that is exposed to the first surface of the second portion 47B of the extension portion 44 of the housing 2140 and contacts the support board 2310, and a second region 75B that is exposed to the second surface of the second portion 47B and contacts the side plate 302 of the cover member 302. The side plate 302 of the cover member 300 may include an opening (not shown) that exposes a portion of the heat dissipation member 75.

The heat dissipation member 75 may include an extension portion that extends toward at least one of the upper side, lower side, front side, or rear side to increase the contact area with the housing 2140 and thus increase the bonding force with the housing 2140.

For example, the heat dissipation member 75 may include a body (or plate) and a protrusion that extends or protrudes from the body. For example, the heat dissipation member 75 may include at least one of a first protrusion protruding from the body toward the support board 2310, a second protrusion protruding from the body toward the side plate 302, a third protrusion protruding from the body toward the top plate 301 or upward, and a fourth protrusion protruding downward from the body.

For example, the cross-section of the heat dissipation member 75 may be cross-shaped, but in other embodiments, it may be polygonal. The heat dissipation member 75 may be in a form that is surrounded by the housing 2140 except for the first region 75A and the second region 75B, but in other embodiments, the heat dissipation member 75 may include at least one region exposed from the outer surface of the housing 2140 except for the first region 75A and the second region 75B.

In a sensor shift camera device in which the image sensor moves for image stabilization, since the OIS moving unit including the image sensor and the first substrate unit is disposed apart from the stationary unit including the second substrate unit, the heat generated in the OIS moving unit may be vulnerable to being discharged to the outside through the stationary unit. In addition, in the sensor shift camera device, the AF driving unit and the OIS driving unit may be structured to be confined in the cover member for the purpose of inhibiting foreign matter defects, and thus, the heat may not be easily discharged to the outside of the camera device. The image sensor 810 and the second coil 230 may be heat sources.

In the embodiment, the heat generated in the OIS moving unit may be directly discharged to the cover member 300 through the heat dissipation member 75 disposed between the support board 2310 connecting the OIS moving unit and the stationary unit and the cover member 300, thereby improving the heat dissipation efficiency.

The heat generated from the image sensor 810 may be sequentially transferred or conducted to the heat dissipation member 280, the second circuit board 260, the first circuit board 250, the support board 2310 (e.g., the pad 88 connected to the ground terminal GR), the heat dissipation member 75, and the cover member 300.

A passage through which heat can be directly conducted or transferred between the support board 2310 and the cover member 300 may be formed by the heat dissipation member 75, and thus the embodiment may improve heat dissipation efficiency.

A thermally conductive adhesive or a conductive adhesive may be disposed between the heat dissipation member 75 of FIG. 46 and the pad 88 of the support board 2310. The heat dissipation member 75 and the pad 88 of the support board 2310 may be coupled or attached to each other by the thermally conductive adhesive (or the conductive adhesive).

A thermally conductive adhesive or the conductive adhesive may be disposed between the heat dissipation member 75 and the cover member 300 (or side plate 302) of FIG. 46. The heat dissipation member 75 and the cover member 300 (or the side plate 302 may be bonded or attached to each other by the thermally conductive adhesive (or the conductive adhesive).

In another embodiment, no adhesive may be disposed between the heat dissipation member 75 and the pad 88 of the support board 2310 and/or between the heat dissipation member 75 and the side plate 302 of the cover member 300.

In another embodiment, the heat dissipation member 75 and the pad 88 of the support board 2310 may be spaced apart from each other, and the heat dissipation member 75 and the side plate 302 of the cover member 300 may be spaced apart from each other, and the heat transfer may be performed by a convection phenomenon.

Since the heat dissipation member 75 has a structure in which it is inserted into the housing 2140, the durability or rigidity of the housing 2140 can be increased, and in the embodiment, a damage of the stationary unit due to impact can be suppressed and the impact stress received by the stationary unit can alleviated.

In addition, since the pad 88 can be formed by removing a part of the insulating layer of the support board 2310, for example, a part of the cover layer, and thereby exposing a part of the conductive pattern of the support board 2310 connected to the ground terminal GR, in the embodiment, the heat dissipation efficiency can be easily improved without significantly changing the structure of the camera device without changing the size of the camera device.

In the case where the controller 830 is disposed at the OIS moving unit, a lot of heat is generated when the controller 830 performs the rolling operation, and in the embodiment, the heat dissipation efficiency of the controller 830 can be improved, so that malfunction of the controller 830 due to heat can be inhibited and the reliability of the rolling operation of the controller 830 can be improved.

By easily transferring and dissipating the heat generated during the operation of the image sensor 810 to the cover member 300 through the heat dissipation member 75, the performance deterioration of the image sensor due to heat can be inhibited. In addition, by improving the heat dissipation efficiency, when the camera device is mounted on the optical device, the negative impact on the optical device caused by heat generated from the camera device can be reduced.

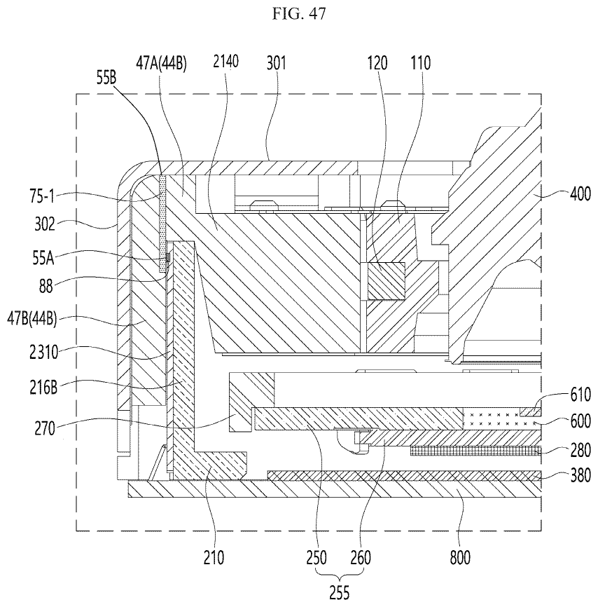

FIG. 47 shows another embodiment 75-1 of the heat dissipation member 75 of FIG. 46.

Referring to FIG. 47, the heat dissipation member 75-1 may penetrate the stationary unit, for example, the housing 2140, and may contact the upper plate 301 of the cover member 300. For example, the heat dissipation member 75-1 may include a first region 55A that contacts or is connected to the pad 88 of the support board 2310 and a second region 55B that contacts or is connected to the upper plate 301 of the cover member 300. For example, the second region 55B may contact or be connected to an inner surface of the upper plate 301 of the cover member 300. For example, the second region 55B and the upper plate 301 of the cover member 300 may be coupled to each other by a thermally conductive adhesive or/and a conductive adhesive. In another embodiment, the heat dissipation member 75-1 may be spaced apart from the top plate 301.

The heat dissipation member 75-1 may be disposed at the extension portion 44B of the housing 2140. For example, the heat dissipation member 75-1 may be disposed at the first portion 47A and the second portion 47B of the extension portion 44B.

For example, the first region 55A may be disposed at the second portion 47B of the housing 2140 and may be exposed from the outer surface of the second portion 47B of the extension portion 44B of the housing 2140 facing the pad 88. The second region 55B may be disposed at the first portion 47A of the housing 2140 and may be exposed from the outer surface of the first portion 47A of the housing 2140 facing the upper plate 301 of the cover member 300.

The heat dissipation member 75-1 may conduct or transfer heat transferred from the support board 2310 to the upper plate 301 of the cover member 300 and release it to the outside.

The upper plate 301 of the cover member 300 may include an opening (not shown) that exposes a part of the heat dissipation member 75-1.

The heat dissipation member 75-1 of FIG. 47 may be applied instead of the heat dissipation member 75 illustrated in FIGS. 43A and 43B.

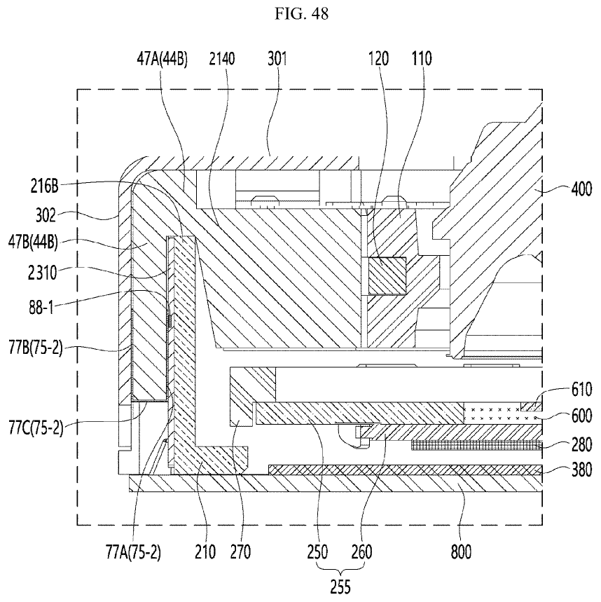

FIG. 48 illustrates another embodiment 75-2 of the heat dissipation member 75 of FIG. 46.

Referring to FIG. 48, the heat dissipation member 75-2 may be disposed on the outer surface of the housing 2140. The heat dissipation member 75-2 of FIG. 48 may not penetrate the housing 2140.

The heat dissipation member 75-2 may be disposed on the outer surface of the extension portion 44B. For example, the heat dissipation member 75-2 may include a first portion 77A disposed on a first surface of the extension portion 44B (e.g., the second portion 47B) facing the support board 2310 and a second portion 77B disposed on a second surface of the extension portion 44B (e.g., the second portion 47B) facing the side plate 302 of the cover member 300. The first surface and the second surface of the extension portion 44B (e.g., the second portion 47B) may be positioned on opposite sides.

The first part 77A of the heat dissipation member 75-2 may be in contact with or connected to a pad 88-1 of the support board 2310, and the second portion 77B of the heat dissipation member 75-2 may be in contact with or connected to the side plate 302 of the cover member 300. For example, the pad 88-1 may be disposed at a region of the body 86 and 87 that is coupled with the protrusions 216a and 216b of the base 210 or the extension member 7A to 7D. The description of the pad 88 may be applied to or analogically applied to the pad 88-1. The heat dissipation member 75-2 may be attached to or coupled to an outer surface of the extension portion 44B by an adhesive. In another embodiment, a heat dissipation member 75-2 may be formed on the surface of the housing 2140 by a surface mount technology (LDS, Laser Direct Structuring).

The heat dissipation member 75-2 may include a third portion 77C connecting the first portion 77A and the second portion 77B. For example, the third portion 77C may be positioned below the extension portion 44B of the housing 2140 (e.g., the second portion 47B). For example, the third portion 77C may be positioned lower than the pad 88-1. For example, the third portion 77C may be disposed on or coupled to the lower surface of the extension portion 44B (e.g., the second portion 47B).

The side plate 302 of the cover member 300 may include an opening (not shown) exposing a portion of the heat dissipation member 75-2. Since the heat dissipation member 75-2 is attached to the outer surface of the housing rather than being inserted into the housing, in the embodiment of FIG. 26, the coupling between the housing 2140 and the heat dissipation member 75-2 can be facilitated and simplified.

In another embodiment, the heat dissipation member 75-2 can be a separate terminal connecting the pad 88-1 and the cover member 300. For example, a groove or hole can be formed in at least one of the upper portion (or upper end), lower portion (or lower end), and side portion of the housing 2140, and the heat dissipation member can be disposed in or coupled to the groove or hole of the housing 2140.

The heat dissipation member 75-2 of FIG. 48 can be applied instead of the heat dissipation member 75 illustrated in FIGS. 43A and 43B.

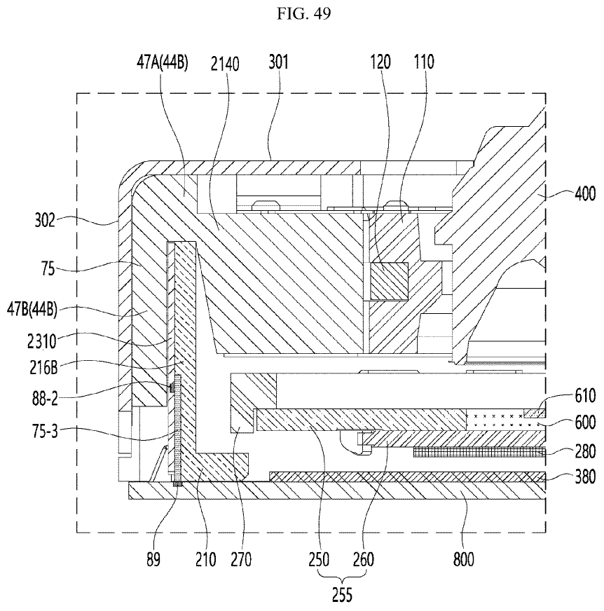

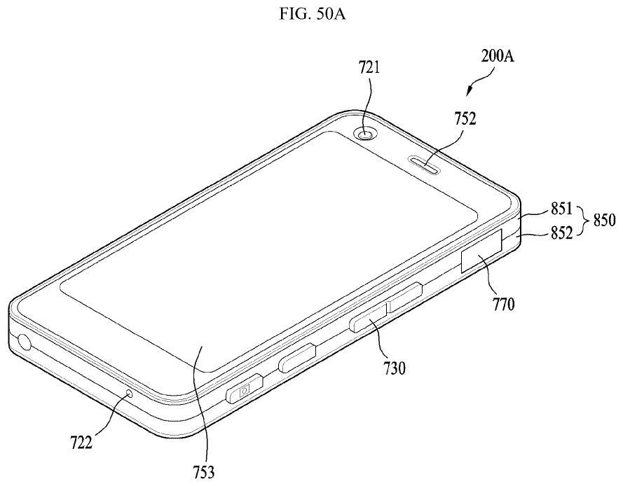

FIG. 49 illustrates another embodiment 75-3 of the heat dissipation member 75 of FIG. 46.

Referring to FIG. 49, the heat dissipation member 75-3 may be disposed on the base 210 or coupled with the base 210. For example, the heat dissipation member 75-3 may be inserted into the inside of the base 210. For example, a portion of the heat dissipation member 75-3 may be exposed from the outer surface of the base 210 (e.g., the outer surface of the protrusions 216A and 216B) and may be in contact with or connected to the pad 88-2 of the support board 2310. For example, the pad 88-2 of the support board 2310 may be disposed on one surface (e.g., rear surface) of the body 86 and 87 (or the extension member 7A to 7D) facing the base 210.

Another portion of the heat dissipation member 75-3 may be exposed from the lower surface of the base 210 and may be in contact with or connected to the pad 89 provided on the second substrate unit 800. For example, the pad 89 of the second substrate unit 800 may be disposed on the upper surface of the second substrate unit 800.

In the embodiment of FIG. 49, the heat of the support board 2310 may be directly transferred to the second substrate unit 800 through the heat dissipation member 75-3.

In another embodiment, the heat dissipation member 75-3 may be disposed on the outer surface of the base 210 rather than being inserted into the inside of the base 210. For example, in another embodiment, the heat dissipation member 75-3 may be attached or bonded to the outer surface of the base 210 or the outer surface of the protrusion 216A and 216B by an adhesive.

The heat dissipation member 75-2 of FIG. 49 may be applied instead of the heat dissipation member 75 illustrated in FIGS. 43A and 43B.

In FIGS. 34 to 49, the same drawing reference numerals as in FIGS. 1 to 25 represent the same configurations as in the embodiments of FIGS. 1 to 25, and the descriptions of FIGS. 1 to 25 can be applied or analogically applied.

In another embodiment, the descriptions of the housing 2140 and the heat dissipation member 75 of FIGS. 34 to 49 can be applied or analogically applied to the embodiments of FIGS. 1 to 25.

In another embodiment, the descriptions of the housing 2140 and the heat dissipation member 75 of FIGS. 34 to 49 can be applied or analogically applied to the embodiments of FIGS. 26 to 33.

Furthermore, the camera device according to the embodiment may be included in the optical instrument, which is designed to form the image of an object in a space using reflection, refraction, absorption, interference, diffraction or the like, which are characteristics of light, to extend eyesight, to record an image obtained through a lens or to reproduce the image, to perform optical measurement, or to propagate or transmit an image. For example, although the optical instrument according to the embodiment may be a mobile phone, cellular phone, smart phone, portable smart instrument, digital camera, laptop computer, digital broadcasting terminal, Personal Digital Assistant (PDA), Portable Multimedia Player (PMP), navigation device, or the like, the disclosure is not limited thereto. Furthermore, any device capable of taking images or photographs is possible.

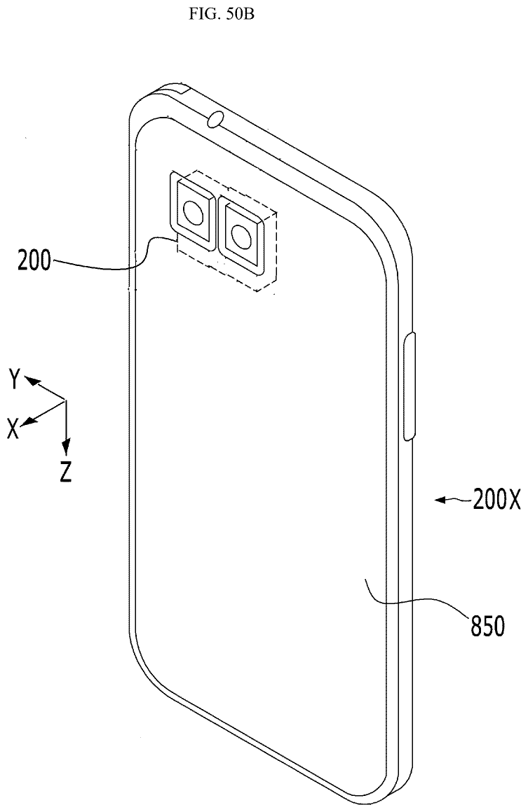

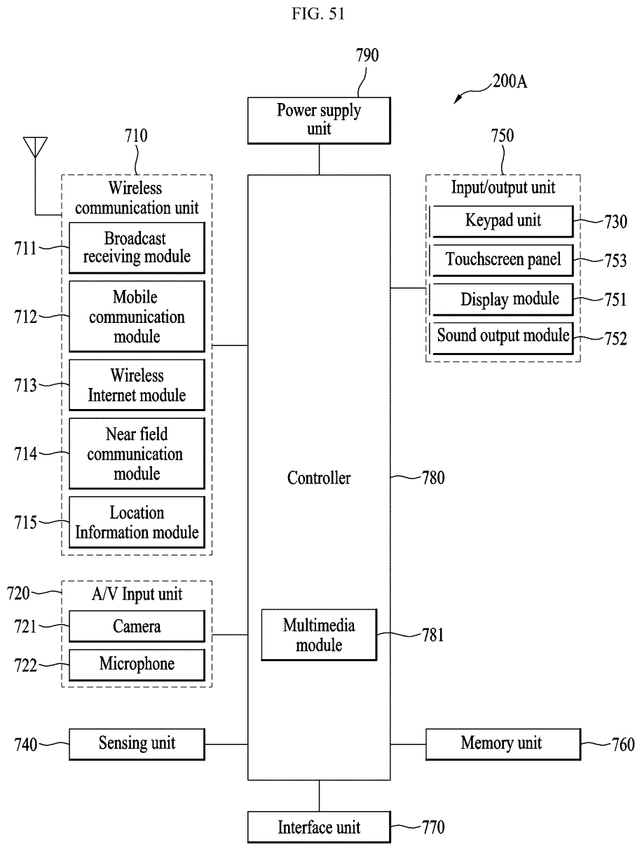

FIG. 50A is a perspective view of the optical instrument 200A according to an embodiment. FIG. 50B is a perspective view of the optical instrument 200X according to another embodiment, and FIG. 51 is a view illustrating the configuration of the optical instrument 200A illustrated in FIGS. 50A and 50B.

For example, the embodiment shown FIG. 50A may be a front camera of the optical instrument 200A in which the lens module 400 of the camera module 200 is disposed so as to face in a forward direction of the body 850, and the embodiment shown FIG. 50B may be a rear camera of the optical instrument 200A in which the lens module 400 of the camera module 200 faces in a backward direction of the body 850. In FIG. 50B, an example is shown where two rear cameras are disposed, but in other embodiments, one or more rear cameras may be disposed.

In another embodiment, the optical device 200A according to the embodiment may correspond to the front camera and the rear camera of the optical device 200A.

Referring to FIGS. 50A, 50B and 51, the optical device 200A may include a body 850, a wireless communication unit 710, an audio/video (A/V) input unit 720, a sensing unit 740, an input/output unit 750, a memory unit 760, an interface unit 770, a controller 780, and a power supply unit 790.

The body 850 has a bar shape, without being limited thereto, and may be any of various types, such as, for example, a slide type, a folder type, a swing type, or a swivel type, in which two or more sub-bodies are coupled so as to be movable relative to each other.

The body 850 may include a case (a casing, housing, cover or the like) defining the external appearance of the terminal. For example, the body 850 may be divided into a front case 851 and a rear case 852. Various electronic components of the terminal may be accommodated in the space defined between the front case 851 and the rear case 852.

The wireless communication unit 710 may include one or more modules, which enable wireless communication between the optical device 200A and a wireless communication system or between the optical device 200A and a network in which the optical device 200A is located. For example, the wireless communication unit 710 may include a broadcast-receiving module 711, a mobile communication module 712, a wireless Internet module 713, a nearfield communication module 714, and a location information module 715.

The A/V input unit 720 serves to input audio signals or video signals, and may include, for example, a camera 721 and a microphone 722.

The camera 721 may include the camera device according to the embodiment.

The sensing unit 740 may sense the current state of the optical device 200A, such as, for example, opening or closing of the optical device 200A, the location of the optical device 200A, the presence of a user's touch, the orientation of the optical device 200A, or the acceleration/deceleration of the optical device 200A, and may generate a sensing signal to control the operation of the optical device 200A. When the optical device 200A is, for example, a slide-type cellular phone, the sensing unit 740 may sense whether the slide-type cellular phone is opened or closed. Furthermore, the sensing unit 740 may sense the supply of power from the power supply unit 790, coupling of the interface unit 770 to an external device, and the like.

The input/output unit 750 serves to generate, for example, visual, audible, or tactile input or output. The input/output unit 750 may generate input data to control the operation of the optical device 200A, and may display information processed in the optical device 200A.

The input/output unit 750 may include a keypad unit 730, a display module 751, a sound output module 752, and a touch screen panel 753. The keypad unit 730 may generate input data in response to input to a keypad.

The display module 751 may include a plurality of pixels, the color of which varies depending on the electrical signals applied thereto. For example, the display module 751 may include at least one among a liquid crystal display, a thin-film transistor liquid crystal display, an organic light-emitting diode display, a flexible display and a 3D display.

The sound output module 752 may output audio data received from the wireless communication unit 710 in, for example, a call-signal reception mode, a call mode, a recording mode, a voice recognition mode, or a broadcast reception mode, or may output audio data stored in the memory unit 760.

The touch screen panel 753 may convert variation in capacitance, caused by a user's touch on a specific region of a touch screen, into electrical input signals.

The memory unit 760 may temporarily store programs for the processing and control of the controller 780, and input/output data (for example, telephone numbers, messages, audio data, stationary images, moving images and the like). For example, the memory unit 760 may store images captured by the camera 721, for example, pictures or moving images. For example, the memory unit 760 may store therein software, algorithm or mathematical formulas for the above-mentioned hand tremor correction.

The interface unit 770 serves as a path through which the lens moving apparatus is connected to an external device connected to the optical device 200A. The interface unit 770 may receive power or data from the external component, and may transmit the same to respective constituent elements inside the optical device 200A, or may transmit data inside the optical device 200A to the external component. For example, the interface unit 770 may include a wired/wireless headset port, an external charger port, a wired/wireless data port, a memory card port, a port for connection to a device equipped with an identification module, an audio input/output (I/O) port, a video input/output (I/O) port, an earphone port and the like.

The controller 780 may control the general operation of the optical device 200A. For example, the controller 780 may perform control and processing related to, for example, voice calls, data communication, and video calls.

The controller 780 may include a multimedia module 781 for multimedia playback. The multimedia module 781 may be embodied in the controller 780, or may be embodied separately from the controller 780.

The controller 780 may perform a pattern recognition process capable of recognizing writing input or drawing input carried out on a touch screen as a character and an image, respectively.

The power supply unit 790 may supply power required to operate the respective constituent elements upon receiving external power or internal power under the control of the controller 780.

The features, configurations, effects and the like described above in the embodiments are included in at least one embodiment, but the invention is not limited only to the embodiments. In addition, the features, configurations, effects and the like exemplified in the respective embodiments may be combined with other embodiments or modified by those skilled in the art. Accordingly, content related to these combinations and modifications should be construed as falling within the scope of the disclosure.

### INDUSTRIAL APPLICABILITY

The embodiments can be used in the camera device and the optical device including the same which is capable of inhibiting occurrence of cracks in wiring of the support board caused by movement of the OIS moving unit and improving performance of the image sensor by shielding noise.

1. A camera device comprising:
a stationary unit comprising a second circuit board;
a moving unit comprising a first circuit board disposed on the second circuit board and an image sensor conductively connected to the first circuit board; and
a support unit connecting the first circuit board and the second circuit board and configured to support the moving unit so as to be movable in a direction perpendicular to an optical axis direction,
wherein the support unit comprises an extension member including a plurality of wirings conductively connected to the second circuit board, and the support unit comprises a bent region, and
wherein a width of a first wiring firstly closest to the bent region among the plurality of wirings is larger than a width of a second wiring secondly closest to the bent region among the plurality of wirings.

2. The camera device according to claim 1, wherein the first wiring is a ground wiring conductively connected to a ground of the first circuit board.

3. The camera device according to claim 1, wherein the first wiring is a ground wiring.

4. The camera device according to claim 3, wherein the second wiring is a wiring for using a communication protocol related to the image sensor.

5. The camera device according to claim 1, wherein the first wiring comprises a bent portion corresponding to the bent region, and at least a portion of the bent portion has a width larger than a width of another portion of the first wiring excluding the bent portion.

6. The camera device according to claim 1, wherein a width of a third wiring that is disposed farthest from the bent region among the plurality of wirings is greater than a width of the second wiring.

7. The camera device according to claim 6, wherein the third wiring is a ground wiring conductively connected to a ground of the first circuit board.

8. The camera device according to claim 1, wherein a fourth wiring that is closest to the third wiring among the plurality of wirings is a wiring for using a communication protocol related to the image sensor.

9. The camera device according to claim 8, wherein a width of the third wiring is greater than a width of the fourth wiring.

10. The camera device according to claim 1, wherein the stationary unit comprises a base coupled to the second circuit board, and the support unit comprises a body coupled to the first circuit board and the extension member is extended from the body and coupled to the base.

11. The camera device according to claim 10, wherein the extension member comprises:
a first extension member extending from the body toward the second circuit board; and
a second extension member extending in a direction different from an extension direction of the first extension member.

12. The camera device according to claim 11, wherein the bent region comprises:
a first bent region formed between the body and the first extension member; and
a second bent region formed between the first extension member and the second extension member.

13. A camera device comprising:
a stationary unit comprising a second circuit board;
a moving unit comprising a first circuit board disposed on the second circuit board and an image sensor conductively connected to the first circuit board; and
a support unit connecting the first circuit board and the second circuit board and configured to support the moving unit so as to be movable in a direction perpendicular to an optical axis direction,
wherein the support unit comprises:
first and second extension members; and
third and fourth extension members positioned opposite to first and second extension members with the first circuit board interposed therebetween,
wherein at least one unit lane for transmitting and receiving a data signal related to the image sensor is disposed at each of the first and second extension members, and
wherein the unit lane includes a plurality of terminals.

14. The camera device according to claim 13, wherein each of the first and second extension members comprises two ground terminals conductively connected to a ground of the first circuit board, and the unit lane is disposed between the two ground terminals.

15. The camera device according to claim 13, wherein the unit lane comprises three terminals, and one unit lane is disposed at the first extension member, and two unit lanes are disposed at the second extension member.

16. The camera device according to claim 13, comprising:
first to fourth coil units disposed on the first circuit board; and
first to third sensors disposed on the first circuit board.

17. The camera device according to claim 16, wherein the third extension member comprises a first coil terminal conductively connected to the first and second coil units, and
wherein the fourth extension member comprises a second coil terminal conductively connected to the third and fourth coil units.

18. The camera device according to claim 16, wherein the first sensor is disposed closest to the first extension member among the first to fourth extension members,
wherein the second sensor is disposed closest to the second extension member among the first to fourth extension members, and
wherein the third sensor is disposed closest to the third extension member among the first to fourth extension members.

19. The camera device according to claim 16, wherein a first sensor terminal conductively connected to the first sensor is disposed at the first extension member,
wherein a second sensor terminal conductively connected to the second sensor is disposed at the second extension member, and wherein a third sensor terminal conductively connected to the third sensor is disposed at one of the third and fourth extension members.

20. An optical instrument comprising the camera device according to claim 1.
